(19) United States
(12) Patent Application Publication
(10) Pub. No.: US 2013/0282446 A1
(43) Pub. Date: Oct. 24, 2013

(54) METHODS AND SYSTEMS FOR CAPTURING, MEASURING, SHARING AND INFLUENCING THE BEHAVIOURAL QUALITIES OF A SERVICE PERFORMANCE

(71) Applicant: Colin DOBELL, King City (CA)

(72) Inventor: Colin DOBELL, King City (CA)

(21) Appl. No.: 13/650,921

(22) Filed: Oct. 12, 2012

Related U.S. Application Data
(63) Continuation-in-part of application No. 13/640,754, filed on Dec. 18, 2012.
(60) Provisional application No. 61/324,683, filed on Apr. 15, 2010.
(60) Provisional application No. 61/331,118, filed on May 4, 2010.
(60) Provisional application No. 61/365,593, filed on Jul. 19, 2010.
(60) Provisional application No. 61/384,554, filed on Sep. 20, 2010.
(60) Provisional application No. 61/412,460, filed on Nov. 11, 2010.
(60) Provisional application No. 61/451,188, filed on Mar. 10, 2011.
(60) Provisional application No. 61/547,950, filed on Oct. 17, 2011.

(51) Int. Cl. G06Q 10/06

(52) U.S. Cl. CPC G06Q 10/06398
USPC 705/7.42

(57) ABSTRACT

Methods and systems for capturing, measuring, sharing and influencing the behavioural qualities of a service performance.

### CROSS-REFERENCE TO RELATED APPLICATIONS

The present application is a continuation-in-part of U.S. patent application Ser. No. 13/640,754, which is a 35 U.S.C. 371 national phase entry application of PCT patent application no. PCT/CA2011/000431 filed Apr. 15, 2011, which designates the United States, and which claims benefit under 35 U.S.C. 119(e) of U.S. provisional patent application No. 61/324,683 filed Apr. 15, 2010; U.S. provisional patent application No. 61/331,118 filed May 4, 2010; U.S. provisional patent application No. 61/365,593 filed Jul. 19, 2010; U.S. provisional patent application No. 61/384,554 filed Sep. 20, 2010; U.S. provisional patent application No. 61/412,460 filed Nov. 11, 2010; and U.S. provisional patent application No. 61/451,188 filed Mar. 10, 2011, the entireties of which are hereby incorporated by reference. The present application additionally claims the benefit of U.S. provisional patent application No. 61/547,950 filed Oct. 17, 2011, the entirety of which is hereby incorporated by reference.

### TECHNICAL FIELD

The present disclosure is related to methods and systems for capturing, reviewing, annotating and sharing the behavioral qualities of a service performance. In particular, the present disclosure describes methods and systems for reviewing a performance using a user interface having an integrated review and annotation component.

### BACKGROUND

In many businesses and organizations, sustained operating results and/or positive changes may rely on an ability to deliver behavioural change throughout an organization, and businesses and/or organizations may benefit from systematic tools to help employees adjust their behaviour. Working individuals may also benefit from tools to help them take responsibility for their own behavioural learning in order to keep up professionally. Recent research in cognitive psychology is helping to identify which approaches are more likely to result in successful behavioral change. These insights may be useful in various aspects of a business or organization, from for example the management of performance in consumer service outlets to the development of individual high performers.

### Consumer Contact Points

Businesses and organizations which operate significant numbers of outlets at which face-to-face service is provided, such as banks and other retail financial institutions, fast food operators, convenience stores, retailers, grocers, walk-in healthcare offices, government offices and other operators of face-to-face customer sales and service environments—of which there may be over 1.8 million locations across North America—may desire to improve service quality and to strengthen customer loyalty. A strategy that many may choose to pursue is to design, measure and manage the desired “customer experience” to be delivered at each outlet, branch and/or customer contact point of the business or organization, which strategy may require the business or organization to be able to change front line employee behavior in response to changing requirements.

Responsibility for delivering behaviour change in these front line environments may rest on the shoulders of the front line manager. However, the manager may also be responsible for supervision of most or all activities within the outlet, observation of subordinates' performance, preparation and provision of feedback, and coaching of subordinates, on top of a whole host of administrative duties, in which case the manager may be overloaded. Being overloaded, front line manager may not pay enough attention to what may be complex and nuanced challenges of employee development and behavioural change.

### Individual Employees

Aside from front line service environments, the work effectiveness of different types of individuals (e.g., executives, outbound sales reps, etc.) within a business or organization may depend on their ability to develop listening, empathy, emotional intelligence, leadership and/or other “soft” skills. Some individuals, such as sales reps, may operate directly under the direction of a manager, who may be responsible for the effectiveness of their sales behaviour. Senior executives may be provided with access to formalized coaching to support their behaviour change efforts. Other individuals, who may not have access to formal human guidance, still may recognize their need to adapt behaviourally in order to realize their full potential. For example, in North America alone, the following statistics were found in 2010: a) over 15 million individuals work in “Sales & Related Professions”, b) 18,000 executive coaches work with over 1.1 million coachable senior executives, and c) 14 million other professionals (e.g., lawyers, accountants, doctors, consultants, etc.) may interact with customers on a regular basis. These people may be busy and may be looking for efficient behaviour change practices that may fit into the fabric of their day.

These situations may benefit from systematic approaches to behavior change that may be more effective and/or efficient. However, research has provided increasing evidence that many of the conventional practices designed to support managers in changing their own and their employees' behaviour (e.g., training, setting developmental objectives, getting feedback and direction, adjusting compensation systems, etc.) may not be satisfactory. Contrary to the conventional ways of teaching students and employees, research has shown that individuals may learn new behaviours more effectively when they are provided with one or more of:
A compelling reason to change, a specific intent to change, and a clear sense of personal responsibility for the effort.
Exposure to one or more new paradigms, or ways of looking at the world, that can expose the limitations of current behaviours and the opportunities available through change.
Consistent support in noticing and paying close attention to the everyday process of change.
A regular opportunity to observe and to reflect on the effectiveness of an individual's own behaviour in achieving goals.
A regular opportunity to practice new behaviours and to get relevant, timely and credible feedback, preferably from sources that are not immediate supervisors (e.g., managers).
A regular opportunity to observe and to reflect critically on the behaviour of others working in a similar situation.
A regular opportunity to talk with others who share similar environments about various experiences.
Recourse to one or more trusted sources of advice, support and encouragement that help digest new insights, assess options, and maintain confidence—without telling the individual what to do.

### SUMMARY

The present disclosure describes example systems and methods to aid motivated individuals and front line service team members in changing their observable behaviours. The disclosed example systems and methods may be more effective, efficient and/or systematic than conventional behaviour-changing techniques.

In some example aspects, the present disclosure provides an iterative review system for obtaining and sharing a Review of a service Performance by at least one performer, the system comprising: at least one display for presenting a user interface for performing the Review; at least one input device for receiving an input from a reviewer; a memory for storing data; at least one computer processor configured to execute instructions to cause the processor to: receive Performance data for playback to the reviewer; provide a user interface for playback of the Performance to the reviewer, the user interface configured for access by the reviewer who is other than: a) a supervisor or team leader of the performer, b) a member of a third party company hired by the organization for the purpose of reviewing the performer, and c) an automated process; receive the Review of the Performance from the reviewer, the Review being carried out using at least one integrated option in the user interface for carrying out the Review of the Performance during the playback of the Performance; directly relate at least one portion of the Review to a time point in the playback; store the Performance data and the Review, the stored Review being associated with the stored Performance data; iteratively provide the same or a different user interface for playback and Review of at least one of the Performance and a previous Review by the same or another reviewer, to obtain at least one iterative Review, the entire Review process having at least one iteration; store the at least one iterative Review and associate the at least one iterative Review with the stored Performance data; and generate a summary report including data representing the Review.

In some examples, at least one of the Review and the iterative Review may comprise at least one of a rating and a reviewer comment.

In some examples, the at least one integrated option may comprise at least one of an option to insert a Bookmark indicative of a comment or other effort by the reviewer to draw attention to that time point in the playback, an option to select a category for a Review, an option to select one of multiple synchronized datasets for playback of the Performance (see definition under Context Views), an option to view or review any pre-existing Review for the Performance, and a representation of at least one concept, in order to prompt the reviewer to consider that concept during the Review.

In some examples, the representation of at least one concept may be at least one of an auditory prompt and a visual prompt.

In some example aspects, the present disclosure provides a method for iteratively obtaining and/or sharing a Review of a service Performance, the Performance being carried out by at least one performer, the method comprising: providing data for playback of the Performance on a computing device to a reviewer; providing a computer user interface for carrying out the Review, the user interface being configured for access by the reviewer who is other than: a) a supervisor or team leader of the performer, b) a member of a third party company hired by the organization for the purpose of reviewing the performer, and c) an automated process; playing the Performance to the reviewer using the user interface; providing, in the user interface, at least one electronically integrated option for carrying out the Review of the Performance during the playback of the Performance; directly relating at least one portion of the Review to a time point in the playback; storing the Performance data and the Review, the stored Review being associated with the stored Performance data; iteratively providing the same or a different user interface for playback and Review by the same or another reviewer, to obtain at least one iterative Review of at least one of the Performance and a previous Review, the entire review process having at least one iteration; storing the at least one iterative Review and associating the at least one iterative Review with the stored Performance data; and generating a summary report including data representing the Review.

In some examples, the iterative Review may be a further review of the performance or a Review of a previous Review by a previous reviewer.

In some examples, the iterative Review may be a Review of a previous Review, further comprising storing the further Review of the previous Review as a global assessment of the previous Review in its entirety or as one or more individual assessments of one or more individual comments or judgments made by the previous reviewer, the results of this further Review being stored as part of a track record associated with the previous reviewer.

In some examples, performing the iterative Review may comprise reviewing a previous Review by at least one of: stepping through one or more time points bookmarked in the previous Review and selecting a specific Feedback element in the previous Review.

In some examples, at least one of the Review and the iterative Review may comprise at least one of a rating and a reviewer comment.

In some examples, the at least one integrated option may comprise at least one of an option to insert a Bookmark indicative of a comment or other effort by the reviewer to draw attention to that time point in the playback, an option to select a category for a Review, an option to select one of multiple synchronized datasets for playback of the Performance (see definition under Context Views), an option to view or review any pre-existing Review for the Performance, and a representation of at least one concept, in order to prompt the reviewer to consider that concept during the Review.

In some examples, the representation of at least one concept may be at least one of an auditory prompt and a visual prompt.

In some examples, the summary report may be generated as at least one of: a paper report, an electronic report, and a virtual representation for communicating the contents of one or more Reviews in the context of a 2-D or 3-D immersive environment.

In some examples, the Performance may be at least one of: a Performance at a remote walk-in service premise owned by an organization; a Performance at a remote walk-in service premise owned by a franchisee of the organization; a Performance during a sales call by a representative of the organization not in a walk-in service premise; a Performance during a meeting involving an individual with one or more third parties of interest during which that individual is practicing a specific behavior; a Performance during a live video call or webinar involving at least one image and one audio feed of the representative of the organization interacting with a third party; a Performance during an interaction between representatives of the organization in a non-customer facing work setting; and a Performance by an individual or by a representative of an organization during an interaction carried out in the context of a virtual 2-D or 3-D immersive environment.

In some examples, the reviewer may be one of: not a specialist in evaluating the quality of live service Performances; employed in a position similar to the position occupied by the performer; and/or employed in a position other than that of the performer's direct supervisor, manager or team leader.

In some examples, the Review may be carried out: during inactive periods or spare capacity in a regular working schedule; during time outside of business hours in exchange for a “piece work” payment; or by an employee of another franchisee of an organization in exchange for a payment or credit.

In some examples, the iterative Review may be a Review by the performer to evaluate a previous Review of the performer's Performance by a previous reviewer.

In some examples, when the performer indicates disagreement with any comment or assessment that makes up a Review, discussions may be initiated or prompted between at least one of the performer and the previous reviewer and their respective direct supervisors in order to enable the at least one of the performer and the previous reviewer to learn from the disputed Review.

In some examples, when the performer indicates that a comment or assessment in a Review was helpful or particularly helpful, this rating may contribute to a track record associated with the previous reviewer (which may portray the previous reviewer's evolving skill as a reviewer), which track record may become the subject of discussion between the previous reviewer and the previous reviewer's direct supervisor to enable the previous reviewer and/or the direct supervisor (e.g., in his/her capacity as a representative of the organization in its efforts to track and promote talented individuals) to learn from the results of the previous reviewer's reviewing activity.

In some examples, the reviewer may either be a customer of an organization or a customer of a franchisee of the organization who was involved in the Performance being reviewed, and wherein the customer is not a specialist in evaluating Performances.

In some examples, the method may further comprise automatically identifying the customer who was involved in the Performance being reviewed and automatically providing the customer with remote access to the user interface to carry out the Review.

In some examples, the playback of the Performance may not include an image of the customer but does include an audio feed of the customer.

In some examples, the reviewer may be considered as a candidate in a hiring decision for an open position in the organization, and the contents of the candidate's Review may be further evaluated using a different user interface by one or more existing employees of the organization having positions similar to the open position, in order to evaluate the competency of the candidate revealed in the candidate's Review, according to one or more dimensions or concepts of interest.

In some examples, the one or more Performances reviewed by the candidate may represent a service situation typical of the open position.

In some examples, one or more evaluations from the one or more employees may be transmitted to an individual responsible for the hiring decision in their raw states or as a predictive index indicative of the one or more evaluations.

In some example aspects, the present disclosure provides a method for encouraging collective attention to, and sense of joint responsibility for, one or more perspectives on the appearance of a service environment of an organization, the method comprising: providing data for playback, by a computing device, of a plurality of states of appearance of the service environment from the specified perspective(s), the states of appearance being representative of appearances of the service environment at a plurality of time periods; presenting the playback to a plurality of employees of the organization; providing a computer user interface including at least one option for receiving Feedback from at least one of the plurality of employees; receiving Feedback, when available, from at least one of the plurality of employees; directly relating at least a portion of any Feedback to a time point in the playback; and providing any received Feedback to the plurality of employees via the display.

In some examples, the data for playback may include at least one of still images, video data, and audio data.

In some examples, the playback may be presented on a display located in a common area of the organization or is accessible only to the employees of the organization.

In some example aspects, the present disclosure provides a method for obtaining and sharing a review of a service performance, the method comprising: storing, in a computer system, a definition of a review group of reviewers for providing a review of the service performance, wherein the definition comprises: one or more criteria for admittance of a candidate into the review group; one or more rules governing at least one of a review type and a review user interface for a reviewer; one or more rules for assigning a performance to be reviewed by a reviewer; determining, based on an evaluation of any criteria and rules in the definition, one or more performances to be reviewed by one or more reviewers; providing, through the computer system, a playback of the performance to one or more reviewers; obtaining from the one or more reviewers, a review of the performance during the playback of the performance; storing the performance data and the review, the stored review being associated with the stored performance data; and providing the stored review as feedback to a performed involved in the service performance.

In some examples, the reviewer may not know the performer and/or does not know the performer's work performance.

In some examples, the method may include updating the definition.

In some examples, the one or more rules governing the review type may include a rule governing a type of performer for a reviewer to review.

In some examples, the method may include determining whether the candidate meets the criteria defined in the definition of the review group and, if the individual meets the criteria, assigning the candidate to the review group.

In some examples, determining one or more performances to be reviewed may include evaluation any requests from the one or more reviewers to review the one or more performances.

In some examples, the one or more criteria for admittance may include at least one of: a request by at least one or the performer and a supervisor of the performer to admit the candidate to the review pool; completion of at least one qualification requirement by the candidate; and at least one experience in common between the performer and the candidate.

In some examples, the review types may include at least one of: an observation of a performer's behavior; an assessment of a performer's competence and/or skills; a comparison of the performance with a reference standard; a review carried out using a computer user interface provided by the computer system; and a review of a pre-defined position in an organization and/or type of service interaction.

In some examples, the one or more rules for assigning a performance may include at least one of: random assignment; assignment based on matched positions, skills, learning objectives, and/or specific request; uni-directional assignments; and bi-directional assignments.

In some example aspects, the present disclosure provides a method for generating a profile of a subject involved in a service interaction, the method comprising: storing, by a computing system, data for playback of a plurality of service interactions involving the subject and storing information characterizing each interaction in association with each respective interaction; obtaining, using a computer user interface provided by the computing system, one or more characteristics of the subject, the one or more characteristics being observed through the playback of the plurality of interactions; and generating the profile of the subject, the profile including information about the one or more characteristics and data for playback of the plurality of interactions.

In some examples, the method may include recording the plurality of service performances and information characterizing each service performance using one or more sensors.

In some examples, the method may include providing, via the computing system, the profile of the subject as output to one or more users prior to the one or more users interacting with the subject.

In some examples, the method may include providing, via the computing system, a summary of the profile of the subject as output to one or more users during an interaction between the one or more users and the subject.

In some examples, the method may include providing, via the computing system, a playback of one or more of the plurality of service interactions.

In some example aspects, the present disclosure provides an apparatus for the collection of data associated with a service performance involving at least one performer and at least one customer at one or more front counter locations, the apparatus comprising: a support positionable between the at least one customer and the at least one performer; and at least one housing mountable on the support, the at least one housing at least one of: at least one camera for capturing an image of at least one of the at least one customer and the at least one performer during the service performance; at least one microphone for capturing audio from at least one of the at least one customer and the at least one performer during the service performance; and at least one processor configured for controlling operation of the at least one camera and the at least one microphone.

In some examples, the at least one processor may be coupled to a memory for storing data captured by the at least one camera and the at least one microphone, the at least one processor being further configured for communicating the stored data to an external computing device.

In some examples, the least one housing may further house at least one of: a motion detector, a distance detector and a radiofrequency identification (RFID) reader.

In some examples, the support may be adjustable in length.

In some examples, the support may be telescopic.

In some examples, the support may be configured to accommodate one or more cables to the at least one housing.

In some examples, data captured by the at least one camera and the at least one microphone may be encrypted.

In some examples, the at least one processor may be further configured for identifying at least one of the at least one performer and the at least one customer.

In some examples, the apparatus may include a mechanism for indicating suspension of data capture.

In some examples, the at least one processor may be further configured for, in response to activation of the mechanism, designate that a subsequent portion of data captured by the at least one camera and the at least one microphone should be ignored or discarded.

In some example aspects, the present disclosure provides a dedicated device for the collection data associated a service performance involving at least two performers, the device comprising: a portable housing placeable stably on a support surface; at least one panoramic camera within the housing for capturing a panoramic view of the service performance; at least one microphone within the housing for recording voices of one or more performers in the vicinity of the device; a memory for storing data from the at least one panoramic camera and the at least one microphone; and at least one communication component for communicating the stored data to a computing device.

In some examples, the device may include a processor in communication with the at least one panoramic camera and the at least one microphone, the processor being configured for controlling function of the at least one panoramic camera and the at least one microphone, and for implementing at least one security feature to inhibit unauthorized access to the stored data.

In some examples, the processor may be further configured for identifying a primary user of the device.

In some examples, the primary user may be identified by at least one of: receipt of a user identifying input; execution of a voice-recognition algorithm; and execution of a facial-recognition algorithm.

In some examples, the at least one security feature may include at least one of: a protocol for authenticating a connection to the computing device; a protocol for inhibiting communication of stored data to an unauthorized system; and a protocol for encrypting the stored data prior to or during communication to the computing device.

In some examples, the device may include a power source.

In some examples, the power source may be a rechargeable battery.

In some examples, the device may include a connector to enable recharging of the battery.

In some examples, the device may be sized to fit into a pocket.

In some examples, the at least one panoramic camera may be configured to capture a panoramic view in the range of about 180° to 360° along a first axis and in the range of about 0° to about 90° along a second axis.

In some examples, the device may be configured for collecting sensor data associated with interactions taking place around a table or desk.

In some examples, the device may include an on/off switch.

In some examples, the device may not be a smartphone or a consumer recording device.

In some examples, the device may include at least one additional sensor including at least one of: a radiofrequency identifier (RFID) sensor; a location sensor; and a wireless hotspot sensor.

### BRIEF DESCRIPTION OF THE DRAWINGS

FIGS. 1A-G shows examples of Sensors that may be suitable for use in examples of the disclosed systems and methods;

FIG. 2 shows an example setup of an example system for reviewing a Performance in a service environment;

FIG. 3 shows an example of a simplified model of data types and their relationships that might be used in an example system for reviewing a service Performance;

FIGS. 4A-7 are tables illustrating examples of characteristics or attributes of the data types illustrated in FIG. 3;

FIG. 8 is a schematic showing example hardware and software components of an example system for reviewing a service Performance;

FIG. 9 is a flowchart illustrating an example process for carrying out an example Review Program, in accordance with an example of the disclosed systems and methods;

FIG. 10 is an example of a relatively simple learning model that may be applied using an example of the disclosed systems and methods;

FIGS. 11A and 11B are example user interfaces for defining, updating and reporting on progress toward user learning objectives, that may be suitable for an example of the disclosed systems and methods;

FIG. 12 is a diagram illustrating example work relationships that may be turned to by an individual to have one or more Reviews of that individual completed using the disclosed system and methods, for the purpose of aiding that individual's behavioral learning;

FIG. 13 shows an example user interface for carrying out an Observation, in accordance with an example of the disclosed systems and methods;

FIG. 14 is a flowchart illustrating an example process for carrying out an example Observation, in accordance with an example of the disclosed systems and methods;

FIG. 15 is a flowchart illustrating an example process for carrying out an example Assessment, in accordance with an example of the disclosed systems and methods;

FIGS. 16-24 show example user interfaces for carrying out an Assessment, in accordance with an example of the disclosed systems and methods;

FIG. 25 is a flowchart illustrating an example process for creation of a Review Pool, in accordance with an example of the disclosed systems and methods;

FIG. 26 shows a user interface suitable for providing a user with information about the Review activity of him/herself and his/her direct reports, in accordance with an example of the disclosed systems and methods;

FIG. 27 is a flowchart illustrating an example process for carrying out a Virtual Mystery Shop type Review, in accordance with an example of the disclosed systems and methods;

FIGS. 28-37 show example user interfaces suitable for carrying out a Virtual Mystery Shop type Review, in accordance with an example of the disclosed systems and methods;

FIG. 38 shows an example report that may be generated in a Virtual Mystery Shop type Review, in accordance with an example of the disclosed systems and methods;

FIG. 39 shows an example report from a conventional mystery shopper program, in contrast with the report of FIG. 38.

FIG. 40 is a flowchart illustrating an example process for carrying out a Virtual Insight into Customer Experience type Review, in accordance with an example of the disclosed systems and methods;

FIGS. 41-43 show example user interfaces suitable for carrying out a Virtual Insight into Customer Experience type Review, in accordance with an example of the disclosed systems and methods;

FIG. 44 is a flowchart illustrating an example process for carrying out a Review of group performance at a particular Site, in accordance with an example of the disclosed systems and methods;

FIG. 45 is a flowchart illustrating an example process for carrying out a Review in the context of a new hiring decision, in accordance with an example of the disclosed systems and methods;

FIGS. 46-60 illustrate example embodiments of the present disclosure, in accordance with U.S. provisional patent application No. 61/384,554;

FIG. 61 illustrates the use of an example device for recording a performance involving two or more performers;

FIGS. 62 and 63 illustrate an example of a recording device that may be set on a table or other surface; and

FIG. 64 illustrates an example of a recording device including a vertical support.

### DETAILED DESCRIPTION

The present disclosure may be understood with the aid of the following glossary.

### Glossary of Terms

Assessment—A Review Type (see definition) in which a designated reviewer may review one or more Performances by one or more performers via one or more user interfaces (which may be referred to as a Review Interface and Rubric, see definition) that may prompt the reviewer to: i) observe, reflect and/or provide his or her subjective Feedback on certain aspects of each Performance; and/or ii) consolidate their observations into an assessment of the performer, such as according to a set of objective performance, quality, skill and/or competency dimensions. Assessments may differ from Observations (see definition) inasmuch as they may include not only commentary from the reviewer but may also include one or more ratings of the Performance(s) according to one or more objective rating scales. Since Assessments may involve reviewing multiple Performances, and may further require the reviewer to make one or more summary assessments, an Assessment may take more time to complete than an Observation. An Assessment may be carried out by the performer (e.g., in “self-Assessments”), by peers, supervisors, etc.

Bookmark—An observable placeholder (e.g., visual icon) which may be provided in the context of a Review Interface. A Bookmark may be associated with a particular time or episode within a Performance being reviewed. A Bookmark may be initiated or created by a reviewer during a Review and may indicate, for any subsequent review of the same Performance, that Feedback has been associated with that time or episode in the Performance. A Bookmark may be presented in a user interface in any suitable method (e.g., visual or audio), including, for example, an icon located along a 2-D timeline representing the time progression of the Performance, a list of references that may be selected to jump to the time period in question in the Performance, a 3-D image within an immersive virtual environment representing the Performance, a highlight or a representation, a written note, an audio cue, a verbal comment or any type of suitable representation in a 2-D or 3-D interface environment.

Collector—A processing device, such as a server, that may collect, aggregate and/or analyze Performance data captured by one or more Sensors from one or more Sites (commonly a single Site). In some examples, the term “Collector” may be used to refer to a software application residing on the processing device (e.g., a generic device) that may cause the device to carry out the functions of a Collector as described herein. The Collector may process such data to determine a subset of Performance data that may be forwarded on to the Head-end System (see definition). The Collector may be located physically proximate to the Site or remotely from the Site. In some examples, where communication bandwidth may not be a limiting factor, a Collector may not be required at each Site and the Collector may be centralized in a remote location, with all Sensor data collected from each Site being transmitted (e.g., streamed) up from each respective Site. In examples where bandwidth may be a limiting factor, the Collector may serve as a data aggregator and/or filter at each Site, in order to filter out and discard data (e.g., data that may be irrelevant or of little or no benefit to a User) and to identify and store locally data which may be of interest to the User (e.g., according to one or more desired Review Programs), which data may then to be provided (e.g., at a later time) to the User via the Head-end System. In some examples, a Mobile Recording Appliance (see definition) being carried by an individual involved in a Performance at a Temporary Site may transmit (e.g., wirelessly) its collected data to another processing device (e.g., running an appropriate Collector software application), which may be connected to a wireless network. The Collector may perform any suitable analysis of the data and may transmit the data (e.g., wirelessly) to the Head-end System. In a Virtual Site, one or more of the computing devices that are participating in the virtual representation of the interaction may be configured to run a software application to capture a representation of the virtual interaction and may transmit this data to the Head-end System. In each case, the computing device running the appropriate software application may be acting as a Collector.

Collector Types—Identifier of a class of Collectors that share one or more common characteristics. Examples may include a “Fixed” collector that may be in a fixed, permanent or semi-permanent location, such as a dedicated device (e.g., server) housed at a remote Site; any suitable third-party processing device (e.g., personal computer) running a Collector application software that, when executed, causes the device to perform Collector functions (e.g., for collecting data from one or more Mobile Recording Appliances); and a “Virtual Collector” that may assemble a Performance from a Virtual Site, for example assembled from inputs from two or more computers, for example, by capturing and consolidating the various video and/or audio data associated with communication between the two or more devices, such as a Skype call or a 3-D virtual immersive environment. One or more Collectors of one or more Collector Types may be provided at any Site.

Company—Commercial entity that may use the disclosed systems and methods and may establish conditions for use in their premises. In some examples, a Company may be an individual. In some examples, the overall conditions for use of the disclosed systems and methods may be established by a system operator of the Company.

Concept Bubble—A visual representation of a category, concept or idea that may be provided as part of a user interface, for example as defined by a Rubric in the context of a Review Interface. A Concept Bubble may be provided to a reviewer in order to: a) prompt a reviewer to consider a category, concept or idea while they are reviewing a Performance; and/or b) facilitate the linking by the reviewer of their Feedback to a category, concept or idea defined by the Rubric. In some examples, a Concept Bubble may be presented in 2-D space, while in other examples, a Concept Bubble may be represented in 3-D immersive environments that may be used to enable a reviewer to review a Performance.

Consumer Service Companies (“CSC”)—Businesses and organizations that may manage service interactions, such as between customers and front line staff, in which the service delivered may depend at least in part on the quality of the employee Performance. Examples of CSCs may include banks, fast food outlets, retailers, grocery chains, governments providing service through physical offices, walk-in medical, dental or other health clinics, offices of individual doctors, dentists and other health professionals, as well as offices of lawyers and other professionals that deal with individuals. A CSC may be any business or organization that may deal directly with individual customers, such as in “store front” environments. CSCs may include businesses and organizations that may deal with customers in virtual environments (e.g., 3-D immersive virtual environments) in which employees may interact with customers and in which employee Performances may have a direct impact on the perceived quality delivered to the customer.

Context Views—Sensor data provided from at least one Station, for example including at least a video feed and possibly also other non-video data (e.g., audio data) synchronized with that video feed, which has been indicated as being a relevant perspective on a Performance. A Context View may be one of multiple datasets (e.g., Sensor datasets) that may be selected for playback of a Performance. For example, a reviewer reviewing a Performance using a Review Interface may be provided an option of selecting one or more Context Views while providing Feedback. Examples of Context Views may include a customer side view and an employee side view.

“Customer” Side—The side or point of view of any Performance whose behaviour or reaction to an “Employee” side of a Performance may be observed to assist in reviewing the quality of the “Employee” side of the Performance.

“Employee” Side—The side or point of view of any Performance or interaction that may be the primary subject of review, reflection or evaluation.

Feedback—Any information (e.g., quantitative or qualitative information) emanating from a reviewer who has reviewed a Performance (e.g., in the course of a review session). The Feedback may be structured as defined by a Rubric (e.g., categorized into one or more Concept Bubbles) so that it may be readily communicated/shared and/or understood by others. Feedback may include, for example, a noticing or an emphasizing of a particular moment, duration, or aspect of a Performance or an emotion or thought associated with the experience of all or part of a Performance. Feedback may include, for example, subjective, relatively freeform reactions (e.g., subjected comments) or structured objective assessments, and anything in between. Feedback may include, for example, numerical rating of any aspect of a Performance. The presence of any Feedback for a given Performance (e.g., for a particular time point or episode of a Performance) may be indicated in a Review Interface by a Bookmark.

Head-end System—One or more servers operating in a coordinated manner which may be referred to as the “Head-end” or Head-end System. The one or more servers may be co-located or not. The Head-end System may or may not be associated with a Site at which monitoring of a Performance is taking place. The Head-end System may include one or more databases for storing data defining one or more Rubrics, Review Interfaces, for storing datasets representing one or more Performances, Reviews, Assessments, for storing information about one or more Review Pools, and/or for storing any other suitable data. The Head-end System may coordinate how Performance data may be provided to one or more reviewers (e.g., according to one or more defined Review Programs), among other functions disclosed herein.

Interpersonal Profile—Characteristics and/or habits of an individual that pertain to the way the individual communicates, prefers to be communicated with, expresses emotions and/or responds to various types of interpersonal techniques, among others. The Interpersonal Profile may include any recurrent trait of the individual (e.g., customer or server) that may pertain to the individual's interpersonal style.

Job Categories—Identifier of a class of positions within a Company that the Company may define as being similar to each other, for example with respect to competencies, skills, behaviours and/or other suitable characteristics.

Location Identifier—Any identifier, label or record (which may refer to an abstract system) for recording, storing and/or reporting the physical or virtual location of an object within a Site. Examples may include: a) site-based coordinates, such as based on one or more reference beacons located within the Site; b) names of physical spaces within the Site (e.g. “front counter”); and c) reference proximity sensors that may identify that the object is within a specified distance of the proximity sensor. Other identifiers may be suitable. For example, the object itself may track its own position (e.g., using a GPS locator).

Meta-Data—Meta-data may be defined as data about a record (or part thereof) of a Performance, which data may be useful in indexing that record (e.g., for later use or retrieval). Meta-data may be related to, for example, time/date, location, identity of Performer and/or Customer (or other individual), and other relevant contextual data.

Mobile Recording Appliance—A portable device that may be carried by individuals to serve as recorders of activity (e.g., recording video, audio and/or other sensory data) that may take place around them, including any activity generated by the individuals themselves. Such a device may be a purpose-built device or may be incorporated into other devices, such as an existing portable computing or communication device, such as smartphones or other devices. Such a device may also be a conventional portable computing or communication device running appropriate software to cause the device to collect relevant data. A Mobile Recording Appliance may be a compilation of multiple Sensors and may be referred to as a Mobile Station.

Observation—A Review Type in which a designated reviewer may review a Performance via a Rubric. In an Observation, the reviewer may be provided with a user interface that may prompt the reviewer to observe, reflect and/or provide his or her Feedback related to the Performance (e.g., on certain designated aspects of the Performance) without requiring the reviewer to rate or formally assess the Performance based on an objective criteria. An Observation may involve a single Performance, and therefore may tend to take less time to complete than an Assessment (which may involve one or more Performances). An Observation may be performed by the performer (e.g., in a “self-Observation”), by peers, supervisors, etc.

Performance—Any interaction involving at least one human being (e.g., the performer performing at a Station), but may involve two or more human beings (e.g., the performer interacting with one or more animate entities, such as another human), which may observed or experienced, reviewed, reflected upon and/or evaluated. The human being(s) involved in a Performance may be physically co-located at a Station in a particular Site, or may be physically at separate sites while interacting over the internet or some other means (e.g., electronic means) of long-distance communication (e.g., teleconference, telephone, etc.), or may be interacting virtually using avatars in a virtual space (at a single Virtual Site, for example). The term Performance may refer to the actual interaction itself or to the electronic representation of the interaction (e.g., audio and/or video data provided to a reviewer). Such electronic representation may include, for example, i) one or more voice recordings only, ii) one or more video recordings only, iii) one or more audio visual recordings, iv) any other record generated by one or more Sensors that may characterize the salient aspect(s) of each interpersonal interaction, v) and combinations thereof. A Performer may be the subject of the Performance who may eventually receive Feedback on their behavior through the Review process.

Performance Types—Identifier of a class of Performances that share one or more common characteristics. For example, one Performance Type may be a customer exchange with a teller at the counter in a retail bank, another Performance Type may be a coaching session by a branch manager of an employee in their office. In some examples, the disclosed system may maintain an evolving library of Performance Types (e.g., stored in a database of the Head-end System), which may be customized (e.g., by the Company). A definition of a Performance Type may include one or more characteristics of the Performance such as: the Job Categories that may be involved; whether it is a 1-sided, 2-sided, 3-sided, etc. interaction; Station Types that may be included; minimum configuration of Sensors that may be included in Stations; how the Performance may be identified (e.g., Station site vs. words used at start); how to identify duration of the Performance (e.g., start and end of the Performance), such as by speech analysis or other Sensor input; how to identify participants, such as by facial analysis or Station identification; how to identify topic of the Performance, such as by use of words/expressions (e.g., including the definition of specific words/expressions used to delineate start/end of the Performance).

Review—A Review or a Review session may refer to a single session of any type during which a human reviewer may review a Performance and may provide Feedback. A Review may include any activity associated with reviewing (or experiencing) at least one Performance (e.g., using a user interface such as that defined by a Rubric) and obtaining Feedback from a reviewer (e.g., via one or more feedback options provided by the Rubric). When used as a verb, to Review may mean the act of performing a Review of a Performance. When referring to types of Review, to Review may include various types of thought, reflection, experiencing, etc. that may be carried out during the Review—examples may include observation, assessment, comparison, etc. A Reviewer may be any individual that Reviews a Performance and provides Feedback.

Review Interface—A user interface or representation strategy, for example including layout and interactive components, which may be provided on a computing device (e.g., displayed on a display) to be used by a reviewer to carry out a Review. The Review Interface may include playback of data representing a Performance (e.g., playback of video and/or audio data). For example, the Performance may be provided in such a way as to provide as much verisimilitude as possible (e.g., involving the display of relevant Context Views). The Review Interface may provide the reviewer with one or more options for controlling playback of the Performance (e.g., play, pause, stop, etc.). The Review Interface may also provide the reviewer with one or more options to provide or review Feedback for the Performance. A Review Interface may provide context for the representation of one or more Rubrics (see definition) while the ideas comprising a Rubric may be organized and communicated in the context of one or more Review Interfaces. The Review Interface may provide a way for an individual to interact with a Rubric, and to provide and/or experience Feedback in the context of a Rubric. The Review Interface may be designed to portray a Performance in such a way as to provide as much verisimilitude as possible, for example.

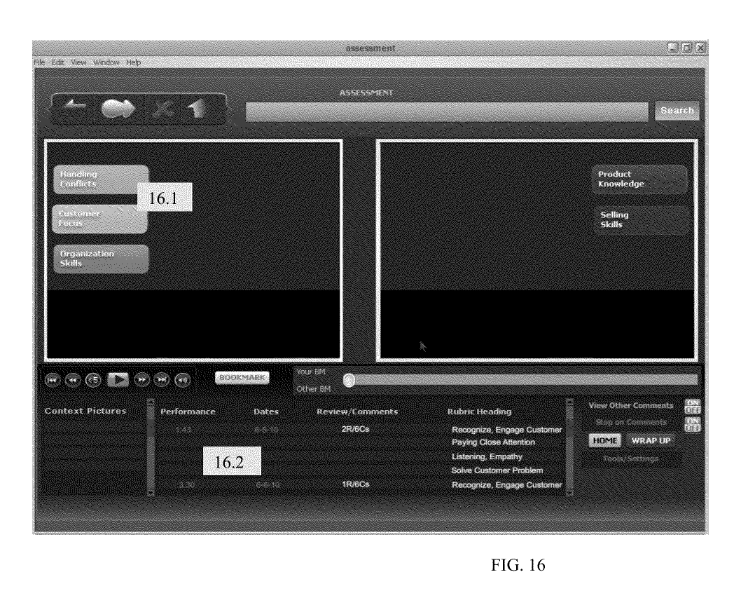

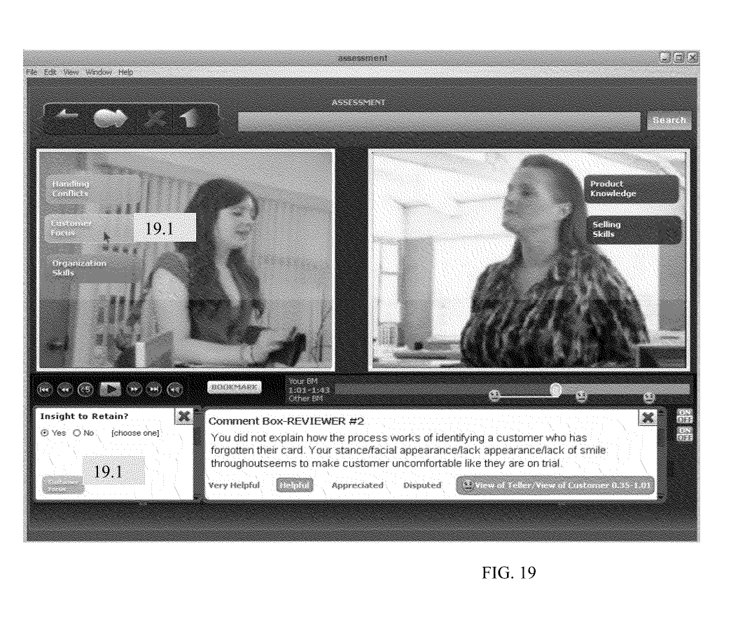

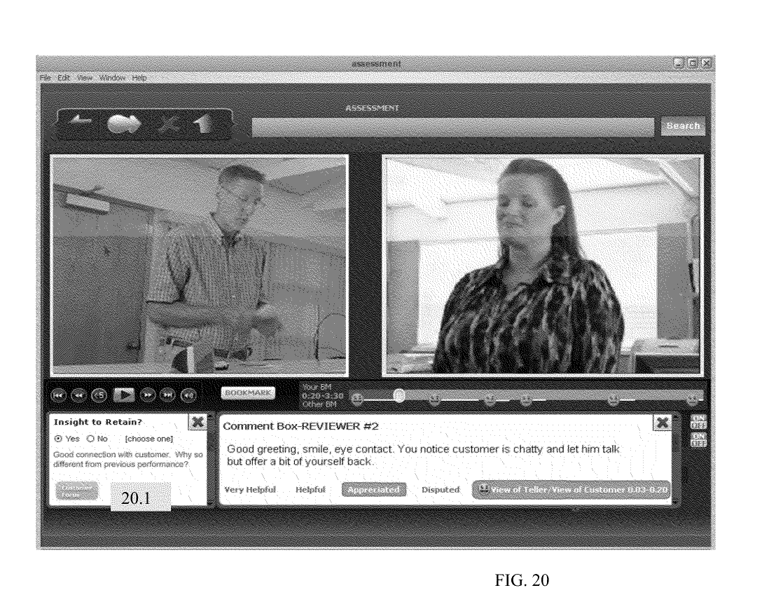

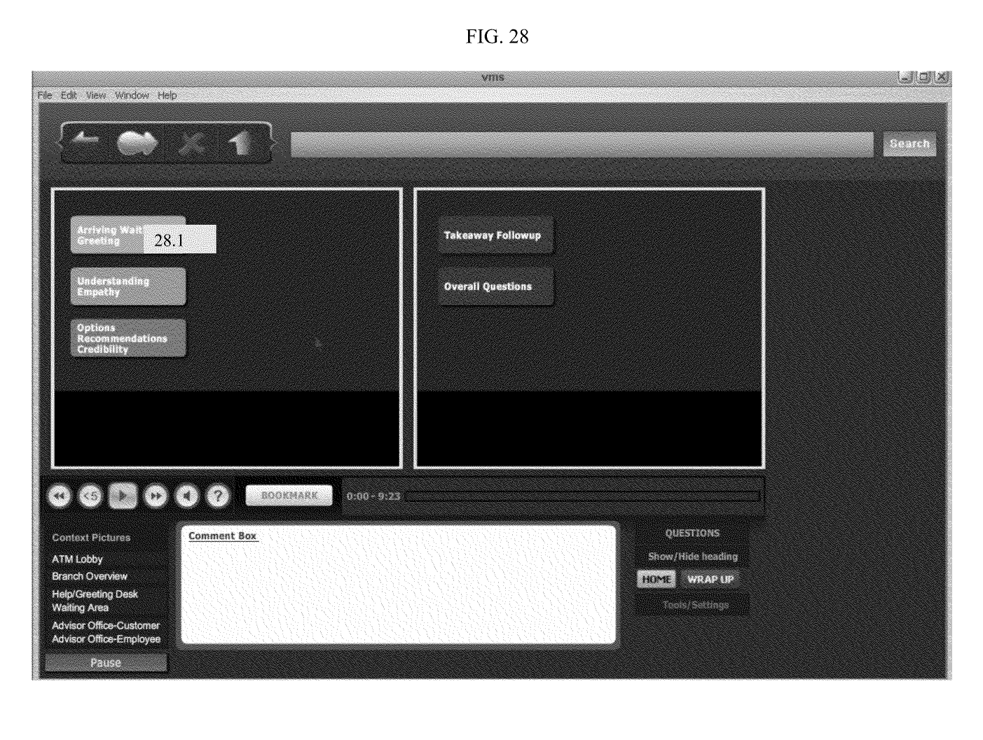

Review Interface Type—Identifier of a class of Review Interfaces that share common characteristics in terms of display or representation strategies for a Performance, a Rubric, and Feedback. For example, FIGS. 16-24 illustrate user interfaces that may be defined by an example Review Interface Type that may be used for Assessments. FIGS. 28-38 illustrate user interfaces that may be defined by an example Review Interface Type that may be used for Virtual Mystery Shops.

Review-of-Review—See “Review Type”

Review Pool—A group of reviewers who may be familiar with or trained in the use of one or more defined Rubrics and may be authorized to participate in one or more Review Programs that use those Rubric(s) and call for non-specific reviewers (e.g., by random selection of reviewers). Each member of a Review Pool may be authorized to participate up to a maximum number of Reviews per period, for example, based on the estimated time associated with completion of each of the Rubrics involved. Each member of a Review Pool may be authorized to review certain types of Performances and/or perform certain types of Reviews. Review Pool members may be expected to complete Reviews allocated to them by the Head-end System (e.g., up to a maximum number within an allotted time), and data about their on-time performance may be collected with respect to this commitment. The individual users in a Review Pool may share one or more common characteristics that qualify them to be allocated Reviews to be performed using a specific Rubric. This qualification may include, for example, the successful completion of an online course, the authorization of an individual by their supervisor, the sharing of common life experiences, etc. The reviewers may not have prior knowledge of the Performer in any Performance.

Review Pool Assignment Rule—One or more Rules by which one or more Reviews to be completed under one or more Review Programs may be assigned to members of a Review Pool, or by which such members may request Reviews to be completed by other members of the Review Pool. These rules may include, for example, random assignment, or assignment based on matched positions, skills, learning objectives, and/or specific Reviewer request. Assignments may include anonymous uni-directional assignments (i.e. in which one Review Pool member performs a Review for a second Review Pool member without the latter performing a Review of the former in exchange. Such a Review may be performed by the first member in expectation that a third member in the Review Pool will perform a Review of the first member at a later date) in which no personal detail is revealed by either party; they may include uni-directional assignments in which various amounts of personal information is exchanged; and/or they may include a mutual exchange of Review activity between two individuals, who may be free to reveal as much personal information to each other as they wish to.

Review Pool Types—Identifier of a class of Review Pools that share one or more common characteristics. Characteristics which may differ among Review Pool Types include, for example: i) membership restrictions, such as requirements that members must belong to a specific Job Category or not; ii) anonymity of members, such as requirements that members are identified to performers whom they review or not; iii) mandatory Review obligations, such as requirements that members are obligated to perform a minimum number of Reviews per period or not.

Review Program—A Review Program may be a pre-configured or pre-defined set of Reviews (e.g., according to a pre-defined review schedule) that may be carried out by one or more reviewers (who may be specified, such as pre-defined according to the Review Program) using one or more pre-defined Review Interface Types and Rubrics. For example, a Review Program may specify that the Review(s) be carried out over a specified period of time and/or that results be distributed to specified Users.

Review Program Type—Identifier of a class of Review Programs that share one or more common characteristics. A Review Program Type may be established within the context of a Company, for example, so that a central administrator may delegate the ability and/or authority to establish a specific Review Program Type to a specific Job Category. Other characteristics may include, for example, the way in which results may be distributed and/or shared.

Review Type—Identifier of a class of Reviews that share one or more common characteristics, for example with respect to who the reviewer is, the type of mental activity involved, and/or the nature of the Feedback provided. A definition of a Review Type may specify the way in which Feedback may be combined and summarized. For example, raw ratings that may result from an Assessment review may be presented as they are, or the Review Type may require that two or more Reviews of the same Performance generate similar ratings in order for the review to be valid. In such an example, the process of determining whether ratings are similar may be carried out differently, for example by providing each reviewer with a blank slate, or by having a second reviewer confirm the results produced by a first reviewer. Some examples of Review Types, such as Observations, Virtual Mystery Shops and Virtual Insight into Customer Experience sessions, may be Reviews which may operate directly on one or more raw Performances. Other examples of Review Types, such as certain types of Assessments, certain types of Observations, and sessions where a performer assesses the comments provided in Reviews of their Performances, may be Reviews which review Feedback provided during one or more previous Reviews—these may be referred to as “Reviews-of-Reviews”. These latter Review Types may differ from direct Reviews in that direct Reviews may be suitable for evaluating behaviour exhibited in a Performance while Reviews-of-Reviews may be suitable for evaluating the thinking and attitudes exhibited in a Review by a reviewer.

Rubric—A Rubric may be a set of defined concepts, questions, issues or other ideas, which may be visually represented in the context of one or more specified Review Interface(s), which may be designed to influence and/or facilitate the Review of one or more Performances by a User (e.g., a Reviewer) in such a way as to prompt the reviewer to observe and/or reflect on certain aspects of interest, and then to provide Feedback about the Performance(s), such as according to a specific set of themes, topics and/or dimensions. A Rubric may define, for example, the minimum type(s) of Performance data to be provided in the context of a Review (e.g., audio and/or video), the type of feedback options to be provided (e.g., text input or audio input) and/or the type of concepts or questions raised or presented during the Review. Each Rubric may: operate on at least one representation of a Performance; define at least one method for prompting the reviewer to consider or reflect on at least one specific aspect of interest; and/or define at least one means of capturing and storing the Feedback elicited from the reviewer in a way that may be shared with others at a later time. Each Rubric may include in its design an estimate of the average amount of time to execute that Rubric (i.e., carry out a review) on an average Performance. There may be an evolving library of Rubrics (e.g., stored in a database of the Head-end System) provided by the disclosed systems and methods, and each Company may customize Rubrics to match its needs. A Rubric may provide recorded data from one or more Performances in a suitable format (e.g., video display, audio playback, etc.) and one or more interactive components (e.g., text box, selectable buttons, etc.) for providing Feedback.

Rubric Types—Identifier of a class of Rubrics that share one or more common characteristics, including, for example, strategies for representing concepts, for prompting observation or thought about a concept, for soliciting Feedback from a reviewer, and/or for capturing Feedback as it is provided. A common set of concepts may be represented by different Rubric Types in the context of differing Review Interface Types. However, even within a common Review Interface Type, multiple Rubric Types may be developed in order to capitalize on different representational and/or prompting approaches.

Sensor—Any analog or digital device (e.g., electronic device) that may be used to generate (either directly or indirectly) a signal (e.g., an electronic digital signal) as a result of a change of state (whether physical or virtual) at a Site. A change of state may include, for example, entrance or exit of a customer. A Sensor may also capture any data related to an interaction (e.g., a customer service interaction) or a state (e.g., appearance of a facility) at a Site. A Sensor may include, for example, a camera, a microphone, a motion or presence sensor, etc, or a combination thereof. A Sensor may be fixed in one place or mobile throughout a Site or between pre-specified Sites, such as a microphone or camera mounted on a headset or lapel pin, or a Mobile Recording Appliance. In the case of a fixed Sensor, the Sensor may be constantly connected to a Collector (e.g., through wired communication) to transmit sensed data to the Collector. In the case of a mobile Sensor, the Sensor may be configured with the system so that its data may be transmitted to the Collector from time to time (e.g., via a cradle or wirelessly). A Sensor may be pre-existing to a Site (e.g., already be in place for some prior purpose, such as an existing camera used in conjunction with an existing recording system) and be configured to collect data for transmission to the Collector in parallel with its pre-existing usage, or new and purpose-selected for recording a Performance. Several simple Sensors may be used in combination with multi-level criteria to produce a complex Sensor that may generate a signal, such as when several criteria are met simultaneously (e.g., presence sensor and microphone both sense the entrance of a customer).

Sensor Types—Identifier of a class of Sensors that share one or more common characteristics. For example, a Sensor (e.g., camera or microphone) might be Fixed or Mobile; a Sensor may be complex Sensor (e.g., aggregated from multiple Simple Sensors). A possible kind of virtual Sensor may be a sensor that exists in a virtual immersive 3-D space that may act in the same way that a real Sensor would act in a real environment. Sensor Types may evolve with the type of technology available, and each Company may select one or more Sensor Types that it may use in its Sites (e.g., according to its needs and constraints).

Site—A location, which may be physical or virtual, at which one or more Performance(s) of interest take place. An example of a physical Site might be a specific bank branch, a retail store, a fast food restaurant, a government office, etc. In these Sites, service Performances may take place on a regular basis and Sensors may be installed at least semi-permanently to capture these Performances. Such Sites may include sub-spaces (e.g., customer service desk, private office, etc.) in which different types of Performances may take place, and such sub-spaces may be referred to as Stations. Temporary Sites may also be of interest to a Company, and these may include, for example, a customer's office where an outbound sales rep may make a sales presentation which may be captured, for example, via one or more portable Sensors (e.g., a camera and/or microphone device attached to a laptop). Another example Temporary Site may be an executive's office where another employee may enter for a meeting that may be analyzed as a Performance, or a conference room where several participants may all engage in Performances during a meeting. In these cases, Performances may be captured using, for example, Mobile Recording Appliances that may be referred to as Mobile Stations (see definition). A Site (e.g., a Virtual Site) may also be a virtual space where one or more virtual avatars may interact in what may viewed as Performances, or where two individuals who are not co-located may engage in a computer-assisted real-time exchange in which each of them may be engaging in a Performance.

Site Type—Identifier of a class of Sites that share one or more common characteristics. Examples may include “retail bank branch” or “commercial banking center” or “branch manager's office”. Separate Site Types might be established for each different Company that had, for example, “retail bank branches” in order to capture the different configurations of Stations or other attributes that are common across a single Company but might differ between Companies.

Station—A space within a Site recorded from one or more specific perspectives in which a Performance of interest takes place. For example, a front counter may be considered a Station from which the perspective of a particular bank teller may be captured (e.g., a close-up of their face, upper body, voice, etc.) while a separate Station may provide an overview of the front counter that may include multiple tellers from some distance away. Performances at a Station may be captured using one or more Sensors associated with that Station. Stations may be fixed physical spaces within a Site such as a teller's counter, a front counter, a bank manager's office, etc., and they may have specified number of fixed Sensor(s) associated with them. In other examples a Station may be mobile, for example a Mobile Station might be a mobile Sensor (e.g., microphone worn on the nametag of a particular individual), or a Mobile Recording Appliance carried by a particular individual. A Virtual Station may be associated with a virtual Site similar to how a physical Station may be associated with a physical Site. Data associating a Virtual Station with a virtual Site may be stored in an appropriate database of the Head-end System. In some examples, virtual interactions associated with a particular individual may be held between that particular individual and any customer. Each Station may be restricted to have only one microphone input associated with it. Some Stations may capture an entire Performance with one camera and microphone while others, which may be referred to as paired Stations, may involve two or more separate Stations to capture the Employee Side and the Customer Side of a Performance.

Station Type—Identifier of a class of Stations that share one or more common characteristics. For example, there may be a teller's counter (e.g., Employee side) in a retail bank, or a branch manager's office (e.g., Customer side), or the front counter of a fast food restaurant (e.g., both sides), or a Mobile Recording Appliance. Each of these Station Types may implement a different Sensor strategy to suitably capture the Performances that may be expected to take place there. There may be an evolving library of Station Types (e.g., stored in a station type database of the disclosed system) and each Company may customize Station Types to match its Sites. A definition of a Station Type may include the type(s) of Sensors that may be expected or permitted (e.g., by a Company), and/or may identify Stations as paired Stations, possibly with the added identification of whether the Station is Employee Side or Customer Side.

User—Individual who may be: a) associated with a Company, or b) using the system as an individual, and who may be granted access to the system in order to participate in one or more Review Programs and/or to act as a system administrator. For each User, the system may maintain (e.g., in a user database of the Head-end System) for example among other things, their contact info, their password(s) to gain system access, their digital image (if applicable), a record of their system access permissions, their job category (if relevant), their relationships within the Company (if applicable), the Rubrics they are authorized to use, which Mobile Recording Appliance they may carry with them, which Sites they may be associated with and/or how to identify them to the system.

Verbal Search Criteria—A set of words or expressions that may be searched (e.g., by an audio analytical algorithm) to identify Performances that share certain attributes of interest. For example, the search may be carried out using any suitable audio analytic algorithm, such as one based on keyword search.

Virtual Insight into Customer Experience—A Review Type in which a customer that visited a particular Site at a particular time may be asked (e.g., by the Company) to re-experience the service Performance to which the customer was a party. This Review Type may be carried out using a specialized/simplified Rubric that may enable the customer to provide Feedback that may be shared with the performer. This exercise may enable a customer to link how they reacted during the Performance to specific details about the performer's specific behaviour. This may provide the performer with insight that they may not be able to glean from a general review or summary of the Performance by the customer or any other reviewer.

Virtual Mystery Shop—A Review Type in which a reviewer may review a Performance, interact with a Rubric Type that prompts the reviewer to answer specific questions about the Performance, and/or provide Feedback by answering each question. The Rubric may link each answered question to one or more episodes from the Performance upon which the reviewer bases their response to an answered question.

Visual Search Criteria—A set of visual clues that may be searched (e.g., by a video analytical algorithm) to identify Performances that may share certain attributes of interest. For example, the search may be carried out using any suitable video analytic algorithm, such as one based on facial recognition algorithms.

### Description of Example System Set-Up and Equipment

An example of the disclosed systems may include components including: a) one or more Sensors; b) one or more local data collection platforms (“Collectors”), which may be connected to, for example, a broadband network for receiving and transmitting data; c) one or more Head-end devices executing any appropriate software, and d) one or more user interfaces (e.g., remote access web interfaces) (“Review Interfaces”) through which one or more individuals may access the Head-end system. Examples of these components are described below.

Sensors (see definition) may include any analog or digital device that may generate (either directly or indirectly) a signal (e.g., a digital electronic signal) as a result of a change of state at a Site (e.g., presence of noise, entry or exit of a customer, etc.). Sensor(s) deployed at a Site may be selected with the objective of providing a relatively realistic and complete recording of one or more human behaviors, which may include a human interaction (which may also be collectively referred to as a “service performance” or Performance). Sensors may include, for example, cameras and/or microphones, as well as motion sensors, presence sensors, and radiofrequency identification (RFID) and/or other identification tools. A Sensor may be relatively fixed in place or may be mobile throughout a Site or among pre-specified Sites (such as a microphone/camera combination, which may be mounted in a Mobile Recording Appliance or on a headset or lapel pin). In the example of a mobile Sensor, the Sensor may be configured with the system so that its data may be transmitted from time to time (e.g., via a cradle or wirelessly) to a Collector associated with that Sensor. A Sensor may be pre-existing to a Site (e.g., already be in place for some prior purpose such as an existing camera used in conjunction with an existing recording device), or new and purpose-selected for its particular function within the system.

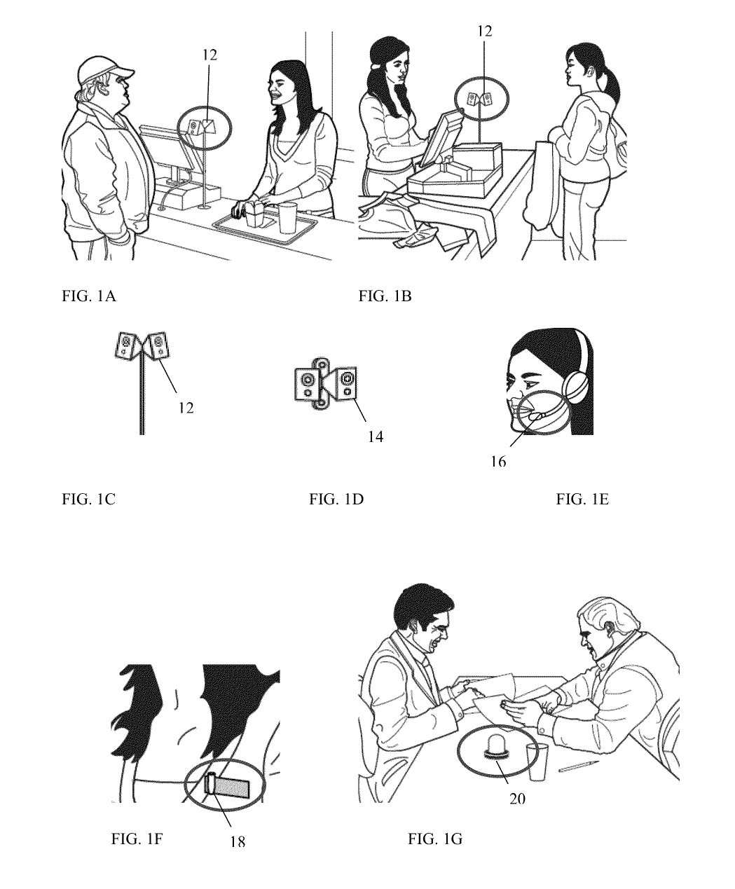

Examples of several different types of Sensor and Sensor combinations are shown in FIGS. 1A-G. In these figures, circles have been added to indicate the Sensor and/or Sensor combinations. As shown, one or more Sensors may be provided as a free-standing sensor 12 (FIG. 1C) (e.g., as a front counter pickup device located close to (FIG. 1A) or at a distance from (FIG. 1B) an interaction), may be provided as a mounted sensor 14 (e.g., a wall-mounted pickup device (FIG. 1D) or headset-mounted microphone 16 (FIG. 1E)), may be attachable to an article of clothing (e.g., a clippable microphone 18 may be incorporated into or attached to a nametag (FIG. 1F) that may be attached to clothing), may be portable (e.g., provided as a portable structure 20 (FIG. 1G) that may include a camera and/or a microphone), or any other suitable configuration.

The example Sensors of FIGS. 1A-1G may include cameras and/or microphones, which may be useful since human behaviour may be understood in terms of sights and sounds. In some examples, front counter devices may, for example, also include RFID readers to sense a nametag identifier so that the name of the employee who participated in a Performance may be associated with the recorded audio and/or video data. Other types of sensors may be used. For example, a presence sensor (e.g., a motion sensor) may be used to understand at what moment a customer arrives at a counter and leaves, for example in order to determine the beginning and end of a Performance. Several simple Sensors (e.g., a Sensor that only senses one type of data, such as only audio or only motion) may be used in combination with multi-level criteria to produce a more complex Sensor that may generate a signal when multiple criteria are met simultaneously. An example of a complex Sensor may be a “trust” sensor that may combine voice analysis with body posture sensing to infer the degree of trust between participants in an interaction. In some examples, a Sensor may operate in a virtual environment in which a virtual interaction is taking place. In such an example, the Sensor may sense changes in state in the virtual space in question rather than in the “real world”. Other types of sensors, based on various types of technology and complexity may be used as appropriate, such as depending on the situation, Site and/or Performance of interest. Although the disclosure describes certain Sensors and examples of information obtained using certain Sensors, it should be understood that any Sensors, combination of Sensors and any other suitable technology for obtaining Performance data may be used.

### On-Site Collection Platform or Collector

Data transmitted from one or more Sensors in a Site may be transmitted (e.g., wirelessly) to a server (the “Collector”, such as an on-site server or a remotely-located server) which may perform one or more of the following functions:
The Collector may run analytic programs to parse the incoming Sensor data (e.g., audio, video, other sensory data) in order to identify the beginning and end of Performances. For example, video analysis algorithms may be used to identify when a face enters, and subsequently leaves, the Customer Side Station associated with a Performance; audio analysis algorithms may be used to identify audio cues that may commonly indicate the start of a customer interaction (e.g., “how are you?”) and the end of an interaction (e.g., “good-bye”); Sensor data analysis algorithms may be used to identify when an object approaches and remains, for example, within 30-40 centimeters of a counter for more than 5 seconds, and then when the object abandons that space; and a combined algorithm may be used to combine all multiple sets of data into an inference that a Performance has begun at that Station. Other such algorithms and technologies may be used.
Data determined not to be associated with a Performance (e.g., any data outside of identified beginning and end points) may be deleted in order to maximize the capacity of data storage.
Data determined to be associated with a Performance may be further analyzed to generate meta-data, such an index of the Performance with the performer's name, the time of the Performance, the location and in-location service point, and/or what keywords were discussed during the Performance.
Performance meta-data may be stored (e.g., in a meta-data database of the Collector), and each component (e.g., audio, video, other sensor data) of the Performance data may be time-synchronized and stored on the server for a pre-specified number of days.
The indexed meta-data may be transmitted to the Head-end System, e.g., via the Collector's shared connection to a broadband connection.
The Head-end system may request one or more records associated with a particular Performance (e.g., chosen based on the meta-data provided by the Collector) from the Collector. In response, the Collector may transmit the requested data to the Head-end system in what may be determined to be the most efficient manner, for example subject to any network usage rules set for that particular site.

In some examples, Performance data and meta-data stored on the Collector may be maintained indefinitely, until selected for deletion (e.g., manually deleted by a system administrator). In some examples, such data may automatically be deleted upon expiry of a time period (e.g., a month), which may be specified by a User.

In the example of “mobile” Sensors such as Mobile Recording Appliances, these Sensors may be configured to transmit recorded data through a wired connection, for example via their charging connection (e.g., a cradle), or wirelessly (e.g., via blue-tooth) to a terminal (e.g., a computing device executing a “Collector” application) having a connection to the Head-end system (e.g., a User's personal computing device having an internet connection). For example, the Collector may execute a store-and-forward function that may compress data and transmit data in what may be determined to be the most efficient way (i.e., acting as a Collector). In a similar way, in an example where a virtual interaction may be carried out using separate computing devices, the computing devices facilitating each end of the virtual interaction may each execute an application that may compress data and transmit data in what may be determined to be the most efficient way (i.e., acting as a Collector).

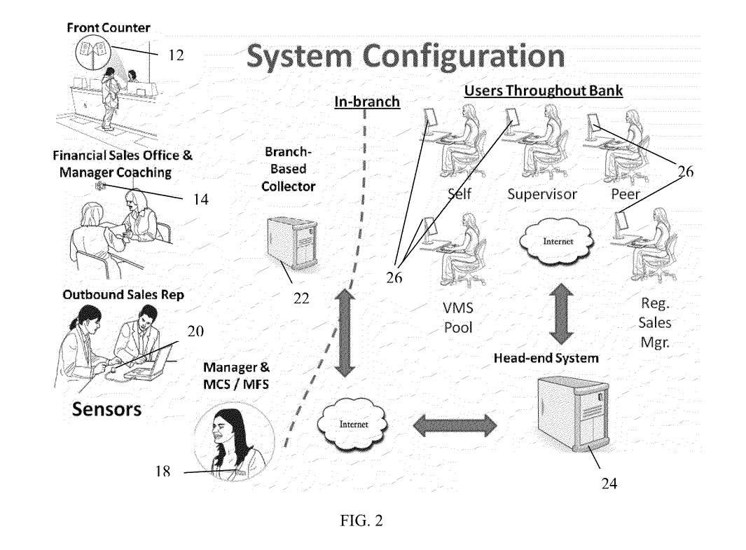

An installation of a Collector, for example in a bank environment (e.g., in a branch office), may be as illustrated in FIG. 2.

As shown in FIG. 2, one or more Sensors, such as semi-permanent or permanent microphone(s) and/or camera(s) (e.g., a free-standing Sensor 12) may be installed at a teller's counter, for example to record interactions with customers. One or more Sensors, such as wall-mounted microphone(s) and/or camera(s) 14 may be installed in office(s), such as a sales office or a manager's office, for example to record interactions between an employee and a customer, an employee and a manager, between employees, or other such interactions. One or more Sensors, such as mobile microphone(s) and/or camera(s) 20, may be used by sales reps at a customer's location, for example to record interactions with customers. One or more Sensors, such as a microphone 18 clipped to a nametag, may be worn by employees (e.g., managers), for example to record interactions with their employees as they move throughout the branch. Data from all such Sensors may be transmitted to a Collector (e.g., a branch-based server).

The Collector 22, in turn, may process the Sensor data and transmit relevant data (e.g., meta-data) to the Head-end System 24 (e.g., wirelessly via the internet). The Head-end System 24 may process the meta-data and, from time to time, may request specific Performance data from one or more Collectors 22 (e.g., from one or more branch offices) as appropriate (e.g., according to one or more Review Programs). The Head-end System 24 may also provide access to any of its functionality (e.g., including the ability to perform a Review) to one or more Users (e.g., at one or more terminals 26), and may collect any Feedback or other inputs obtained from such Users.

Collection of data by the sensors and/or processing of data by the Collector 22 and/or Head-end System 24 may be subject to privacy and security restrictions. For example, a customer may be notified that an interaction is being recorded and may or may not be provided with an option to suspend temporarily the collection of data from Sensors associated with that Station. In another example, the Collector(s) 22 and Head-end System 24 may transmit data using a secure intranet rather than the internet, to ensure privacy and security of the data being transmitted.

### Head-End System or Software and Web Interface

The Head-end System, for example running on a configuration of one or more servers (e.g., in wired or wireless communication with each other), may be responsible for one or more of the following functions:
A Company may enable access by its employees to one or more services provided by the system according to Company-specified rules. The Head-end System may enable a system administrator to set and/or to update these rules.
Individual Users may have unique password-protected portal access that may customize the scope of applications and Performances that they may access. The Head-end System may manage each User's identity, access, and/or permissions.
An authorized User may establish a Review Program, for example focused on a specified sample of Performances being delivered according to a specified schedule (e.g., one-time or recurring), for review using one or more specified Review Interface/Rubric combinations by one or more specified individuals or groups. The Head-end System may enable the specification of this Review Program, the selection of a representative sample of Performances to meet program specifications, and/or the assembly of this sample by retrieval of appropriate data from the appropriate Collectors.
Each time a particular Performance is scheduled to be reviewed under a Review Program, the Performance may be provided to be accessed by one or more designated reviewers, for example through a web browser. The Performance may be provided via a specified Review Interface using one or more specified Rubrics. The Head-end System may manage this process.
Each Review carried out in the context of a Review Program may become part of a collection of Feedback that may assist one or more Users in the development of their performance. To assist in this, information collected during Reviews may be stored, reported and/or shared with appropriate people in one or more specified ways. The Head-end System may manage this process.

### System Data Definitions

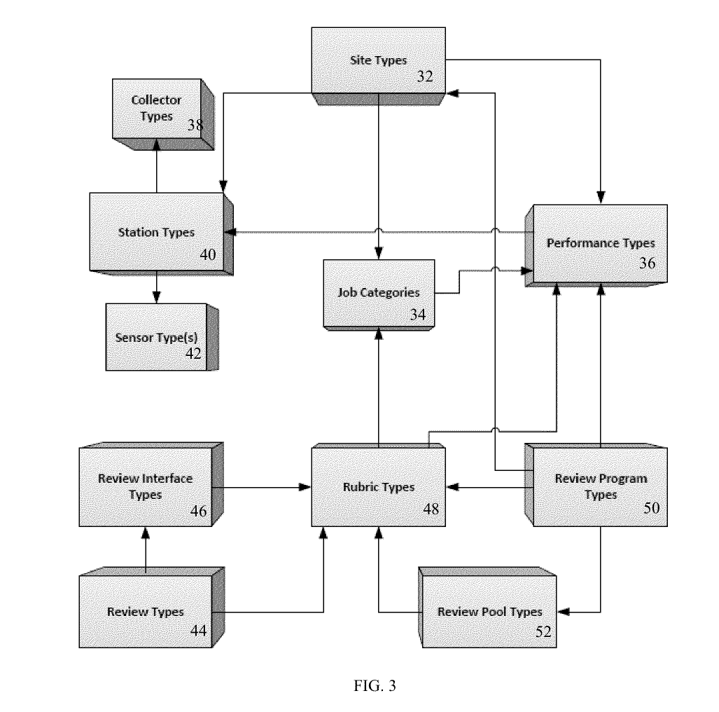

To assist the components of the system to inter-operate without each element having to know everything about the other, and to help enhance flexibility (e.g., for individual Companies to customize various aspects for their own purposes), the system may define certain abstract elements of its data model. Example abstract elements and their relationships may be, for example, as shown in FIG. 3. These example elements are described in further detail below.

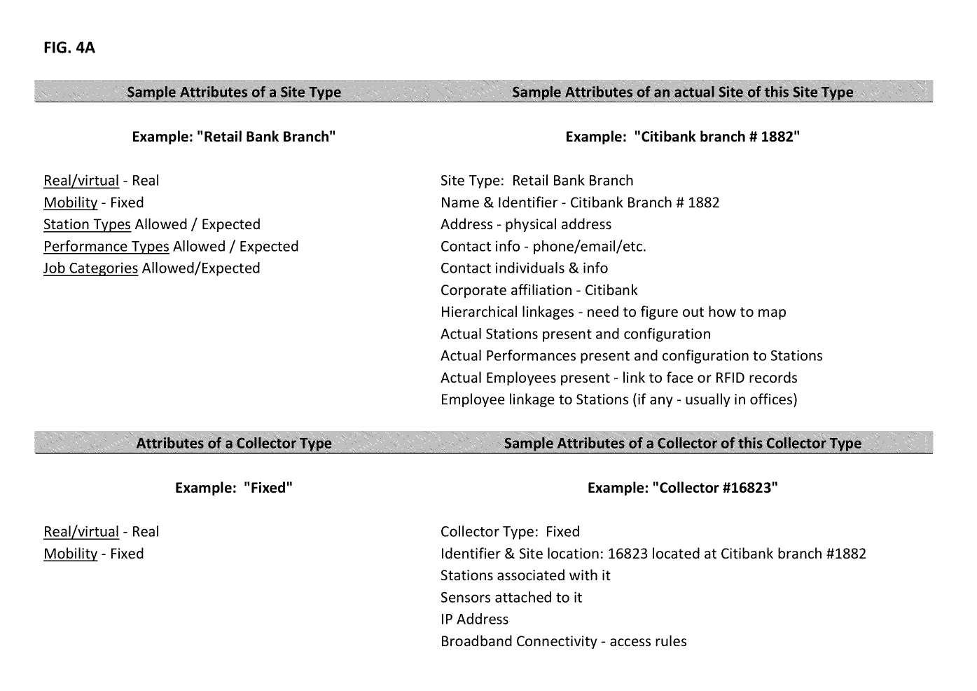

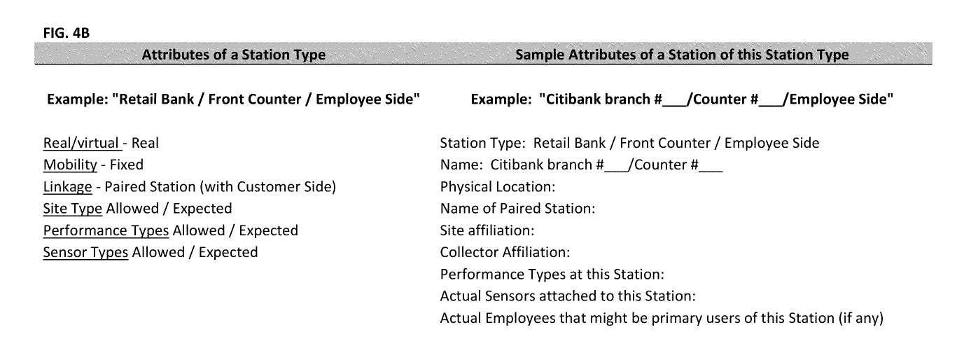

A Site Type (32) may identify a class of Sites that share common characteristics. Examples may include “retail bank branch” (e.g., a “Citibank retail branch”), a “branch manager's office”, or a mobile device (i.e., a Site that may move around, such as a mobile Sensor being worn by an individual). FIG. 4A shows a table illustrating sample attributes of a Site Type as well as attributes of a specific Site record that may use that Site Type.

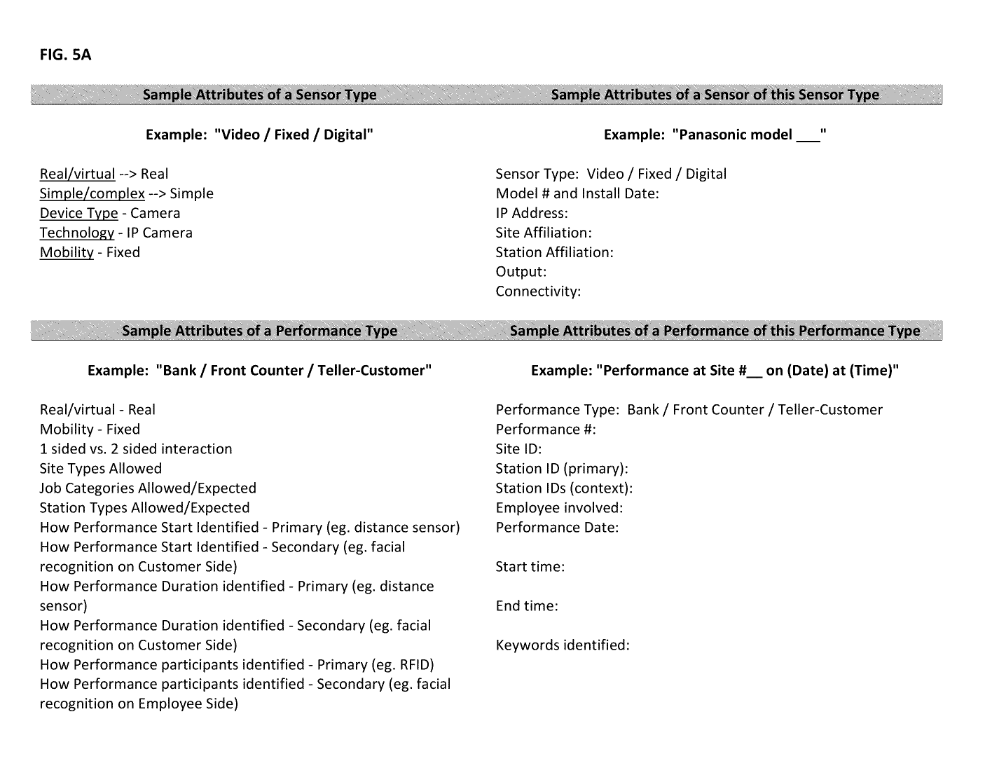

A Job Category (34) may be a class of positions within a Company that the Company may consider to be similar, for example with respect to competencies, skills, behaviours and/or other characteristics. FIG. 5B shows a table illustrating sample attributes of a Job Category as well as attributes of a specific Job record that may use this Job Category.

A Performance Type (36) may identify a class of Performances that share common characteristics, such as a customer exchange with a teller at the front counter in a retail bank, or a coaching session by a branch manager of an employee in their office. FIG. 5A illustrates sample attributes of a Performance Type as well as attributes of a specific Performance record that may use this Performance Type. A specific Site Type may have specific Job Categories associated with it (e.g., certain types of employees may work at certain types of Sites) and/or specific Performance Types associated with it (e.g., certain types of interactions may take place at certain types of Site). Each Job Category may have one or more Performance Types associated with it (e.g., certain types of employees may carry out certain types of interactions).

A Collector Type (38) may be a class of Collectors that share common characteristics. Examples may include a “Fixed” collector that may be in a fixed, permanent or semi-permanent location, such as a dedicated device housed at a remote Site; a “Mobile” Collector may be a software application executed by a third-party computing device, such as one owned by a User of a Mobile Recording Appliances; and a “Virtual” Collector may assemble a Performance from two or more computing devices, for example by capturing and consolidating the various video and/or audio data associated communication between the two or more devices, such as during a Skype call or in a 3-D virtual immersive environment. One or more Collectors of one or more Collector Types may be provided at any Site. FIG. 4A shows a table illustrating sample attributes of a Collector Type as well as attributes of a specific Collector record that may use that Collector Type.

A Station Type (40) may identify a class of Stations that share common characteristics. For example, there may be a teller's counter (e.g., Employee side) in a retail bank, or a branch manager's office (e.g., Customer side), or the front counter of a fast food restaurant (e.g., both sides), or a Mobile appliance. FIG. 4B illustrates sample attributes of a Station Type as well as attributes of a specific Station record that may use that Station Type.

A Sensor Type (42) may identify a class of Sensors that share common characteristics. For example, a Sensor (e.g., camera or microphone) might be Fixed or Mobile; a Sensor may be Simple or Complex (e.g., aggregated from multiple Simple Sensors). A possible kind of Virtual Sensor may be a Sensor that exists in a virtual immersive 3-D space that may act in the same way that a real Sensor would act in a real environment. By using a defined Sensor Type rather than specification of an actual Sensor, different models and/or combinations of Sensors (e.g., different cameras or microphones) may provide data to the system without any other system component having to know any details about the specific Sensor. FIG. 5A illustrates sample attributes of a Sensor Type as well as attributes of a specific Sensor that may use that Sensor Type. A Site Type may have one or more specific Station Types associated with it, and specific Station Types may require one or more specific Collector Types. A specific Station Type may also require one or more specific sets of Sensor Types to accurately capture the desired Context Views of a Performance in question. A specific Performance Type may require one or more specific Station Types to capture the Performance.

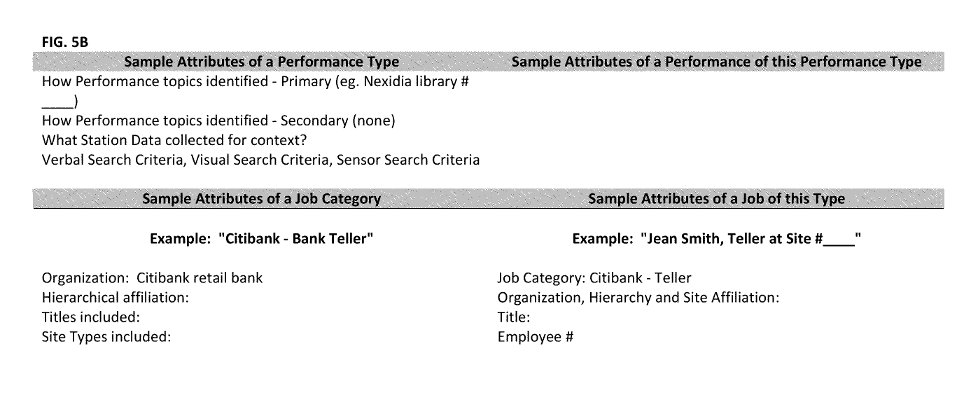

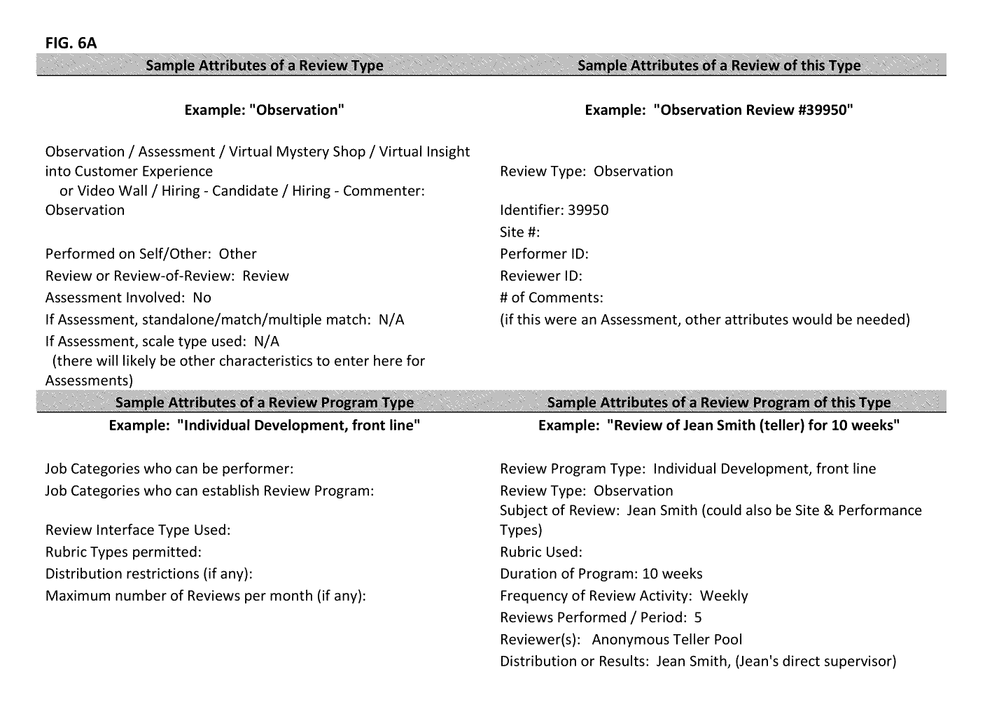

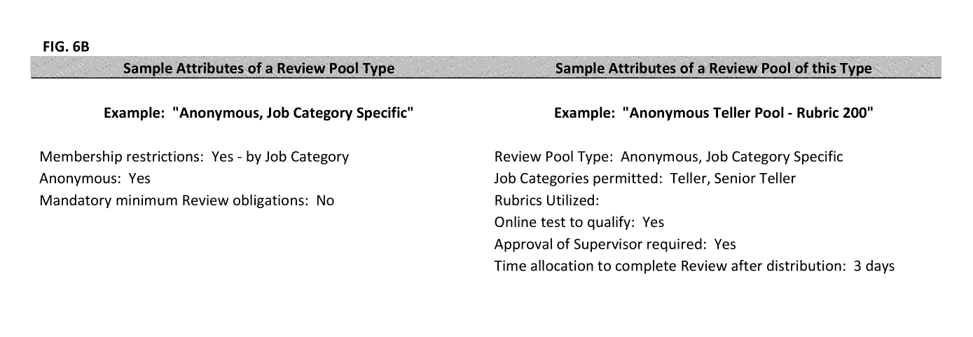

A Review Type (44) may be an identifier of a class of Reviews that share common characteristics, for example with respect to whom the reviewer is, the type of mental activity involved, and/or the nature of the Feedback provided. Examples of Review Types include Observations, Assessments, Virtual Mystery Shops, and Virtual Insight into Customer Experience sessions. FIG. 6A illustrates sample attributes of a Review Type as well as attributes of a specific Review record that may use that Review Type.

A Review Interface Type (46) may identify a class of Review Interfaces that share common characteristics in terms of their display or representation strategies for a Performance, a Rubric, and/or Feedback. While present disclosure is illustrated with 2-D interface designs, Review Interface Types may also include 3-D interface designs.

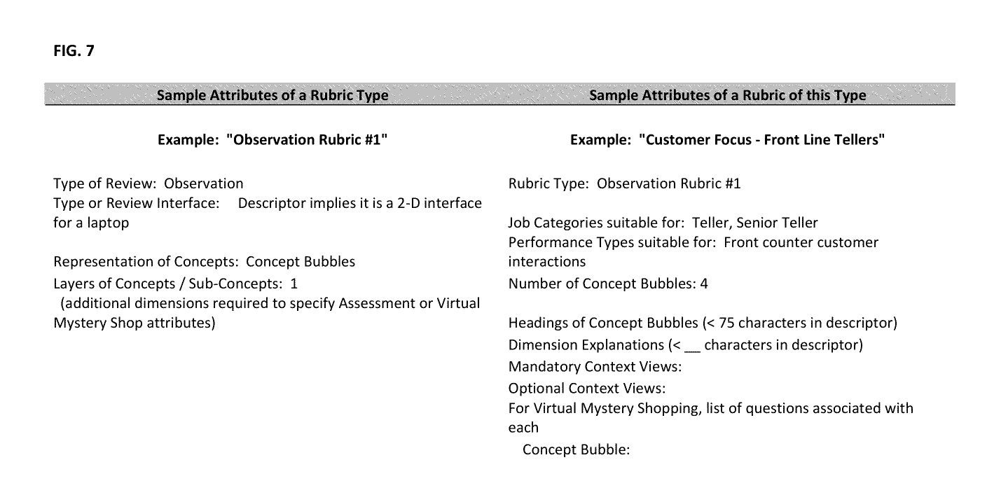

A Rubric Type (48) may identify a class of Rubrics that share common characteristics, for example including, among other things, their strategies for representing concepts, for prompting observation or thought about a concept, for soliciting Feedback from a reviewer, and/or for capturing that Feedback as it is provided. FIG. 7 illustrates sample attributes of a Rubric Type as well as attributes of a specific Rubric record that may use that Rubric Type. The requirements of a particular Review Type may require one or more suitable Review Interface Types, as well as one or more groups of Rubric Types that may support the Review Type most effectively. The layout of any particular Review Interface Type may have one or more specific Rubric Types that are supported by it. A static or evolving library of Rubric Types may be developed for every Review Type/Review Interface Type combination.

A Review Program Type (50) may identify a class of Review Programs that share common characteristics such as, for example, the authority required or Job Category able to establish a Review Program, or the way in which Feedback may be distributed and shared. FIG. 6A illustrates sample attributes of a Review Program Type as well as attributes of a specific Review Program record that may use that Review Program Type.

A Review Pool Type (52) may identify a class of Review Pools that share common characteristics such as membership restrictions or anonymity of members. FIG. 6B illustrates sample attributes of a Review Pool Type as well as attributes of a specific Review Pool record that may use that Review Pool Type. A specific Review Program Type may specify whether a Review Pool is used and, if so, may specify the appropriate Review Pool Type, and may also specify the appropriate Rubric Types which may be used. Separately, a specific Rubric Type may specify the Performance Type upon which it may be executed and may also specify the Job Category to which it applies.

U.S. Pat. No. 7,085,679, which is hereby incorporated by reference in its entirety, describes an example setup for video review of a Performance, and may be incorporated as part of the disclosed systems and methods.

### Example Process Flows for Collecting Performance Data

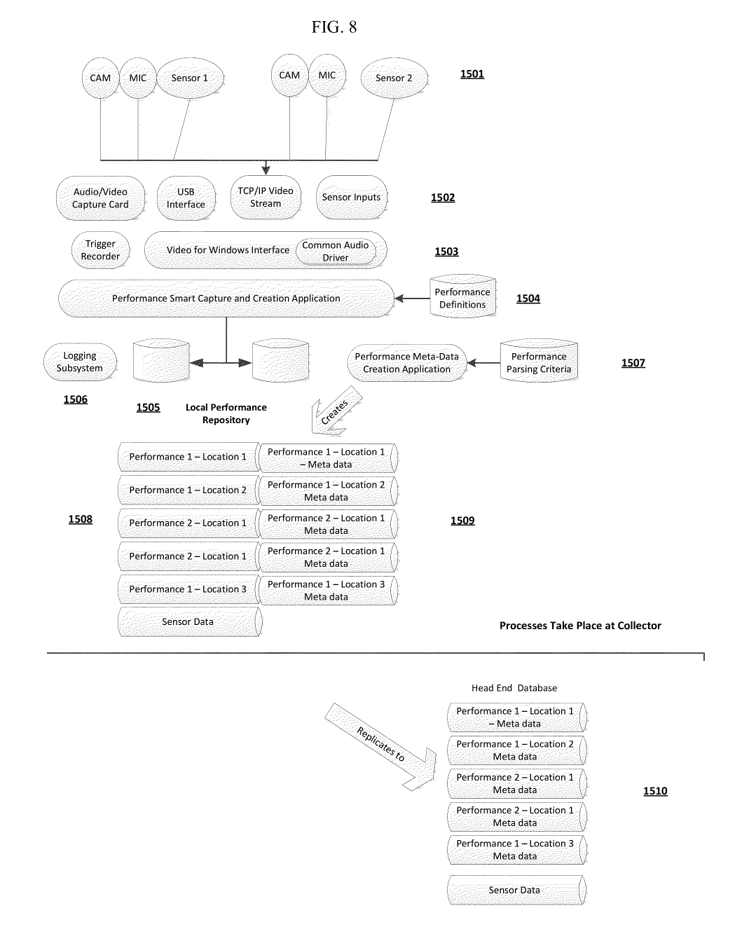

An example process flow diagram of sample steps involved in an example of a process of recording, processing, indexing and storage of Performances on a Collector is included in FIG. 8. Groupings of Sensors (for example, each including a camera, microphone and one or more other Sensors) (1501) may be associated with one or more Stations at a Site. These Station(s) may be linked (e.g., via wired or wireless connection) to a software application (e.g., resident either on a main Collector server or on intermediary servers that may pre-process data from a subset of Stations and may relay that data on to the main Collector). This application (1502) may include one of more sub-applications which may capture and/or process various types of raw data from one or more Sensors—for example, video signals from analog, USB or IP cameras, and audio and other Sensor data (whether incorporated into the video feed at the camera or delivered separately). A common interface module (e.g., Video for Windows or another suitable application based on a different operating system) may consolidate data (e.g., video, audio and other Sensor files) from each of these different capture processes and may make the data available in a common format for further processing (1503).

A Performance Capture and Creation Application (1504) may use a database of Performance criteria to parse the incoming data, to Bookmark the beginning and ending of Performances, to export the resulting individual Performance files to a mirrored Performance database (1505) and/or to delete the remaining data deemed to be unassociated with specific Performances. A logging subsystem (1506) may capture the various actions taken by 1504 in order to facilitate later analysis of the performance of that application. A separate Performance Meta-data Creation application (1507) may analyze the Performance(s) stored in 1505, for example referring to its own Parsing Criteria database, in order to generate an index of Meta-data (1509) associated with each Performance record (1508). Such Meta-data may include information such as time/date of Performance, identity of employee/Performer, keywords used during the Performance, etc. The Performance records may not be transmitted on to the Head-end System at this time but may remain stored in 1505, associated with their respective meta-data, until requested by the Head-end System. The Meta-data, however, may be periodically transmitted to the Head-end System so that the latter may have up-to-date record(s) of Performance(s) that are stored on the Collector in question.

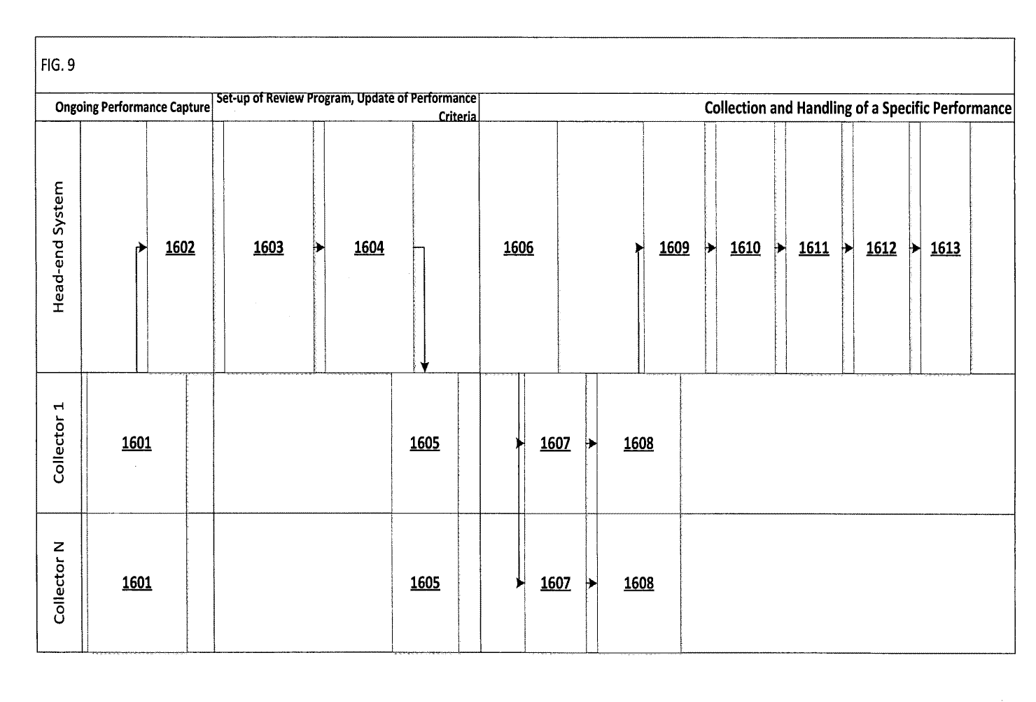

An example process flow diagram of the steps involved in the set-up and compilation of a Review Program is set forth in FIG. 9. As described above, ongoing Performance capture processes on one or more Collectors (e.g., Collectors 1 to N) may create Performances from incoming Sensor data, and may parse and/or index them to create a meta-data dataset associated with each Performance dataset (1601). Meta-data datasets from each Collector(s) may be periodically transmitted on to the Head-end System, which may maintain a log of which Performances, for example including related meta-data, are stored on each Collector (1602). A User (e.g., an authorized User) may establish a Review Program and may specify the required data (1603). For example, the Review Program may specify the performer, performance specifics (e.g., performance type, time of day, topics covered, etc.), how many performances to review, how often performances are reviewed, and/or the Review Interface/Rubric to be used for reviews. The Head-end System may receive instructions for the Review Program specification and may break the specification into components for defining the Review Program (1604). For example, the Head-end System may set up a Review calendar (e.g., defining the number and/or frequency of Performance reviews), determine which Collector(s) will be involved (e.g., by determining the Collector(s) associated with the office of a specified performer) and/or determine new or updated definitions for Performance creation or parsing criteria by each Collector. The Collector(s) may receive any updates or new Performance criteria from the Head-end System (1605).

At the appropriate time, for example as determined by the Review Program calendar, the Head-end System may select one or more specific Performance records from one or more Collectors that meet Review Program criteria (1606) and may send request(s) to each Collector to transmit data associated with these specific Performance(s), which request(s) may be received at respective one or more Collectors (1607). Each Collector may determine how data should be transmitted, for example by consulting any traffic rules associated with its Site (e.g., instructions provided by Company information technology (IT) staff about how and when video data, for example, can be sent from the Site in order to minimize inconvenience to Site personnel and processes that also use the broadband connection) and transmit the requested data as expeditiously as possible to the Head-end System (1608). The Head-end System may receive this data from each Collector, store it, and then may notify the appropriate reviewer(s) that a Review is ready for access (1609).

When each reviewer logs into their respective portal, the Head-end System may deliver a Review using the appropriate Rubric (1610). Once the Review is complete, the Head-end System may store the review data, may notify the relevant performer that a Review of their Performance(s) has been completed and is ready for viewing, and may update the activity log for the reviewer (1611). When the performer logs in to a portal, the Head-end System may deliver the recorded Performance(s) along with one or more Reviews by the reviewer(s) in 1610. The performer may be provided with an option to rate each comment and/or assessment associated with each Review, and the system may store those ratings, for example in a review database of the Head-end System. The system may also provide the performer with an option to store all or part of the Review in their personal learning files (e.g., on a hard drive of a personal computer) (1612). At that point, the activity and ratings logs for both the reviewer and performer may be updated (1613).

Steps 1606 to 1613 may be repeated (e.g., from time to time) as often as specified in the Review Program until that Program ends.

### How the System May be Used by a User

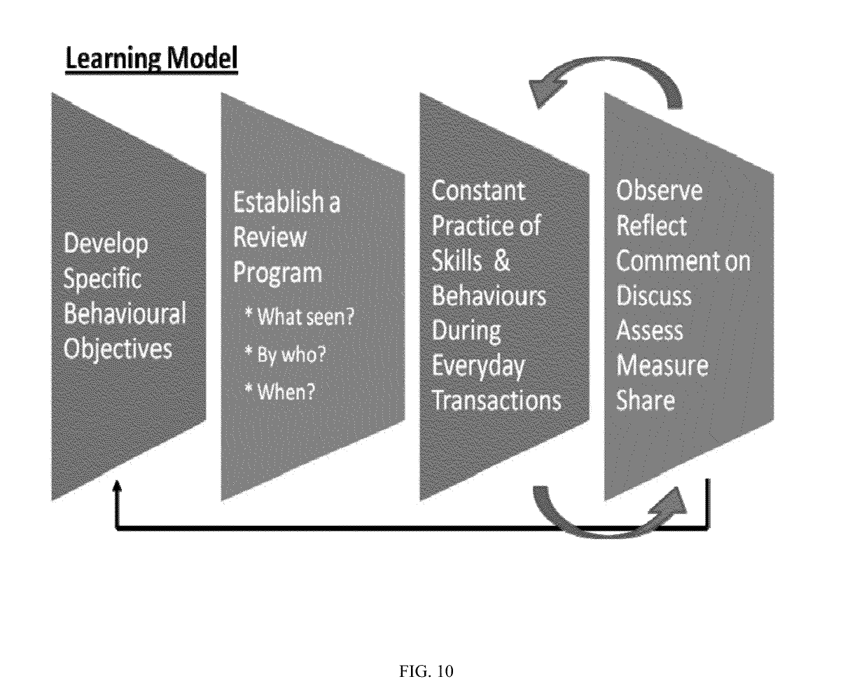

To help individuals and front line service groups to consciously, systematically and efficiently change their behaviour, an example basic model for usage of the system is illustrated in FIG. 10.

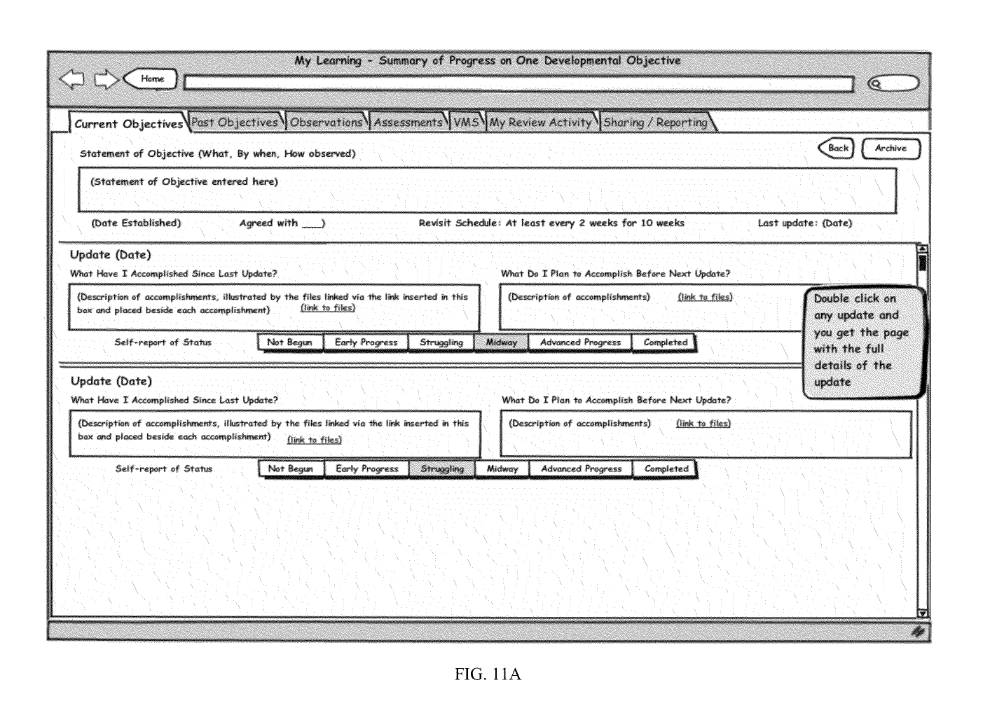

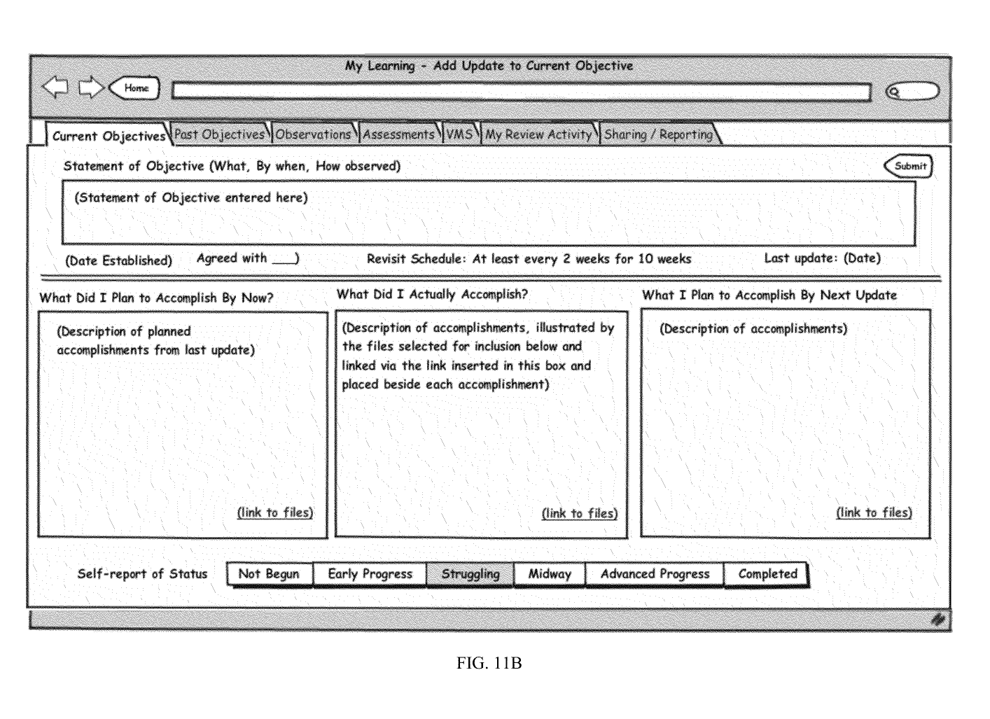

Each individual or employee, for example working with a supervisor, coach, manager or, if they have none of these, working on their own, may begin by establishing clear “bite-sized” behavioural objectives to work on for a defined period of time. The Head-end System may provide individuals with authorized (e.g., password-protected) access via a personalized portal, which may be accessed via a suitable computing device, such as a workstation or personal computer. Within this portal, there may be provided a private area, for example for documenting current developmental objectives, as well as for storing past objectives and progress made thereon, a succinct statement of what they are working on, for how long, and/or how regularly they will review and document their own progress, among other goals. Users may have sole responsibility for populating and maintaining this screen, although they may grant access to, for example, their supervisor, coach or mentor to be able to observe what they write and/or record (e.g., via audio input). This module may serve as a chronicle of each User's goals as well as of periodic reflections on their experiences while working on those goals (e.g., what they tried, what worked, what didn't work and why). Users may be provided with system tools to “illustrate” what they are talking about, for example with examples of specific Performances that may be linked to points in their commentary. A sample screen for how this type of functionality may look is illustrated in FIGS. 11A and 11B.

As shown in FIGS. 11A and 11B, the individual may be provided with options for reviewing and inputting past, current and future behavioral learning objectives, including options for tracking progress and updating the status of the learning. Such information may be provided solely for the individual's use to track personal progress, or may be made available to other persons, such as an authorized supervisor.

Referring again to FIG. 10, at the beginning of work on any particular behavioural objective, the individual (and any colleague they are working with) may establish a Review Program. A Review Program may, for example, define one or more of the following attributes: (i) the type(s) of Performance(s) to be watched (e.g., a specific employee, a time of day, use of certain keywords, etc.); (ii) which individual(s) will watch them; (iii) how many Performance(s) may be watched per period; (iv) for how many periods; and (v) what Rubric may be used. Review Programs may include the performer as a reviewer (e.g., self-observation and self-reflection may be foundations of this type of learning). Once the desired Review Program is defined in the Head-end system, the individual may personally request each third-party reviewer to participate in the Program, which may reinforce a sense of personal accountability. The system may facilitate the delivery of the request to each potential reviewer, and may also facilitate transmission of the response (e.g., acceptance/refusal). Notification of acceptance from a reviewer may trigger the beginning of the component of the Review Program associated with that reviewer. The Head-end system may collect a representative sample (e.g., as defined in the Review Program) of Performance(s) by the performer in question, for example by requesting appropriate Performance data from one or more Collectors. The Head-end System, upon receipt of such data, may compile the data and make these Performance(s) accessible by each reviewer (e.g., via a terminal that may log into the Head-end System) to be watched at their convenience (see FIG. 9, for example).

Once a Review Program is underway, the individual or employee may simply continue their normal operations, for example keeping in mind the behaviour that they are working on. Reviewers, including the individual, may use system tools to observe, assess and/or otherwise provide Feedback on the Performance(s) they are shown. This range of Feedback may be made available on an on-going basis to the individual to support their behavioural learning and to keep them focused. Such Feedback may be colloquially referred to as a “gametape” and an “informal, ongoing 360° review.”

A “gametape” may be analogous to the methods used by professional athletes. Professional athletes may watch recordings of themselves and their team's performances to understand what happened, what worked and didn't work, and how they can improve their game. For example, professional football players may watch a gametape in the middle of games, such as immediately following a play, so they can speed up their learning by understanding what happened immediately following the event, while the details are fresh in memory. In a similar manner, the disclosed systems and methods may enable an individual to watch “gametape” of their human interactions, but to do so as and when convenient during their day.

FIG. 12 illustrates example facets of a “360° review”. The individual being reviewed (e.g., an employee) may receive feedback from reviews of a Performance by different sources including, for example, the individual herself, a supervisor, an external coach or mentor, a peers, a regional sales or product manager, an anonymous peer or superior, and a customer, among others. Other reviewers may supply feedback, as appropriate. It should be understood that not all Performances may be suitable for review by all reviewers. For example, privacy concerns may prevent review of closed-door customer interactions by an external coach.

Members of an organization, such as executives and other team performers, may periodically or occasionally arrange for reviewers, such as colleagues, superiors, direct reports, and/or outside relationships, to provide them with anonymous Feedback in what may be referred to as a “360 review session”. Software offerings may be available (e.g., conventional software currently available on the market) to help simplify the aggregation of these comments, but such 360 reviews may remain complex and time consuming to set up and to manage using conventional systems and methods. As a result, they may be done infrequently, often in connection with formal performance reviews, which may formalize the review process. Such formal reviews may be global in nature as opposed to addressing specific aspects of a particular behaviour. Such reviews may help individuals to reflect on their development needs, but may not provide regular reinforcement of specific behaviours. The disclosed systems and methods may provide the benefit of Feedback from multiple perspectives, backed up by recordings of actual episodes, that may focus on specific behaviour and may be delivered relatively quickly and/or informally.

### Observation Reviews

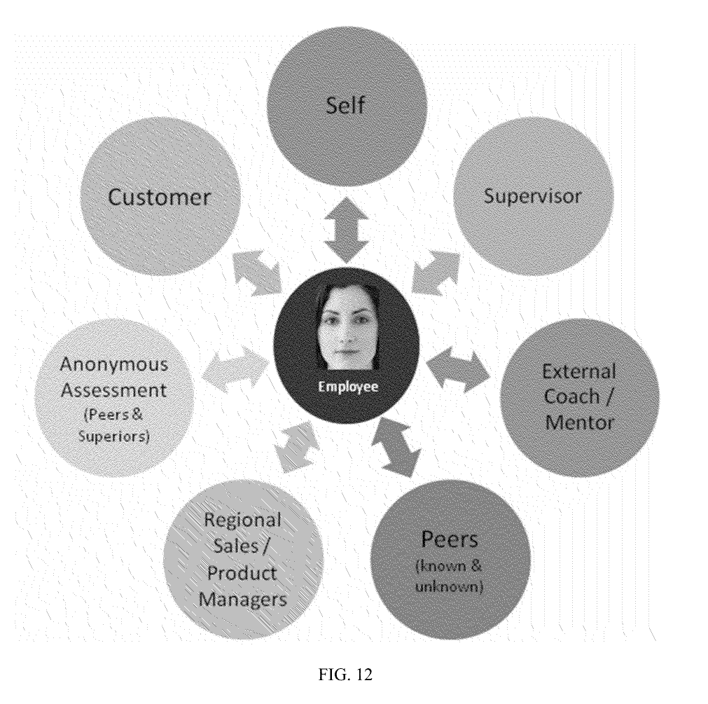

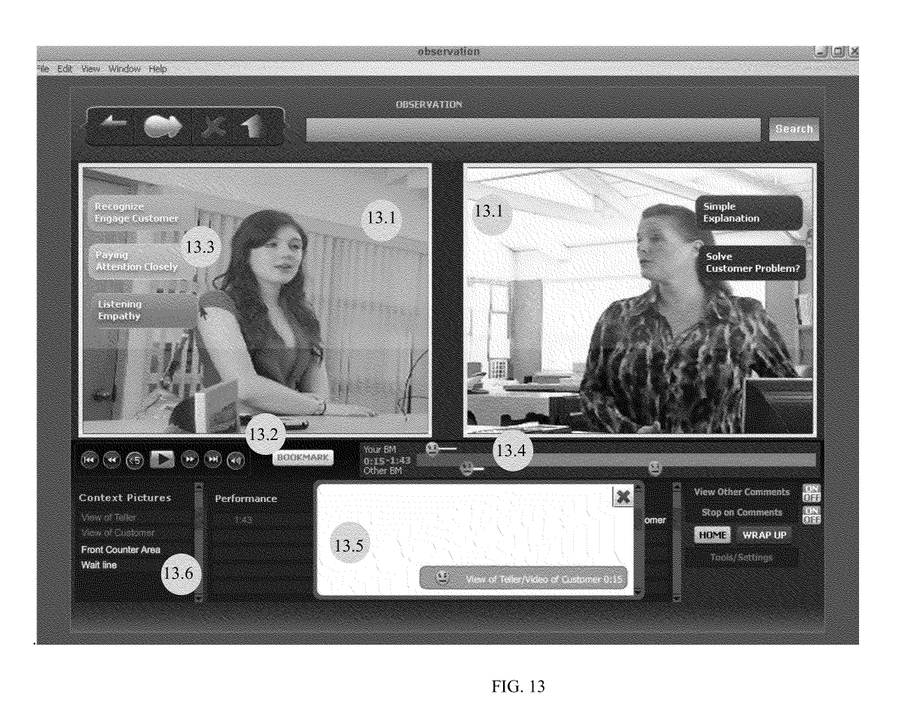

An example of a Review Interface and Rubric suitable for an Observation Review is illustrated in FIG. 13. In this example, the interface is illustrated in the context of an interaction between an employee at a bank office and a customer, although various other context and interaction types may be possible. Aspects of FIG. 13 are described below, with respect to reference characters shown in the figure.

13.1—Video images—In this example, the Review Interface may include video images from the viewpoint of a customer and a teller in a front counter interaction. The reviewer may input an instruction to begin playing the Performance, which may cause the video images and any accompanying audio to play. These videos may be synchronized, along with any associated audio feeds. In cases where more than two simultaneous images may be required to portray a Performance, the Review Interface Type may be modified to accommodate more Context Views simultaneously. In other examples, less than two (e.g., only one or none) video images may be provided.

13.2—Bookmark button—When the reviewer wishes to make a comment associated with a certain time point in the Performance, the reviewer may indicate this by selecting the “Bookmark” button. This action may pause the video and any accompanying audio, may insert an icon onto the timeline (13.4) of the video corresponding to the time point, may bring up one or more Concept Bubbles (13.3) onto the screen, and may bring up a “Comment box” (13.5) for inputting the reviewer's comments. The comment box may automatically include relevant information associated with the bookmark and comment such as: icon type, names of relevant Context View(s) with which the comment is meant to be associated, and/or time on the timeline to which the comment applies. In some examples, the reviewer may select any specific time point in the Performance for inserting the Bookmark. In some examples, the reviewer may additionally select a time period or duration in the Performance (e.g., by defining start and end time points for a bookmark).

13.3—Concept Bubble—One or more Concept Bubbles (e.g., according to the design of the Rubric) may be super-imposed on the screen in response to the creation of a Bookmark, and may prompt the reviewer to consider specific aspects of the Performance. Each Concept Bubble may define a specific aspect, dimension or category of the Performance to be considered and, taken together, they may define an Observation Rubric. The concept(s) in each Concept Bubble and in the defined Observation Rubric may be customized, for example by a supervisor or manager of a Company, to reflect issues of importance or relevance. Selection of a Concept Bubble by the reviewer may associate the created Bookmark and related comment to the particular concept defined by the selected Concept Bubble.

13.4—Timeline—The Performance timeline slider may indicate the current time point within the Performance being reviewed. The timeline may also indicate the location of any previously created Bookmarks. Dragging this slider may advance or rewind the Performance. Selection of any Bookmark icon on this timeline may bring the Performance to that time and may display any Comment Box associated with that Bookmark.

13.5—Comment Box—The Comment Box, in some cases with associated Bookmark information, may be displayed after a Bookmark has been created and, depending on the definition of the Review Program, may or may not be displayed any time thereafter when the Performance is reviewed again (e.g., by the same or a different reviewer). The reviewer may input a comment (e.g., a text comment) in the Comment box that may be associated with the time point or period bookmarked by the reviewer. In some examples, the comment may be an audio comment, for example inputted through the use of a microphone or headset, that may be associated with the time point or period bookmarked.

13.6—Context Picture—The Context Pictures box may list one or more available camera/audio perspectives or Context Views for the reviewer to select. Each Context View may include, for example, video, audio and/or any other Sensor data. Each Context View may be time synchronized with the timeline (13.4), so that the reviewer may switch between different perspectives seamlessly by selecting a desired Context View from the Context Pictures box.

In some examples, a Review Interface Type may be developed to enable the reviewer to experience an Observation in a 3-D virtual immersive space rather than via a 2-D screen, in which case functionalities and activities discussed above may remain similar.

An example process flow diagram showing example steps involved when the system executes an Observation Review is set forth in FIG. 14. The process may take place using an interface similar to that described with respect to FIG. 13.

As illustrated in FIG. 14, the process may begin when a User, such as an authorized Corporate department or manager within a Company defines one or more Rubrics for use in an Observation Review Type, which may reflect one or more perspectives of interest with respect to specific Performance Types (1701). Each Company may develop a library of Rubrics that may pertain to each Performance Type relevant to the Company, and each Rubric may provide different insights into that Performance Type. These Rubric(s) may be loaded into the Head-end System, and the Rubric(s) may be stored, such as in a Rubric database or library of the Head-end System (1702). The Head-end System may then be able to make these Rubrics available for use, for example by authorized employees throughout the organization.

A Review Program may be defined (1703), for example when a particular employee/supervisor team decides that the employee could benefit from an Observation Review Program. The definition of the Review Program may also specify one or more reviewers or reviewer types (e.g., peers or other colleagues) to be used in the Review Program. The employee may be made responsible for requesting (e.g., via the Head-end System) that each potential reviewer agree to participate in the program. This may provide the employee with a sense of personal responsibility for the results of the program. Assuming a reviewer (e.g., a peer) agrees to participate (1704) in the Review Program, an acceptance from the reviewer may be transmitted back to the Head-end System, and the Head-end System may activate the program to enable access by that reviewer (1705). The Head-end System may notify any related Collector(s) of any new or updated Performance criteria required to support the new Review Program and may request the Collector(s) to provide any such required Performance data (1706). In some examples, the Head-end System may also specify the method by which Performance data should be transmitted from the Collector(s) (e.g., periodically, at defined times and/or dates, security, etc.). Thereafter, on an ongoing (e.g., periodic) basis during the duration of the Review Program, the relevant Collector (e.g., at the Site of the performer being reviewed) may transmit any recorded Performance data which may be required by the Program (1707). The Head-end System may receive and store this data and may then notify the reviewer that a Performance is available for them to review (1708).

The reviewer may then log into their portal and may perform the Review (1709), for example using an interface similar to that described with respect to FIG. 13. Data generated and associated with a completed Review may be stored by the Head-end System (e.g., in a review database) and a notification may be sent to the performer that a completed Review of them is available (1710).

The performer may log into their portal, may access the Review (e.g., watch the Performance with any accompanying Feedback), may rate the usefulness of each comment, may log any insights into a record of their personal developmental objectives and, if appropriate, may discuss issues with their supervisor (1711).

The Head-end System may then update records of the performer's developmental objectives (e.g., according to the performer's update) (1712) and the reviewer's ratings track record (e.g., according to the performer's evaluation of the usefulness of the reviewer's ratings) (1713).

Steps 1707 to 1713 may correspond to an individual Observation Review, and these steps may be repeated for additional Observations (e.g., by different reviewers and/or for different Performances) until the time duration for the Review Program expires or the Review Program is otherwise completed (e.g., by the performer meeting all learning objectives) (1714). Results from the completed Reviews may be transmitted to Corporate HR personnel for sampling, for example to ensure that the Rubric(s) in question is(are) being used successfully (1715).

In some examples, a completed Review may include one or more Bookmarks on the timeline of a Performance, with each Bookmark associated with one or more Concept Bubbles and/or one or more comments. A completed Review may be made available to the performer, as well as other persons such as that individual's supervisor, coach or mentor.

The Evaluations of, and Feedback provided to, an employee (i.e., the performer) by another employee (i.e., a reviewer) in the course of a Review may then become subject to a structured rating process by the performer. This process may help to ensure that the evaluation skills and rating judgments manifested by different reviewers are relatively consistent, and that reviewers who are consistently rated as extreme (e.g., very high or very low ratings) by the performers they review in one or more dimensions of their assessment activities may be identified relatively quickly. For example, Feedback provided by Employee 1 about Employee 2's Performance may be received and reflected on by Employee 2. As Employee 2 watches the video and reads the comments and assessments (if any) associated with each Bookmark, Employee 2 may be provided an option to rate the quality of the comments/assessments made by Employee 1. For example, Employee 2 may rate a piece of Feedback as “Disputed”, “Appreciated” (which may be the default rating), “Helpful” or “Very Helpful”. Employee 1 may be anonymous to Employee 2, in which case there may be no personal bias in the rating of that Feedback. However, if Employee 2 selected a rating of “Disputed” in connection with any comment or assessment, Employee 2 may be required to justify such a rating, for example by relating it to a specific behavior displayed in the episode in question and explaining why they disagreed with Employee 1's comment or assessment.

The sum total of ratings provided by Employee 2 and other recipients of Employee 1's Feedback activity may provide a “track record” that may accumulate and be associated with Employee 1. Employee 1 and his/her supervisor may discuss the meaning of this evolving track record, for example to the extent that particular rating trends began to diverge from the organization's average. For example, overall ratings of different employees may be monitored to target employees having a track record of extremely Helpful or Disputed ratings, which may prompt each such employee's supervisor to have a discussion with the employee about why their assessments are consistently different from the average. Various competitions, games or prizes for particular success in providing quality Feedback may be established to motivate/reward effort for reviewers. This type of social ratings process may be useful for discouraging deceitful behaviour.

### Assessment Reviews

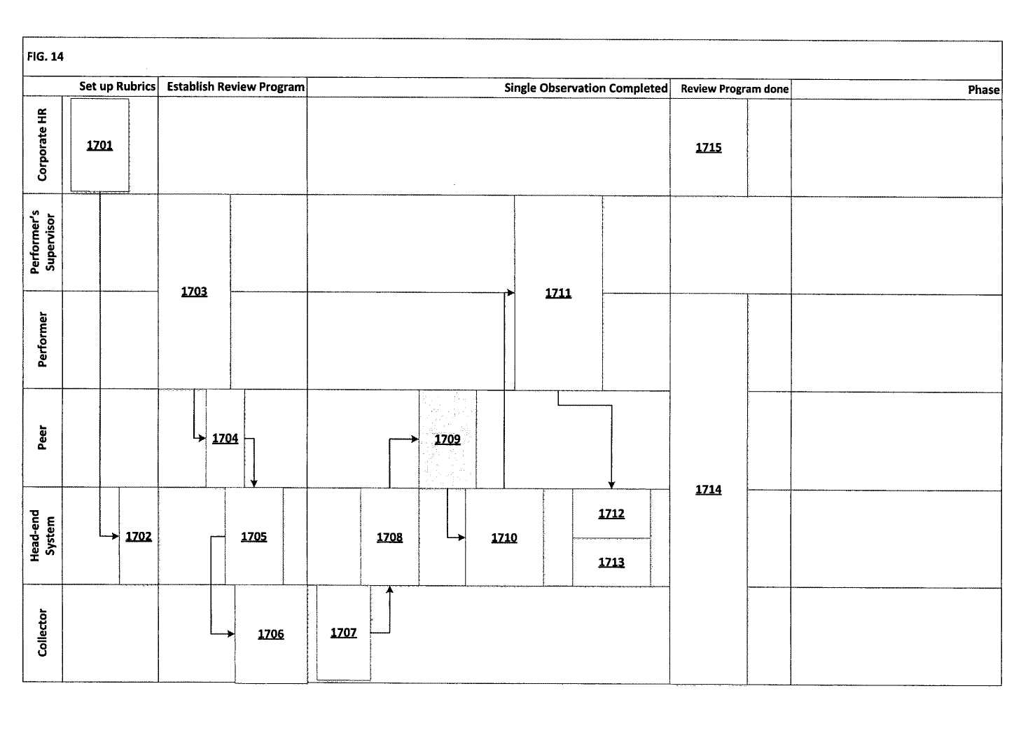

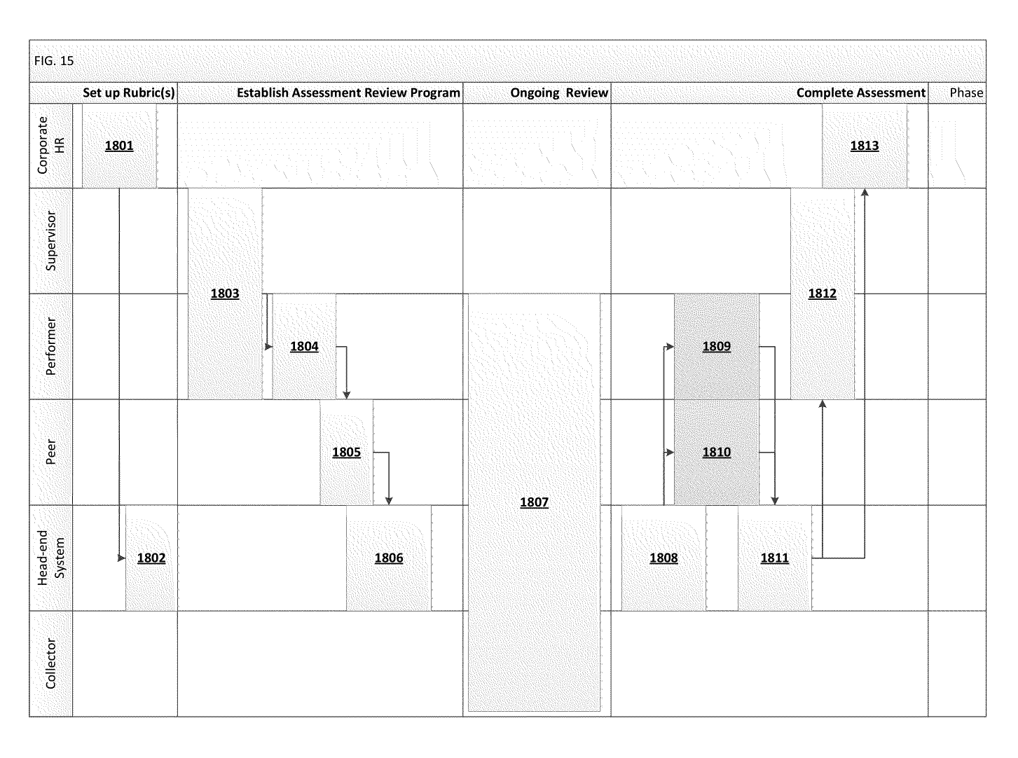

An example process flow diagram for the completion of an example Review of an Assessment type (which may be referred to below as an Assessment Review) is set forth in FIG. 15. An illustration of an example Review Interface and Assessment Rubric suitable for an example Assessment Review is provided in the screenshots laid out in FIGS. 16 to 24.

An objective of an Assessment may be to watch multiple examples of the behaviour (e.g., multiple Performances) of a particular individual and then to use these examples as a basis for, and as a justification and/or illustration of the reason, why an individual is assessed in a certain way, for example with respect to each of one or more core competencies.

In FIG. 15, one or more Rubrics to be used for an Assessment Review Type in connection with each Job Category may be created (e.g., by a Corporate Human Resources (HR) department of a Company), for example based on a competency model for that Job Category (1801). These Assessment-related Rubrics may be loaded into a library in the Head-end System, which may then make such Rubrics available for use, for example by authorized Users (1802). In some examples, an employee and their supervisor may agree on the definition and structure of an Review Program made of up Assessment type Reviews, for example either a single Review (as shown in FIG. 15) or a longer Review Program (1803). The Assessment Review Program may be defined in terms of, for example, the performer(s) involved; the reviewer(s) involved; the number and/or frequency of reviews; the responsibilities of the performer(s), colleague(s), reviewer(s) and/or supervisor; the recipient(s) of review data; and/or the Rubric to be used for reviews. The structure of an individual Assessment may specify, for example, that 6-8 individual Performances should be watched in order to complete each Assessment Review.

The employee may then request participation from any 3^{rd} party participant(s) or reviewer(s) in the Assessment Review Program (1804), each of whom may accept to participate or reject the request (1805). Assuming acceptance, or in the event no requests were necessary (e.g., the reviewer(s) are assumed to accept), the Head-end System may then establish an Assessment Review Program (e.g., based on the specification of the Assessment Review Program defined in 1803) (1806).

Through the activity associated with existing Observation Review Programs (e.g., as described above) involving the employee, individual Reviews or specific Performances (e.g., by performer in a self-Review, by peers, anonymous reviewers, etc.) may continue to be generated (1807), any of which may be included in the group of one or more Performances (either already reviewed or not) selected for the Assessment. When the Assessment Review takes place (e.g., as scheduled by a calendar application in the Head-end System), the Head-end System may assemble a representative sample of Performances(s) that meet the criteria set forth in the definition of the Assessment Review Program, and may notify all reviewer(s) (which may include the employee him/herself) to perform their Assessment (1808). In some examples, the Performance(s) may be already reviewed, in which case feedback from the existing Review(s) may also be provided to the reviewer(s).

The reviewer(s) may then access the system (e.g., via their respective portals) and complete the Assessment (1809-1810). An example Rubric for carrying out the Assessment is illustrated and described in detail with respect to FIGS. 16 to 24. The data generated during such an Assessment may be stored on the Head-end System (e.g., in an assessment database) (1811). The Head-end System may also notify the employee and their supervisor that the Assessment(s) are complete and the results ready for viewing.

The employee and their supervisor may pre-review the Assessment results (e.g., via respective portals) and may schedule a discussion to address any issues, questions, and next steps, including any update of the employee's developmental objectives (1812). Results from the various uses of the Rubric may be shared with other Company personnel, for example with the Corporate HR department so they may ensure Rubrics are being used effectively (1813).

FIGS. 16-24 are now described with reference to respective reference numerals. These figures illustrate an example interface suitable for carrying out an Assessment, for example as described above.

16.1—Concept Bubble—Concept Bubbles may be used to highlight core job competencies based on an organization's competency model, as described above with respect to FIG. 13.

16.2—Performance Box—The Performance box may provide a listing of one or more Performances that are available as part of the current Assessment session. For example, an Assessment Review session may include 6-8 Performances. For each Performance, the Performance Box may provide information such as Performance length and date, how many previous reviewers have watched the Performance and how many comments they made, and/or what Rubric headings any comments were grouped under.

17.1—Definition of Concept(s) Behind a Concept Bubble—Selecting one of the Concept Bubbles may result in a definition of the concept to be displayed. In this example, the definition may include a scale that the reviewer may be asked to rate the performer on (e.g., 1-5, Exceeds Standard to Below Standard) and/or any guidance regarding the specific sub-dimensions which the reviewer should consider when making an assessment. This guidance may be available at any time, though it may not be used by experienced reviewers.

18.1—Context Pictures—A Performance to be reviewed may be selected from one or more Performances listed in the Performance box. One or more perspectives or Context Views, through which the reviewer may experience the particular Performance, may be selected from a list provided in the Context Pictures box. Selecting one or more of these perspectives, in this case the “View of Teller” and “View of Customer”, may display any associated video images on the screen and may begin the synchronized playing of related video, audio and/or other Sensor data.

18.2—Bookmarks—One or more icons on the Performance timeline may indicate episodes that previous reviewers have Bookmarked and commented on. In this example, the video being watched has arrived at an episode in this Performance that was the subject of a previous Bookmark. In some examples, a Bookmark may be a visual cue, an audio cue or any other sensory cue. For example, in a 2-D or 3-D virtual environment, a Bookmark may appear as a virtual object at the associated time points.

18.3—Comment Box—In this example, during the Performance Review, any comments of any previous reviewers may be displayed on the screen for the reviewer to see. Such comments may be displayed throughout the entire Performance or may be displayed only during the relevant episodes. In this example, the icon in the Comment Box suggests that the Bookmark was associated with a “Negative” or “Could Improve” judgment by the reviewer and the text of the comment may be displayed.

18.4—Rating—The Comment Box may also include the rating that the performer gave to the comment when the Feedback was reviewed. In this example, the rating indicates that the reviewer's comment was rated by the performer as “Helpful”.

19.1—Insight to Retain Box—When the entire episode of the Performance that was the subject of a previous observer's comment has been played, the Performance (e.g., video and/or audio) may pause and the Concept Bubbles may be displayed. An “Insight to Retain?” box may also be displayed (e.g., in lower left corner of the screen). The review may use this box i) to indicate if this specific episode and comment bookmarked and made by a previous reviewer is, in their opinion, sufficiently insightful or important to warrant being included in their Assessment process for the final rating and, if so, ii) to select which of the competencies (e.g., as denoted by one or more Concept Bubbles) the episode and/or comment should be related to. In this example, the assessor has chosen to retain this episode and associated comment, and has associated the episode with the “Customer Focus” competency.

20.1—Insight to Retain Box—This screen illustrates a similar choice as in FIG. 19, but in the context of a different Performance. In this example, the reviewer has chosen to retain this comment and episode for including in a final rating, has linked it to the “Customer Focus” competency, and has also entered a brief note, for example to remind herself what she was thinking when she made this decision.

This example process of watching a Performance, creating new Bookmarks and comments and/or considering whether to retain the Bookmarks/comments made by others (and as appropriate linking each retained insight with one or more competencies) may be repeated until all Performances included in the Assessment have been reviewed. At that point, the Assessment session may proceed to the next phase, for example as illustrated by FIG. 21.

21.1—Competencies—After the initial watching phase (e.g., as described above) of the Assessment Review has been completed, the reviewer may be presented with an interface for reviewing each of the competencies previously displayed in the Concept Bubbles which make up the Rubric. In this example, the displayed information may be associated with the Customer Focus competency.

21.2—Assessment heading—The heading section may describe the nature of the Assessment that is taking place, including information such as who is assessing whom, which Performances are being assessed, and/or who has previously reviewed the Performances in question.

21.3—Bookmark Listing—Bookmarks may be separated into Positive and Negative (or “Could Improve”) categories. In this example, several of the Positive Bookmarks are displayed.

21.4—Bookmarks—Each heading in the Bookmarks section may refer to a particular Bookmark/comment which the reviewer had previously chosen to retain and to associate with the particular competency (in this example, the Customer Focus competency) during the Performance observation phase (e.g., as described above). Each listing may provide information about which Performance the insight pertains to and the time on the timeline within that Performance which pertains to the specific episode/comment in question. Selection of a listing may cause the associated episode to be played. Any associated comments made by a reviewer may also be displayed.

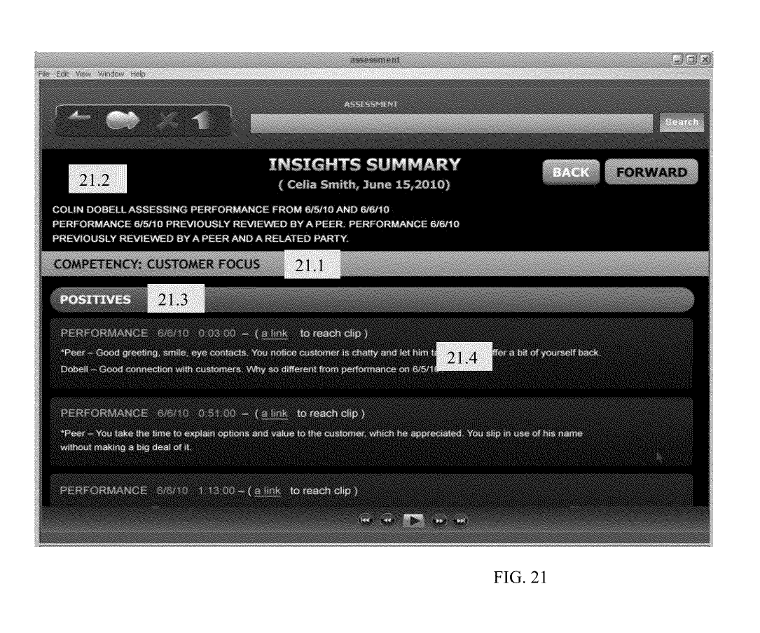

FIG. 22—Assessment rationale—Each competency-related interface screen may also include a section for the reviewer to complete, for example by selecting the rating for the particular competency in light of the evidence displayed in the Performance(s) they have reviewed, and/or by inputting in an assessment rationale (e.g., by text input or by audio input) that describes how/why they made the decision they did. This rationale may relate directly to the various episodes/comments listed (e.g., as shown in FIG. 21). By relating back to specific episodes/comments, a performer who is reading this Assessment at a later time may understand better the basis for a rating by the reviewer, by reading the reviewer's rationale and/or by selecting specific episodes/comments in order to see which Performance examples the assessment was based on.

An Assessment may be complete once the reviewer has observed all of the Performance(s), chosen which insight(s) to retain, associated these insight(s) with specific competency(ies), and/or summarized in a rationale and/or in a numerical rating their assessment of each competency based on the insight(s) they associated with it.

In some examples, an Assessment may be performed by the performer (i.e., a self-Assessment). This may be useful to help consolidate a performer's learning and/or to help the performer decide what to work on next. In this example of a self-Assessment, the Concept Bubbles that make up the Rubric may be based on the individual's Developmental Objectives (e.g., one Bubble for each Objective). At the end of the watching or observation phase of the self-Assessment (which may be similar to that described above), the individual may have indicated one or more Bookmark/comments as insights and may have associated each with at least one Developmental Objective.

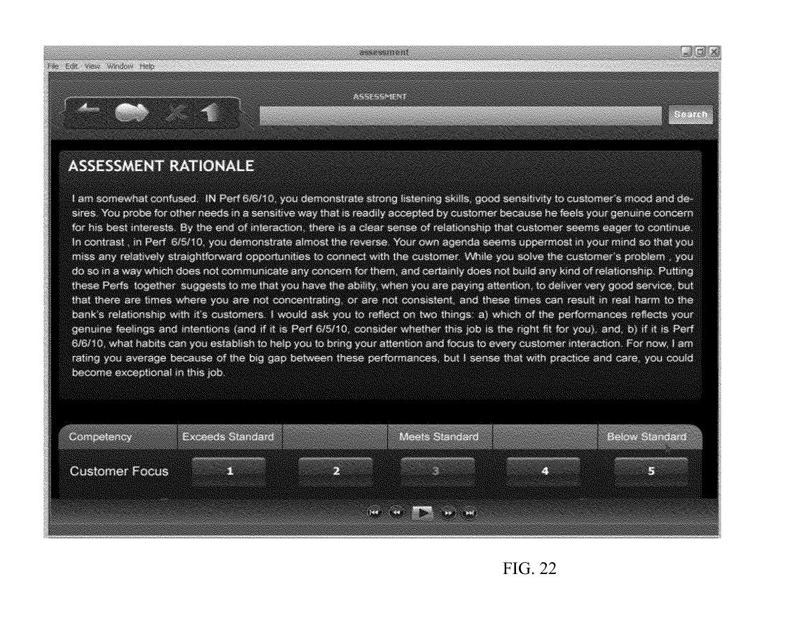

At that point, a summary page (e.g., as shown in FIG. 23) may be displayed, which may include a statement of each objective laid out at the top. The individual who was self-assessing may be provided with the option to summarize their learning by filling, for example, the two sections “What did I Actually Accomplish?” and “What I Plan to Accomplish by Next Update”. This may be useful to help induce the individual to acknowledge their current behaviour and/or plan the next step that they intend to work on.

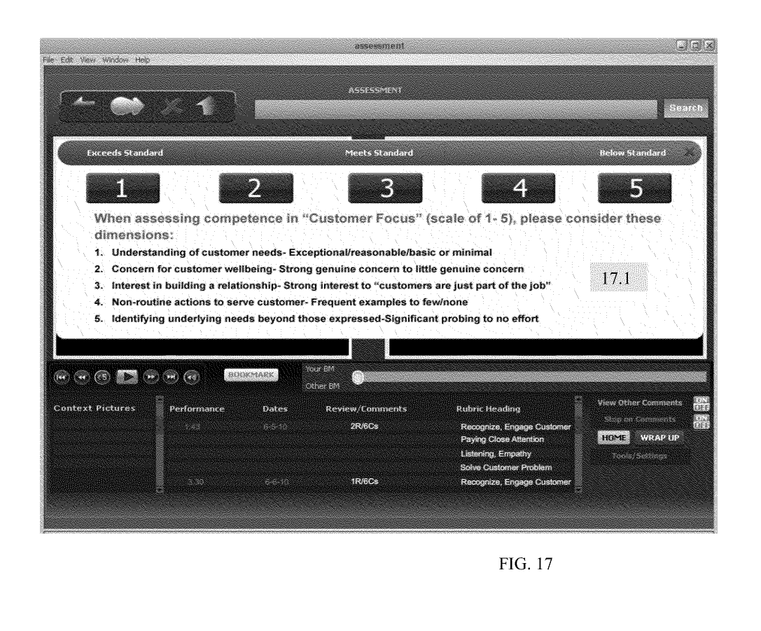

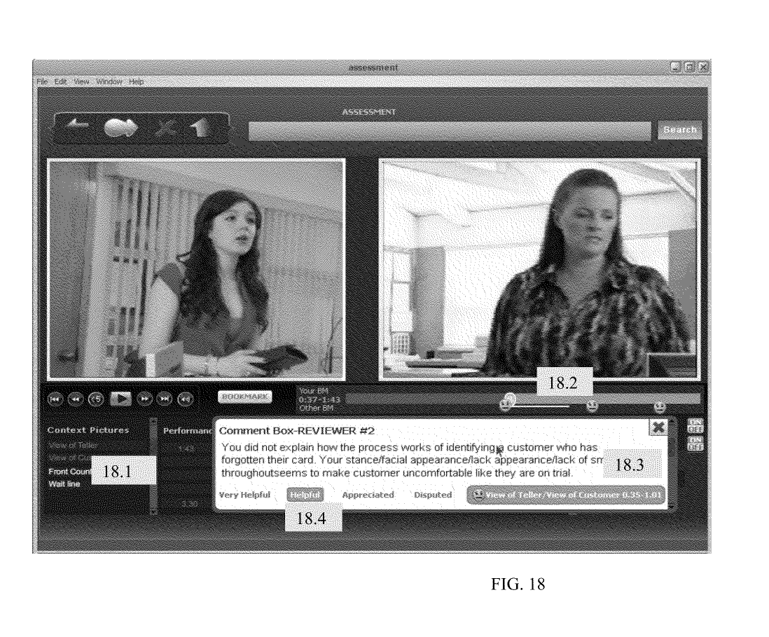

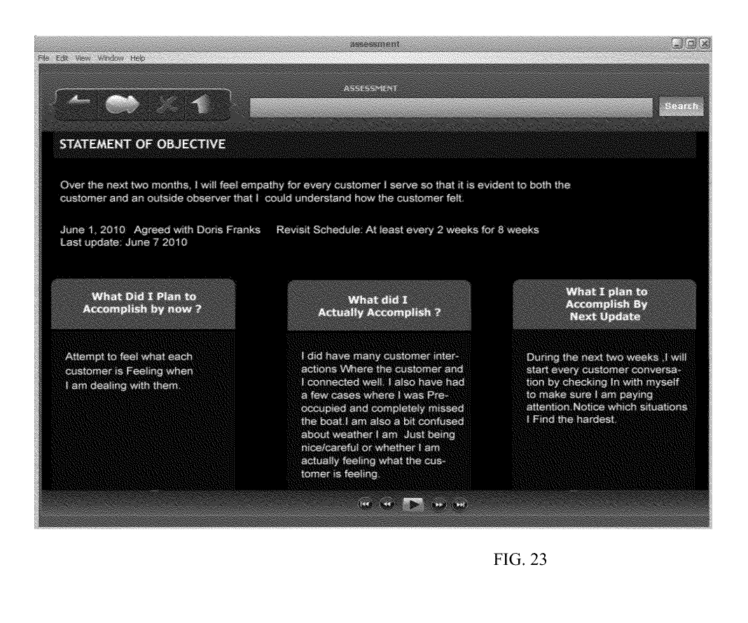

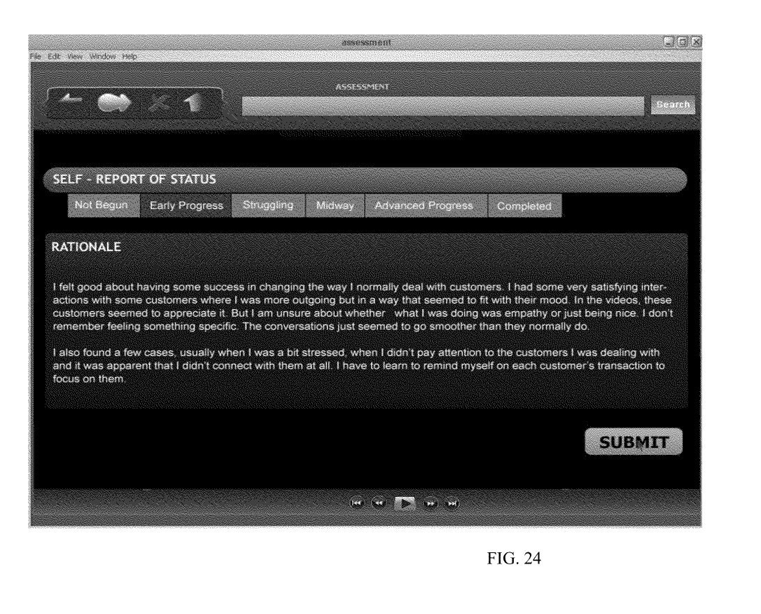

A self-Assessment may also involve a Self-Report of Status and/or a written rationale (e.g., as shown in FIG. 24). This may be similar to the self-observation of behaviour described with reference to in FIG. 18, and may help the individual to develop a realistic sense of their progress.

The self-assessor's manager may be provided with access to review these summary pages so that they may discuss them with the individual, assist them in consolidating their learning, and/or assist them in setting realistic goals.

Performance assessment of subordinates may be considered a managerial responsibility, and most conventional assessment processes may formalize this by directing all assessment activity to an individual's supervisor (or team leader). However, Feedback provided by a direct supervisor may be tainted by the power dynamic that may exist between them and the employee. Compounding this, front line managers may be busy and, therefore, too brief and directive in their Feedback, which may undermine its motivational effectiveness. Feedback may be more effective when it comes from credible sources that may be anonymous or respected without being threatening. For example, direct supervisors may play a coaching role in helping the employee to assimilate and make sense of the Feedback from such sources, and then to consolidate the learning to fuel new behavioural experimentation. In view of these facts, the Assessment process, for example as illustrated in FIG. 15, may involve the supervisor in joint planning of the Assessment Review Program, but may then exclude the supervisor from direct Assessment activity. After Assessment activity is complete, the Supervisor may re-engage with the employee to assist the employee in assimilation of the Feedback.

### Review Pools

Review relationships both for Observations and Assessments may be not static. For example, as learning needs may evolve, so may the types of relationships required to support them, and employee/supervisor or individual/coach teams may initiate or discontinue any such relationships. The responsibilities associated with these relationships may also be reciprocal. For example, employees or individuals may learn not only by observing themselves and receiving Feedback from others, but also through the process of crafting their own Feedback regarding the performances they review for others. The act of formulating and giving thoughtful Feedback to others may contribute as much to learning as does receiving Feedback. While an individual's relationships may be mostly with known reviewers, it may be desirable for the development of that individual that one or more anonymous reviewer(s) participate in a Review Program. For example, the anonymous reviewer may be identified based only on the type of position they hold. The disclosed systems and methods may help to manage the interwoven review relationships that may pertain among employees within a large organization. The disclosed systems and methods may also help to support the ability for individual customers who do not have access to a coach or mentor to barter their own services, for example as a reviewer of others in exchange for others providing reviews of them.

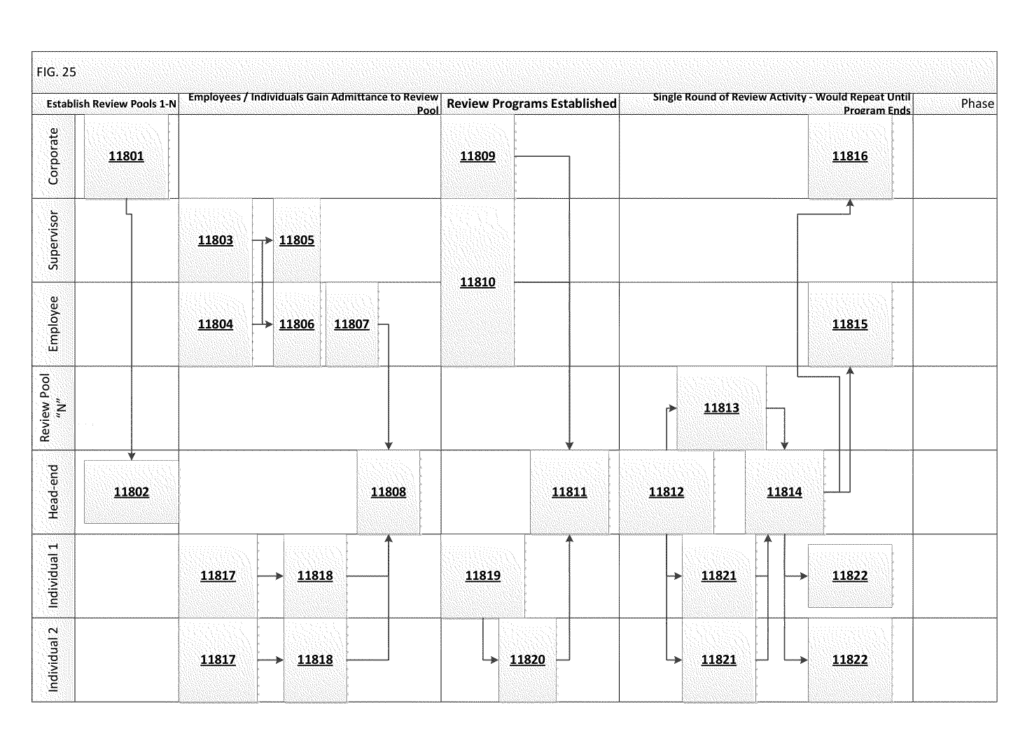

An example diagram of how the disclosed systems and methods may manage the interweaving of such review relationships, for example both known and anonymous, is shown in FIG. 25, which describes the Creation and Management of Review Pools. This figure is described further below. This figure is first described with respect to corporate environments and secondly with respect to individual Users of the system.

As shown in FIG. 25, a corporate department (e.g., Operations or HR) may define one or more different Review Pools, which may be groups of reviewers who may have all been trained in the use of one or more Rubrics and may be authorized to participate in one or more Review Programs that use those Rubric(s) (11801). A Review Pool may be defined based on, for example, Job Categories, competencies, levels of Review activity, and/or types of Review activity. These definitions may be stored in the Head-end System (e.g., in a review pool database) to establish the Review Pools in the system (11802). Review pools may be established for individual users based on, for example, the users' learning interests. Once these Review Pools have been defined, either i) a supervisor may select an employee to serve in a Review Pool (e.g., to help speed up learning by the employee) (11803), or ii) an employee may choose to serve in a Review Pool (e.g., with permission from a supervisor), for example to help speed up learning (11804). In either case assuming the supervisor or employee agrees (11805-6), the supervisor may authorize a time budget that the employee may spend performing Reviews as part of the Review Pool.

The employee may then complete an online training associated with one or more Rubrics used by the targeted Review Pool (e.g., including an online test) (11807). Based on the supervisor's permission and the passing of the requisite test, for example, the Head-end System may assign the employee into a Review Pool (11808).

In an example, a Review Program using a Review Pool Rubric may be defined, for example by i) Corporate Quality control personnel using internal resources (e.g., as described in Example 1 below) (11809), or ii) an employee/supervisor pair (11810). The Head-end System may be used to establish the Review Program based on the Review Program definition (11811). For example, the Head-end System may schedule the related Review activity. The Head-end System may assemble one or more Performance datasets (e.g., received from one or more Collectors) related to the Review Program and may notify member(s) of the Review Pool that a Review may be available to be carried out (11812).

The Review Pool member may have a defined period of time in which to access their portal and to complete the Review(s) using the appropriate Rubric(s) provided by the Head-end System (11813). Failure to complete the Review in the required time may result in an initial warning and may subsequently result in an ejection from the Pool. Feedback from the completed Review(s) may be stored at the Head-end System and the requisite parties (e.g., performer being reviewed) may be notified of the completed Review(s) (11814). The employee/supervisor may log in to view the results, rate Feedback, store review data, update Objectives, etc. (e.g., as described above) (11815). In some examples, the corporate personnel or department that defined the Review Program may access the review results, for example to audit review activity and/or to modify the Review Program (11816).

In a variation, a system operator may aim to attract individual Users for one or more Review Pools, for example based on different learning interests. For example, individual Users may indicate their interest in joining one or more particular Review Pools and may agree to a “budget” of Reviews that they would be prepared to undertake, for example in exchange for a similar amount of Review time from another individual (e.g., exchange between Individual 1 and Individual 2) (11817). In this example, two individuals may separately make this undertaking and may complete any appropriate online course and/or test about the use of the Rubric in question (11818). The system may then assign them into one or more appropriate Review Pools (11808).

Individuals within a Review Pool may have the ability to see other individuals (e.g., experience profile, but not their names) who are interested in trading Review services. An individual may develop a rating track record (e.g., over time, as individuals perform Reviews), which information may be associated with them in the Review Pool. Based on a combination of ratings, experience profile and/or expressed interest, for example, one individual may propose to another one that they swap Review services (11819). Assuming the second individual agrees to the swap (11820), the Head-end System may be used to establish a reciprocal Review Program based on the agreement between the individuals (11811).

The Head-end System may assemble Performance data (e.g., based on the terms of the Review Programs) (11812) and may notify each Individual, who may then log in to complete the Review(s) (e.g., using respective personal portals) (11821). Data from their respective Review(s) may be stored on the Head-end System and each individual may be notified that completed Review(s) are available for each of them to access (11814). Each individual may then log in to their respective portals, access their respective Review(s), rate Feedback as desired, and/or store relevant information in their respective developmental objectives folders (11822). Variations, including use of various community-oriented and social-networking applications may be used to help encourage and facilitate the sharing among individuals of successes, challenges, insights, techniques, etc.

### Self-Directed Learning, Social Learning, Tracking Participation

The combination of providing Feedback to others while receiving Feedback from others may help to build a culture in which everyone is working on their own form of behavioural change. The disclosed systems and methods may provide each User with access to an organization-specific (or coach-specific) customized learning management tool (e.g., within their private secure portal) so that interested individuals or employees can explore relevant material to extend their understanding of key concepts and skills as well as of the intricacies of their organization's corporate service strategy.

In some examples, the user interface may also include within-group social network features (e.g., ability to nominate and vote on the “Best Service Performance”, “Best Example of a Common Service Problem”, among others). These and other features may generate personal and/or social interest in sharing and discussing, for example at the branch or store level, of details of customer service, desirable and undesirable behaviours, insights about successes and failures, etc. Such group sharing may take place in a virtual discussion group or forum, for example hosted by the Head-end System. Group discussions may be structured around specific episodes and/or Performances, which may represent common challenges or learning moments that may have been experienced by one of more individuals in a specific position. Individuals may take turns leading these discussions, for example based on what they have been working on, successes and challenges they have experienced, etc. The disclosed systems and methods may provide tools to aid individuals in linking video/audio segments from their personal library to presentations that may be used to support effective discussion.

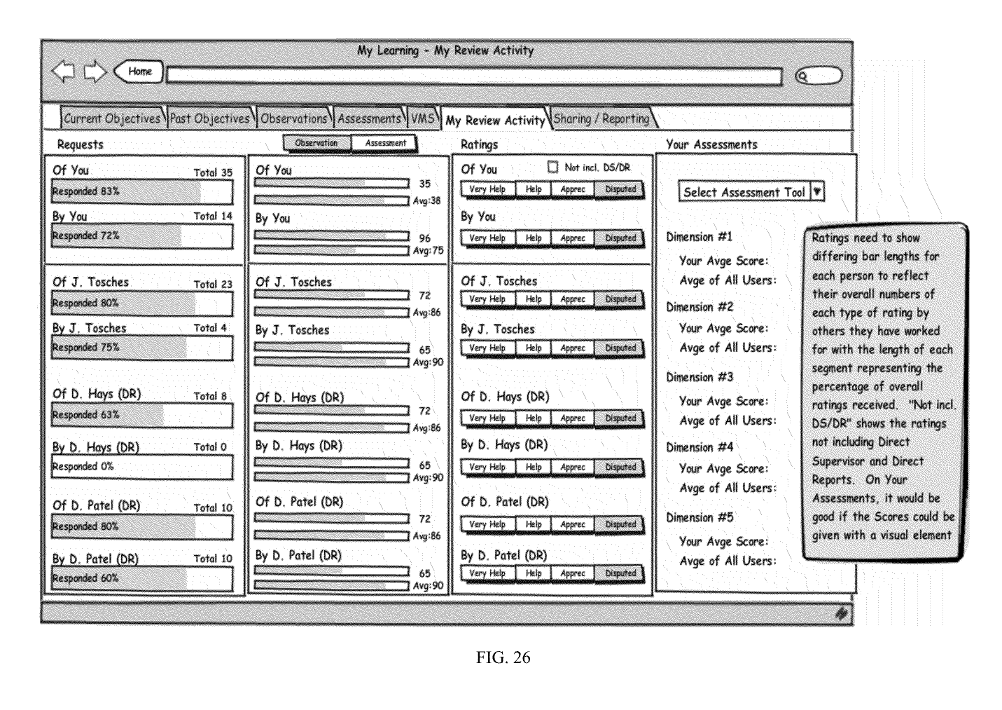

Participation may be useful in the learning of both individuals and the group. As such, the disclosed systems and methods may track and/or provide an up-to-date account of each User's review activity. Such information may be made available to both the User and to their supervisor. An example interface that illustrates how this might be done is shown in FIG. 26.

As shown in FIG. 26, the interface may provide bar graphs (e.g., across the top) indicating an account of the User's request activity, Observation activity, and how their Feedback has been rated. Also provided may be graphs representing performance for the User's direct reports. For example, in the top left hand corner, a graph indicates that the User had 35 requests made of them to review others, of which they responded to 83%, and that the User made 14 requests to others, of which 72% were responded to. Asymmetries in requests made to others or received by the User might point to either popularity issues and/or refusal to participate, for example, which may be a subject of discussion between the User and their manager.

For security and/or privacy reasons, the system may also include security features which may decrease or minimize the possibility of any of the Performances being able to be copied and shared, for example on external social networks (such as YouTube). These security features may place restrictions on downloading Performance data (e.g., videos and/or audio played during Reviews). The system may also employ an encryption methodology, for example which may dissimulate within the image and/or the audio signal associated with each video or audio data, each individual time it is played for review purposes, a distinctive identifier that may be recovered from a subsequent replaying of a copied version of the data. Various appropriate technologies may be used to modulate onto the video or audio data a unique identifier, which the system may store and associate with each separate Review. If an unauthorized instance of the data were subsequently to show up, such as on a shared site (such as YouTube), for example based on a recording made by screen-grabbing software, the provenance of the recording may be tracked back to the instance that it was taken from and the related User who accessed that instance may be identified (e.g., from User login information).

A 360° performance review, or other review of individual performance according to which one or more people who are familiar with an individual's performance (also referred to as the “Assessor(s)”, even though feedback provided may not always be an assessment) provide feedback to that individual (referred to as the “Performer”) about the individual's performance (e.g., in a form that is attributed to the Assessor(s) or that is delivered anonymously) is a commonly used management tool. The provision of performance feedback has been conclusively shown to be an integral part of the process of improving and/or modifying performance in various specific ways. Conventionally, however, since feedback could only be solicited about performance that the Assessor had witnessed on one or more previous occasions, the only suitable Assessors were individuals who had direct, prior experience with the Performer. The concepts described in WO 01/84723, for example, describe automating the collecting and sharing of opinions/assessments of a Performer by a group of people with whom the Performer has worked. Since the Performer understands that he/she knows all of the Assessors (even if the Performer is unable to identify which comment belongs to exactly which Assessor), the Performer often feels defensive, wasting time trying to figure out who said what (which may impede the effectiveness of the feedback) and the Assessor often feels anxious or uncomfortable about the risk of being discovered as the source of a particular comment (which may limit the scope and/or quality of feedback provided). The requirement that an Assessor must know the Performer personally also limits the number of outside perspectives available, specifically to those people who work closely with the Performer in question.

In some examples, the present disclosure may provide a method for facilitating the Review of one or more service Performances and the exchange of detailed Feedback by and among individuals who belong to an extended population who may or may not know each other or be otherwise directly aware of each other's day-to-day performance. For example, a review group, also referred to as a Review Pool, may include a group of Reviewers for providing a review of a service performance. One or more Review Pools may be defined (e.g., in a computer system) and such definition may be updated from time to time. The definition of a given Review Pool may include a definition of one or more admittance criteria (which may be updated from time to time) that an individual must meet in order to become a member of that Review Pool. Criteria for allowing individuals to become members of a Review Pool may include, for example: i) a request by a Performer and/or a Supervisor; ii) successful completion of a qualification requirement (e.g., one or more courses or tests); and iii) an experience (e.g., specified work or life experience) in common with the Performer; among others.

An individual may be a member of more than one Review Pool. An individual may also request to be included in a given Review Pool. A candidate may be required to meet the criteria defined for the given Review Pool before such a request may be granted and the candidate may be assigned to the given review pool. The definition of a given Review Pool may include one or more rules (which may be updated from time to time) of the types of Reviews and/or review interface (e.g., Rubrics) that a member of the Review Pool may perform and/or use. The definition may also define, for example, the types of Performers and/or Reviews within an organization that a given Review Pool member may Review. For example, a Review Pool member may be permitted to perform a particular type of Review including, for example: i) observation of behavior, ii) assessment of competences and/or skills, iii) comparison of an observed Performance with a standard, iv) use of one or more pre-specified Rubrics, and/or v) performing a Review on a pre-specified position or type of interaction within an organization.

The Review Pool definition may also include one or more rules (which may be updated from time to time) governing how members of a Review Pool may be assigned a Performance to Review (i.e., Review Pool Assignment Rules). Review Pool Assignment Rules may include, for example, random assignment, or assignment based on matched positions, skills, learning objectives, and/or specific Reviewer request. Assignments may include anonymous uni-directional assignments (i.e. in which one Review Pool member performs a Review for a second Review Pool member without the latter performing a Review of the former in exchange. Such a Review may be performed by the first member in expectation that a third member in the Review Pool will perform a Review of the first member at a later date) in which no personal detail is revealed by either party; they may include uni-directional assignments in which various amounts of personal information is exchanged; and/or they may include a mutual exchange of Review activity (bi-directional) between two individuals, who may be free to reveal as much personal information to each other as they wish to.

A Performance may be assigned to be reviewed by one or more Reviewers in the Review Pool, for example based on an evaluation of criteria and/or rules of the Review Pool. Such an evaluation may be carried out automatically by the computer system. An individual in a Review Pool may also request permission to perform a Review (and may optionally request particular types of Performances to Review). Any applicable criteria and/or rules (e.g., Review Pool Assignment Rules) may need to be first satisfied before any such individual request may be granted. The Reviewer may carry out the review (e.g., including reviewing a playback of the Performance and providing feedback during the playback, such as using one or more Rubrics) using the computer system. Completion of assigned Reviewed by Review Pool members may be captured and stored (e.g., using the disclosed system as described above), including Feedback generated during the Review process. Completed Reviews, including Feedback, may be shared with the Performer involved in the Performance that was Reviewed.

The disclosed methods and systems (e.g., using, among other things, devices and/or techniques disclosed herein, such as a Review Pool) may make use of technology that allows performances (e.g., interpersonal service performances) to be recorded (e.g., automatically) with a relatively high degree of fidelity. In these recordings, various (e.g., a majority of) relevant dimensions of quality may be readily observable in the concrete behavior exhibited by the Performer in question, without any need for the Reviewer to know the Performer personally, or to be otherwise familiar with the Performer (e.g., with their mental qualities, or other internal characteristics). As a result, a person with no experience in the field in which the Performer is operating and/or with no prior knowledge of the Performer may readily observe the behavior of the Performer and may provide a range of valuable feedback based only on the Reviewer's previous experience as a human being (i.e., without any specific knowledge about the Performer). Similarly, a Reviewer with experience working in a position similar to the Performer but with no direct prior knowledge of the Performer, may observe a recording of the Performer in a service performance and may provide detailed feedback on the performance based on the Reviewer's knowledge and/or experience of the position. If such knowledgeable observer is further provided with a record of the behavioral objective that the Performer is working on, the Reviewer may use his/her own experience to help the Performer to make progress on the Performer's objective and/or to gain an important insight into the limitations of the Performer's current behavior. By providing a way for a Performer to receive specific performance feedback from a knowledgeable, yet unrelated and anonymous person, one or more of the downsides noted above (e.g., defensiveness, anxiety, etc.) which impede the effectiveness of conventional feedback techniques may be reduced and/or avoided. Such benefits may not be available or easily achievable in a traditional or 360° performance review, regardless of how automated the process becomes.

This method may also be useful in that the Reviewer may learn through the process of providing feedback. By watching service performances by people wholly unknown to the Reviewer, the Reviewer may spend more time reflecting on the elements of successful a performance. The Reviewer may witness episodes that lie outside the Reviewer's normal range of experience, thereby broadening the Reviewer's perspective and/or expanding the Reviewer's behavioral range. The present disclosure may thus provide a structured means of: i) allocating anonymous review and feedback resources efficiently, ii) scaffolding the learning of reviewers based on their skill levels, and/or iii) building a commitment to organizational culture by enabling individuals to give and receive assistance from others about whom the only thing they know is that they work for the same company. Such benefits may not be available or easily achievable under traditional or 360° performance reviews as currently known or practiced.

In the latter quarter of the twentieth century, consumer service companies (particularly in North America, and to a lesser extent, around the world) sought to support rapid growth while providing a consistent customer experience by developing procedures which sought to specify everything that a service worker needed to do in order to deliver that consistent experience. Moving into the 21st century, there has been a re-emergence of the appreciation of the importance to customer service of a “human” interaction with a service worker. As a result, consumer service companies are trying to train and encourage their employees to improve the quality of their interpersonal skills. Companies are trying to differentiate themselves by the adeptness of their employees in delivering an exceptional customer experience. On a micro-level, many of the same concerns are leading organizations and the workers that work in them to develop an ability to handle each person that they meet with (e.g., with particular emphasis on the “high value” interactions) in a manner that reflects the needs of the other individual. Although this description uses the term employee or Performer, the employee or Performer may be any person trying to learn and/or modify their behavior to suit the characteristic(s) of another specific individual who, for the purposes of this description, may be referred to as a customer.

In some examples, the present disclosure provides a method for influencing the behavior of individuals (e.g., Performers) for whom the quality of their face-to-face interpersonal Performance is central to their overall effectiveness (e.g., in customer service roles). In particular, the method may generate a profile of a particular customer based on a plurality of past interactions with the customer, to be reviewed by an employee (e.g., prior to an upcoming meeting with the customer).

A recording of a multiplicity of service Performances involving a given Performer (e.g., a customer of interest) may be captured using one or more Sensors. The data may be stored (e.g., in a computing system) for playback of the service Performances. During the recording process, information characterizing each Performance (e.g., Meta-data) concerning each Performance may also be captured and stored in association with the respective stored playback data. One or more characteristics of interest (e.g., related to the objective qualities of the service or interpersonal interaction associated with each Performance (for example, presence or lack of eye contact, presence or lack of “small talk”, extroversion or introversion of the customer, etc.)) may be observed through the playback of the Performances and identified (e.g., inputted to the system by a human or by automatic computer-based means). Such observed characteristic(s), in combination with the identity of the Performer (e.g., customer served or person interacted with) may be used (with one or more records that the system maintains of past interactions with that customer or person) to generate that person's Interpersonal Profile. A multi-media representation may be stored in the system as an Interpersonal Profile associated with that person.

The Interpersonal Profile may be provided to an individual (e.g., an employee) prior to the individual interacting with the subject of the Interpersonal Profile. The Interpersonal Profile may enable an employee or individual to imagine, experience and/or practice interaction with such person. A representation of a given person's Interpersonal Profile may be made available to employees or individuals in advance of an anticipated interaction with the given customer or person. For example, the representation may be in a form suitable to enable the employee or individual to adapt their interpersonal behavior in preparation to be more effective in dealing with the given customer or person.

The importance of an employee's skill and effort in delivering an exceptional customer experience may be amplified in the case of an organization's highest value customers. Recent research on behavior emphasizes that: i) the ability to modify behavior may be strongly based on an individual's opportunity to experiment with and practice the desired new behavior, and ii) such pre-practice of new behavior may be effective in preparing an individual to be effective in a new situation even if it takes place entirely in the mind (i.e. through the systematic imagining in advance by that individual of the situation they will face and of how they intend their behavior to unfold). Nevertheless, practicing interpersonal scenarios may not be very meaningful in the absence of any concrete behavioral examples that one is likely to encounter. The disclosed methods and systems may provide employees who are trying to become particularly attuned to the interpersonal styles of their highest value customers a way of previewing past behavioral evidence so they employees can reflect on how they will attempt to customize their behavior during upcoming meetings with such customers. The same may apply to individuals who are trying to prepare for an upcoming meeting with one or more people on whom it is important to make a strong impression, for example.

The Interpersonal Profile stored about an individual (typically a customer) may be more than simply the facts, images, purchase preferences, and/or relationship ties associated with this individual. Rather, the Interpersonal Profile may be a combination of personal attributes of the individual with audio-visual representation of the individual's specific behavioral traits and interpersonal preferences in such a manner as to enable someone experiencing the Profile to envision and/or practice interacting with that individual.

In addition to enabling an employee's pre-practice of an interaction with a customer, another support for new behavior may be the provision of one or more mental cues to remind the employee in real-time of behavioral aspects that they may want to include when faced by the particular customer in an upcoming Performance. The present disclosure may include the provision of one or more of the following tools to help an employee prepare to be effective when faced by the customer:

A condensed summary (e.g., of key facets) of the Interpersonal Profile of a customer may be accessible to the employee (e.g., displayed on an interface visible to the employee, such as at a front counter) during an interaction between the employee and the customer (e.g., as soon as the customer identifies themselves).

Further details may be perused by the employee in advance of anticipated customer visit(s).

The system may provide an option to review one or more representations (e.g. playback recordings) of selected Performances (e.g., typical or salient Performances) involving the customer, which may help the employee to recognize personal traits that may be relevant to how to interact effectively with the customer.

The system may provide an option for an employee to Review, prior to an upcoming customer meeting, one or more previous service Performances between the customer and another employee or individual, such as for the purpose of practicing the ability to recognize elements of the customer's Interpersonal Profile and change the employee's behavior accordingly

The system may provide an option to identify in advance customers according to their importance and/or attractiveness to the company, and having employees who are likely to interact with those customers practice dealing with each customer in question (e.g., using the tools described above) so that the employees may become more adept at handling that customer in the way the customer most like to be handled, in anticipation of future interactions.

Collection of information may be facilitated by the use of suitable electronic devices. Developers of smartphones and of accessories for smartphones have been enhancing the capabilities of these devices to provide full, 360° panoramic video-capture capabilities. Other developers of audio-visual recording appliances (e.g., GoPro™) have developed devices that may be carried on the body and used to record an audio-visual track of whatever is happening to the individual (e.g., from parachuting to extreme skiing, etc.) but without capturing the individual's own behavior. The demand for these capabilities appear to be driven by the desire of smartphone users and other individuals to capture events in real-time, such as for the purposes of i) putting them onto the web (for social media sharing, such as on Facebook, etc.) or sharing them in some other way; or ii) facilitating low-cost group discussions via smartphone with more than 1-2 people participating at one end of the call via a single smartphone device (e.g., teleconferencing). In most cases, the audio-visual files created by these devices are either stored on the local device temporarily for later transmission (e.g., to a social media account), often after having been edited on the device by the user of the device, or are transmitted live via a wireless network (e.g., for teleconferencing). The incorporation of these capabilities and features into a smartphone or GoPro-like device reflects the fact that a) the video/audio recorded by the individual owner of the smartphone is deemed to be the property of the individual, b) the individual is fully authorized to access, edit and share these files however they wish, and c) the storage on the smartphone or GoPro-like device and/or the uploading of these files to the internet is not considered to be of high-concern from a security point of view. Moreover, any third-party being recorded by a smartphone or GoPro-like device (e.g., as part of any exercise described above) may be expected to be comfortable with the possibility that any recordings in which he/she is included may end up being shared (e.g., on the internet), possibly without his/her knowledge and/or permission.

Employers or other organizations may wish to record various types of interpersonal interactions between customers and/or employees, such as for the purpose of performance improvement through later review of the recordings by the employee and others. Employers or organizations may wish, therefore, to facilitate the unobtrusive capture or recording of interpersonal performances by their employees in the course of their working day. Examples of performances that they may wish to capture might include, for example, sales reps meeting with customers, executives meeting with internal or external contacts, and HR personnel, among many others. In all of these cases, the recording of these interactions may be: a) fully disclosed to all participants in any meeting (in other words these recordings may not be surreptitious); b) may be easy to execute so that the employee need to do no more than ask permission to record the performance (and optionally set up the recording device, such as placing the recording device on the table); and c) may be of sufficient quality (e.g., on both a video and audio level) so that the nuances of body language and intonation may be properly captured and represented in a playback of the recording. Being able to achieve b) and c) simultaneously for video and audio (and any other sensor data) in any ad hoc meeting place (that is, not in a pre-set-up facility) may be challenging. The emerging smartphone and other recording device capabilities (e.g., as described above) may be useful in this situation, but they typically suffer from one or more of the following limitations:

Such devices typically do not offer any protection against unauthorized distribution of recordings. Corporations or organizations may not want to allow their employees access to the files of the recordings. For example, a disgruntled employee might embarrass his employer by recording his customer meetings and posting them on the web, or might quit his position with the company and take recordings of the company's customers with him to a competitor. In these cases, recordings of service Performances might be considered corporate assets that must be protected.

Such devices typically do not protect a recording against unauthorized editing and/or viewing. Corporations or organizations may not want to allow the employee to preview/select/edit files of their Performances prior to the recordings being collected and stored. For example, a corporation may want to see unedited and representative examples of a sales rep's performance, without the rep being able to preview his Performances to remove poor examples.

Such devices do not offer any protection against unauthorized distribution of a Performer's or other party's image. Corporations or organizations and/or the individuals using the recordings may want to minimize the likelihood that a third-party (who may be recorded as part of an employee's service performance) might worry about the possibility that they may find themselves in a public forum (e.g., on the web). If the third-party had such worries, they might alter the way they interact with the Performer. This may hamper the educational value of the recording, since the value to the Performer of Reviewing his/her Performance derives from their ability to see typical examples of their interactions with others, including not only themselves but also how others react to them. Using a smartphone or other such conventional recording device to do the recordings might provide an impression to the third-party that there is a risk of unauthorized distribution of such recordings (e.g., end up on the web).

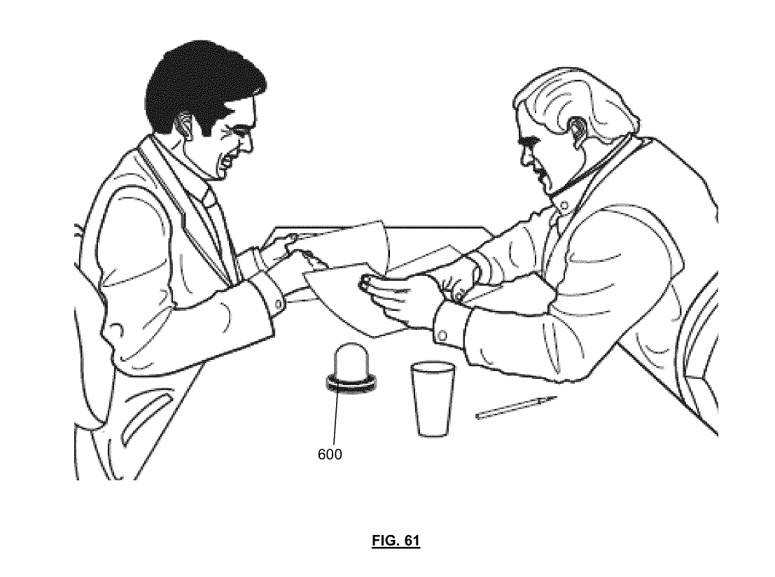

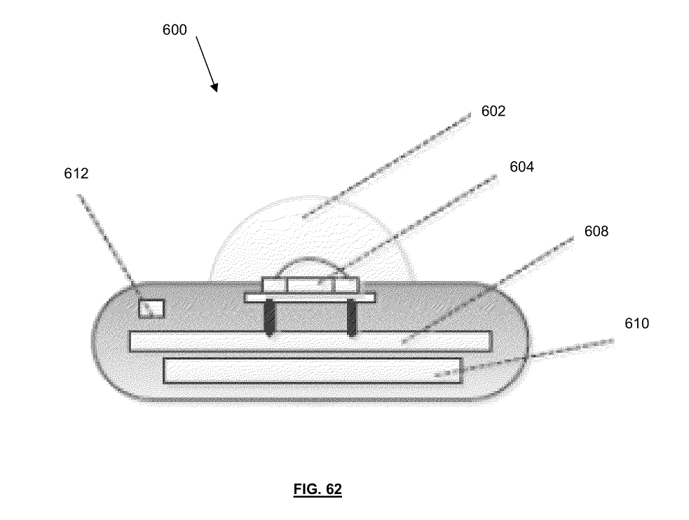

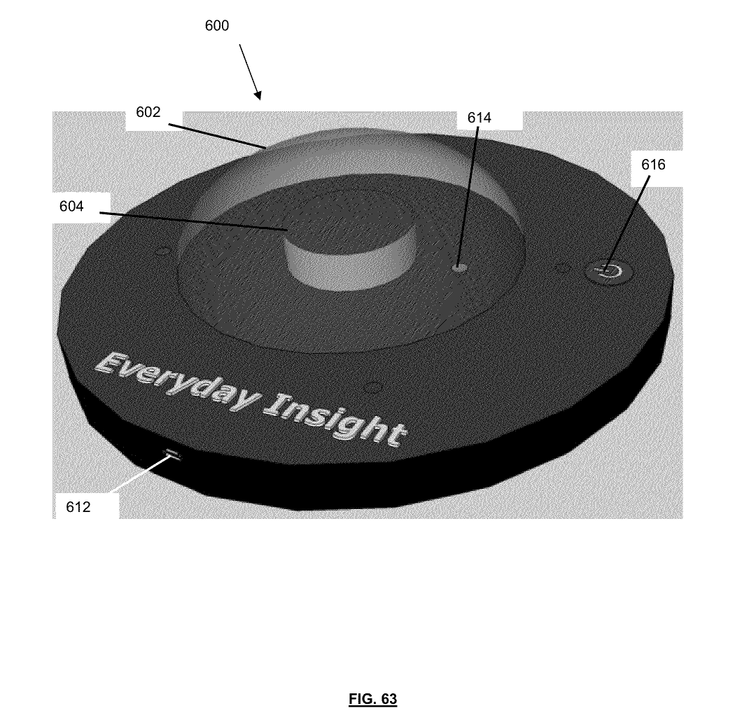

To address these and other concerns, the present disclosure provides a dedicated device for the collection of audio, visual and/or other sensor data associated with face-to-face interactions (e.g., taking place around a table or desk). Examples of such devices are shown in FIGS. 61-64. FIG. 61 illustrates the use of an example tabletop device 600 for recording a performance between two performers. A cross-sectional view of the device 600 is shown in FIG. 62, and a perspective view of the device 600 is shown in FIG. 63.

The device 600 may include a portable housing 602 (e.g., of a size to fit into a pocket) that can be placed stably on a surface (e.g., on a table), for example during an interaction between two or more performers (e.g., between employees and customers). The housing 602 may include a transparent portion (e.g., a plexiglass dome) to enable capture of images through the housing 602. The device 600 may include a panoramic camera 604 for capturing a panoramic view of the Performance (e.g., configured to facing upward, to captures at least a band between 180° and 360° horizontally around the camera and an arc on the vertical axis from 0° (i.e. directly horizontal) extending upwards to as much as 90° (i.e. directly vertical)). The device 600 may include one or more microphones 606 deployed so as to facilitate the recording of audio (e.g., the voices of one or more individuals) in the vicinity of the device 600 (e.g., standing or sitting around the device). The device 600 may also include other sensors (not shown) in addition to or in place of the camera(s) 604 and/or microphone(s) 606, which may provide the ability to better capture and characterize whatever is going on around the device 600. For example, the device 600 may include a radiofrequency identifier (RFID) sensor that may detect the identities of the employees (e.g., based on the employee's nametag equipped with a RFID tag), a sensor with a location sensing capability (e.g., micro-GPS capability) that may enable the device to record its location at any time, and/or a WiFi receiver which may enable the device 600 to record when it enters into a particular wireless communication hotspot, among others.

The device 600 may include one or more processors 608 (e.g., a digital video recorder (DVR) board) to control operation of the camera(s) 604, microphone(s) 606, and other on-board functionality. The device 600 may include a memory (not shown) to enable the digital storage of data (e.g., audio/visual recordings) captured by the camera(s) 604, microphone(s) 606 and/or other sensors.

The device 600 may also be capable of determining the identity of a user (e.g., a Performer), in particular a primary user (e.g., owner of the device 600) before, during or after recording of a Performance. For example, the processor(s) 608 may be configured to allow the user to identify him/herself to the device (e.g., by the user selecting or entering a user identity on the device 600) and/or the processor(s) 608 may execute a voice-recognition and/or facial-recognition algorithm.

The device 600 may be powered by a power source such as a battery 610 (e.g., a re-chargeable battery) and may include a connector to support recharging of the battery 610. Alternatively or in addition, the device 600 may include a means of coupling to an external power supply (e.g., an electrical cable and plug). The device 600 may include one or more physical or wireless means (e.g., a communication component 612, such as a USB connector or port) to communicate recorded data to an external computing system, such as an authorized computing platform. The device 600 may provide one or more security features (e.g., implemented by the processor(s) 608) that can be set up (e.g., by the owner of the device) to prevent an individual user from accessing the recorded data in an unauthorized manner (e.g., any other way than by uploading it to an authorized computing platform). The security feature(s) may include any suitable security and/or authentication techniques, for example, the processor(s) may implement one or more of: i) protocol(s) that is able to identify when the device is connected to an authorized computing system and/or software application with which the device is paired (e.g., through handshake protocols or other authentication protocols), ii) protocol(s) that prevent the uploading of files to any other unauthorized computing system and/or type of application, and/or iii) protocol(s) that implement encryption to prevent interception and duplication of files when they are stored and/or as they are being uploaded to the authorized computing system. The device 600 may also include one or more indicators 614 (e.g., a light) for indicating the life or strength of the battery 610 and/or for indicating when the device 600 is recording data. The device 600 may also include a mechanism (e.g., an on/off switch 616) for activating and deactivating recording. In particular, the device 600 may not be a conventional smartphone, GoPro-like device or other consumer recording device. The device 600 may be designed to be easily portable and unobtrusive (e.g., may be sized to fit into a pocket)

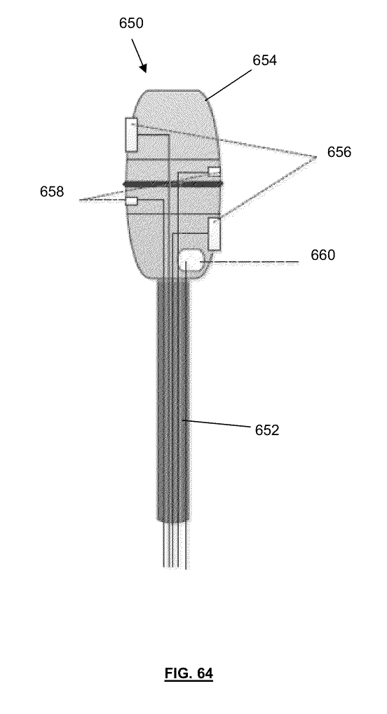

In some examples, a recording device may be a dedicated apparatus for collecting audio, visual and/or other sensor data (e.g., data associated with face-to-face service Performances), and may be mountable or adapted to be positioned at a fixed physical location (e.g., a front counter or an office), particularly where interpersonal interactions typically take place. FIG. 64 shows a cross-sectional view of an example device 650 suitable for being setup at a fixed physical location, such as a customer service counter. For example, the device 650 may include a support, such as a vertical stand 652, that may be placed or affixed, such as to the counter or table top in between where customers and service employees are customarily located. The stand 652 may be configured to accommodate any necessary cable or wires threaded through the stand 652 (e.g., the stand 652 may be substantially hollow). The stand 652 may be telescopic, so that it may be set (and locked) at various different heights. The stand 652 may extends upwards in such a manner as to enable a direct line-of-sight connection between one or more housings 654 mounted on the stand 652 and the face (and optionally upper body) of the customer and/or service employee. One or more housings 654 mounted on the vertical stand 652 (e.g., near the top and/or at different levels) may each or collectively house sensing equipment. For example, there may be one or more cameras 656 housed in the housing(s) 654 for capturing the customer and/or performer during the service performance. For example, the camera(s) 656 may be focused so that they cover one or more areas where customers might customarily stand or sit while being served and/or one or more areas where employees might stand or sit to serve the customer. There may be one or more microphones 658 housed in the housing(s) 654 for capturing audio from the customer and/or performer during the service performance. For example, the microphone(s) 658 may be aligned to capture voices from one or more customers and/or employees. One or more other sensors 660 provided by the device 650 may include, for example, motion detectors, distance detectors and/or RFID readers, in order to capture additional information associated with the interaction being recorded.

There may be one or more processors (not shown) for controlling operation of the camera(s) 656, microphone(s) 658 and/or any other sensor(s) 660. There may be one or more memory(ies) (not shown) that may store the recorded signals locally. Recorded data may be transmitted to an external computing device (e.g., to an authorized computing system), either immediately or upon request. The processor(s) may also encrypt the recorded data, to ensure secure storage and/or transmission of the data. The processor(s) may also execute functions (e.g., voice- or facial-recognition algorithms) to identify at least one individual involved in the interaction. The processor(s) may also carry out authentication protocols, to ensure that the recorded data is being accessed by and/or communicated to an authorized system or personnel.

In some examples, the device 650 may include a mechanism (e.g., a pause button, not shown) to temporarily suspend recording of data or otherwise ignore or discard recorded data (e.g., in the event a customer asks that recording be switched off). Activation of the mechanism may have the effect of stopping recording of the interaction for a pre-set period of time (e.g. 30 min) after which time the device 650 would automatically resume recording. Alternatively, recording may not be stopped, but activation of the mechanism may cause the processor(s) to identify a period during the recording which is to be ignored, so that any subsequent recorded data (e.g., for the next 30 min) may be designated to be eliminated or disregarded (e.g., at a remote station).

### Advantages and Benefits

Conventionally behavior change within an organization has often been approached from the following perspectives:
The traditional managerial approach to behaviour change may focus on objective setting, skills training, repeated feedback from the individual's superior, and alignment of compensation with the desired behaviour. Essentially, feedback and cash may be used as “carrots and sticks”.
Leadership and culture-based approaches may leverage the compelling and charismatic characteristics of a leader and a cause to inspire and motivate an individual enough to make the desired change.
Practice-based approaches may rely on closely supervised repetition of the desired behaviour until it becomes routinized and habitualized.

Recent research has found that these approaches may be limited in their scope. The strength of the disclosed systems and methods may be that they help to motivate individuals to pay sustained attention to behavioral change by providing one or more of:
Convenient access by both reviewers and performers, through secure and private portals.
Avoid need for excessive paperwork (e.g., collection of paper surveys).
Direct connection between specific behaviors observable during a service performance and specific evaluations of that service performance, rather than a generalized assessment of the overall performance.
A clear sense of personal responsibility for the behaviour change effort.
Exposure to one or more new ways of looking at the world that may expose the limitations of current behaviours and/or the opportunities available through change.
Continual support in noticing and paying close attention to the everyday process of change.
Repeated opportunities to observe and to reflect on the effectiveness of existing behaviour.
Repeated opportunities to practice new behaviours and to get relevant, timely and credible feedback from sources that are not direct managers.
Repeated opportunities to observe and to reflect critically on the behaviour of others working in a similar situation.
Repeated opportunities to share experiences with others who inhabit the same environment.
Recourse to a trusted source of advice, support and encouragement that may help in understanding new insights, assessing options, and maintaining confidence.

The disclosed systems and methods may be useful for capturing, collecting and indexing Performances and making them available to be watched regularly, by oneself and by others, so that one may practice new behaviours in real situations, receive timely, credible feedback from many different perspectives, and/or take personal responsibility for reflecting on and sharing experiences. Using the disclosed systems and methods, front line service workers and, more broadly, individuals who earn a living interacting with others, may be able to learn to change their behaviour more effectively and efficiently.

### Potential Variations

The present disclosure describes examples of the systems and methods, and variations which may be possible. Variations may be possible, for example, in one or more of the following areas:
How Performance data is collected—More sophisticated, miniaturized Sensors may enable more realistic representations of Performances, for example including inferences about the emotions that are in play during the Performance on both sides. Lower-cost Sensors may enable wider diffusion of Sensors into the workspace, which may enable more sources of data to help provide a more nuanced portrayal of a Performance. Sensors may be able to pick up what or how performers are thinking during a Performance (e.g., through interpretation of body language and/or facial expressions, or through biosensors such as heart rate monitors), which may enable that element to be captured for portrayal at a later time.
How Performances are represented—More sophisticated 3-D representation systems may enable 3-D representations of Performances for reviewers to interact with, for example enabling a reviewer to walk among the performers in a Performance. In examples where thoughts and feelings may be captured by a Sensor, representations of Performances may adapt in order to enable the inclusion of such data in the representation.
How the reviewer is prompted to reflect on specific dimensions of the Performance—In the disclosed examples, Concept Bubbles may be used to portray ideas to be kept in mind while experiencing a Performance. These may be two-dimensional shapes that appear on a screen at specific times. Any form of such 2-D representation of prompts or ideas (e.g., lists, floating text, shapes that are on-screen part or all of the time, reminders that are hidden but can be brought forward by the reviewer by interacting with the computing device, colouration of all or part of the screen, etc.), any 3-D representation of prompts or ideas (e.g., lists, floating text, shapes that are on-screen part or all of the time, reminders that are hidden but can be brought forward by the reviewer by interacting with the computing device, colouration of all or part of the space, or other methods of representing ideas in 3-D space), any audio representation of prompts or ideas, or any other form of representation may be used. The disclosed examples also use Bookmarks represented as icons along a time line, or in a list that can be selected. Other suitable representation may be used, for example in 2-D or 3-D space located in the position which the associated comment relates to.
How individuals who have been reviewed engage with the Feedback—The disclosed examples describe reviewers providing their Feedback using input devices such as keyboards (textually) or headsets (audio). Any Feedback provided in one format may be provided back to the performer in any other format if they choose (e.g., conversion of text to audio or vice versa). A portrayal (e.g., actual video or simulation) of the reviewer explaining their Feedback in common language may be used, which may make the Feedback more accessible to the performer. Such a portrayal may be invoked when a bookmark is selected. Additional tools may be provided to enable a reviewer to indicate and isolate specific movements, facial habits, voice intonations, etc. in providing their Feedback. The reviewer may also be provided the ability to create a compilation of episodes within one or more Performances (e.g., to indicate repeated instances of certain behaviour). This may enable a much more specific level of coaching and Feedback, for example to target more nuanced aspects of behaviour. The system may also recognize common Feedback from multiple reviewers (e.g., by analysis of review ratings, parsing of keywords within comments, etc.) and may gather similar Feedback together so that a performer may be provided with Feedback on the same topic from multiple reviewers.
How reviewer and reviewee and groups to which both belong can interact so that all learn—In some examples, the disclosed systems and methods may provide options for reviewers and reviewees to interact using one or more Review Interfaces. For example, a virtual environment may be provided for sharing of reviews and comments, or for enabling groups to enter together the 3-D space in which Performances are being represented (either visibly or invisibly) so that individual members may get close-ups and may point out to each other specific elements of each behavior. This 3-D space might be able to be modified temporarily by the group in order to enhance learning, for example, by speeding up or slowing the action down, by enabling any member of the group to take control of either one of the representations of the participants in the Performance to be able to vary the scenario that has been represented in various ways, etc.

Examples of the use of the disclosed systems and methods in various aspects of an organization's operations are now described.

### Example 1

In this example, the disclosed systems and methods may be used to enable a Review of behavior by an employee at one Site, usually but not always interacting with a customer or a peer, by his or her peers or other co-workers, for example during free time already incorporated into the working day of the peers or co-workers. In this example, peers or co-workers may be front line employees or others who are neither the observed employee's supervisor, manager or team leader nor working in a quality control or assessment department of the employee's company or a company hired by the employee's company, nor the employee him/herself, nor the company's customers. Instead they may be employees having positions similar to the one being reviewed, for example whose regular jobs involve daily work in front line customer service environments, or other employees who are not in similar positions to the employee but may be deemed to be able to learn or benefit by watching and assessing Performances of the type in which the employee is involved.

Consumer Service Companies (CSCs, entities such as banks, retailers, governments, healthcare providers or other entities delivering face-to-face service through one or more service outlets, either fixed, mobile or virtual) may find it challenging to measure and report on the non-financial performance of their employees working in service outlets and of the service outlets themselves. In order to be more effective, performance measurement in this type of environment may aim to achieve one or more of: i) measuring a subjective assessment by a customer of the quality of the customer experience, for example, in a reliable and valid fashion; ii) indicating, for example, as precisely as possible what behaviors and/or choices made by the employee who served the customer resulted in the customer's assessment, and iii) reporting such information in a way that may help to motivate the employee(s) being assessed by providing objective information indicating any connection between what they did and how the customer felt about it.

Conventionally, CSCs aim to accomplish i) above through customer surveys, which may be relatively inexpensive (e.g., they can be done online or by telephone), and through cultivation of online customer communities. However, these types of surveys or feedback gleaned through customer communities may not to accomplish ii) or iii) above very well, and may therefore be of relatively limited value in driving or supporting front line behaviour change. CSCs may conventionally aim to accomplish ii) above through, for example mystery shopping, in which an outside individual poses as a customer and then, after leaving the premises, answers a standardized set of questions about what employees did or didn't do while serving them. This approach may be specific regarding how the employee(s) need to change their behaviour. However, challenges of this technique may be that i) data collection may be very expensive (e.g., labour costs associated with a mystery shopper's visit to the store), which may result in CSCs not collecting such data very often (e.g., less than once per month) and therefore such data may not be statistically representative of actual store performance; and ii) negative results delivered to employees may not be backed up with any data to illustrate why or how the judgment was made, with the result that employees may dispute or discount the results.

Since CSCs conventionally may not have access to effective non-financial service quality measures, managers and supervisors at CSCs may under-focus on the non-financial dimensions of customer service performance, which may hinder their ability to drive and support any necessary or desired front line customer service behaviour change.

In this example, one or more of the above challenges may be addressed by harnessing any spare capacity in a CSC's existing staffing, often among the front line sales or customer service staffing, to provide low-cost, valid, reliable and/or motivationally effective Reviews of the CSC's service quality in Performances by individuals and, more generally, by the Sites to which individuals are attached. Such spare capacity may be built into daily operations (e.g., slow times near the beginning or end of the workday, break time which an employee may wish to use in this way, etc.). In this example, these reviews may be provided by employees not in a quality control or assessment department (e.g., those in HR, managerial or supervisory positions), but by employees whose regular jobs may involve daily work in front line environments. During slow times (e.g., mid-morning or mid-afternoon for a bank or retail store, or after 6 pm for certain fast food outlets), front line customer service employees may have relatively little work, but are still being paid to be present (e.g., in case a customer shows up). Depending on the industry, such slow times may be up to 10%-20% of a front line employee's working hours. The employee may also suffer from boredom during such times, which may detract from that worker's overall work motivation.

In this example of the disclosed systems and methods, an employee may be provided with the option or the requirement to perform Reviews during such times. For example, the employee may be provided with access (e.g., a computer terminal, earbuds, a headset, etc. as appropriate) near or convenient to the workspace, in order to carry out quality assessments of service Performances by other employees, for example anonymously, for example of employees in other branch or store locations owned by the CSC.

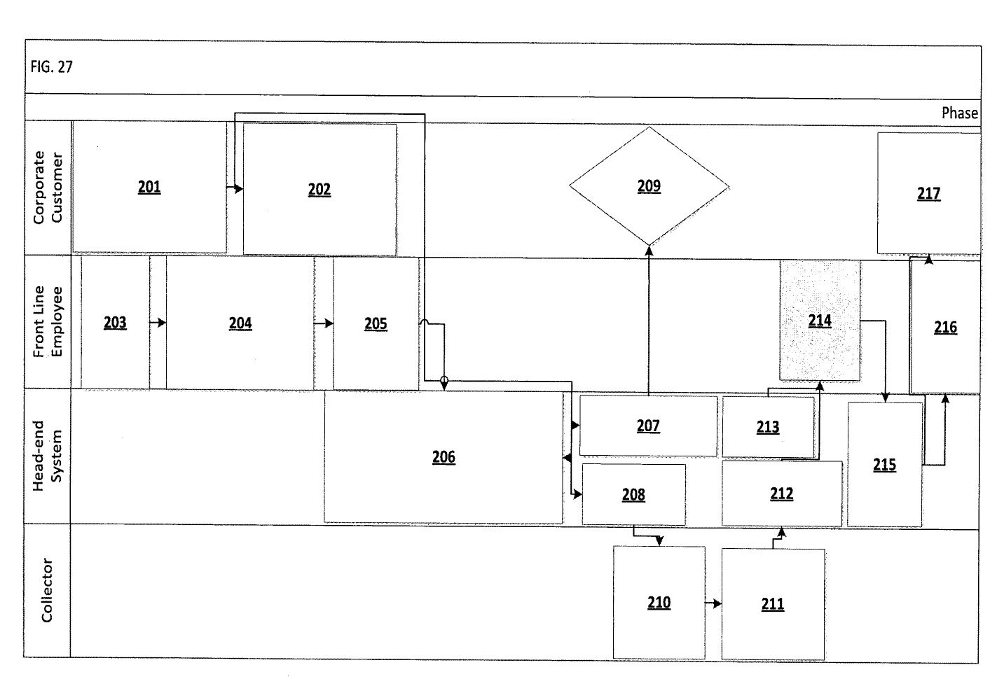

FIG. 27 illustrates an example process flow suitable for this example. FIGS. 28 to 38 illustrate an example Review Interface and Rubric that may be used to perform the process steps described below.

In FIG. 27, the example process may begin when a Virtual Mystery Shopping (VMS) Review Type is established (e.g., by a Quality department personnel within a Company), including, for example, definition of a suitable Review Interface Type and a suitable Rubric (201). The Rubric Type definition may specify, for example, the Performance Type(s) to be reviewed, any questions to be answered in the Review, one or more Stations from which Performance data is to be collected, and/or estimated time for completing a Review. The Rubric itself may include one or more questions of interest, such as questions pertaining to the appearance of one of the premises (e.g., relative to a desired appearance) and/or to the behaviours of employees in that premises (e.g., relative a desired set of behaviors designed to deliver a desired customer experience). Answers to such question(s) may provide an indication of how well a particular service Performance is executed, and of any specific details (e.g., appearance and behaviours) which may contribute to the Performance result.

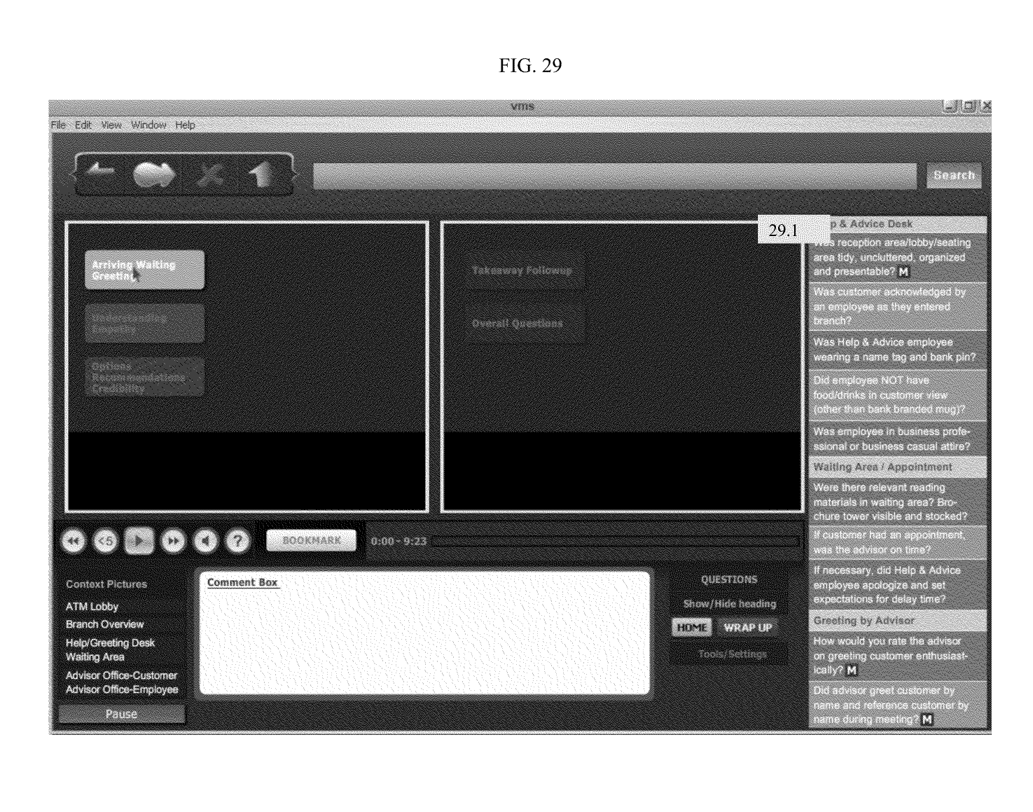

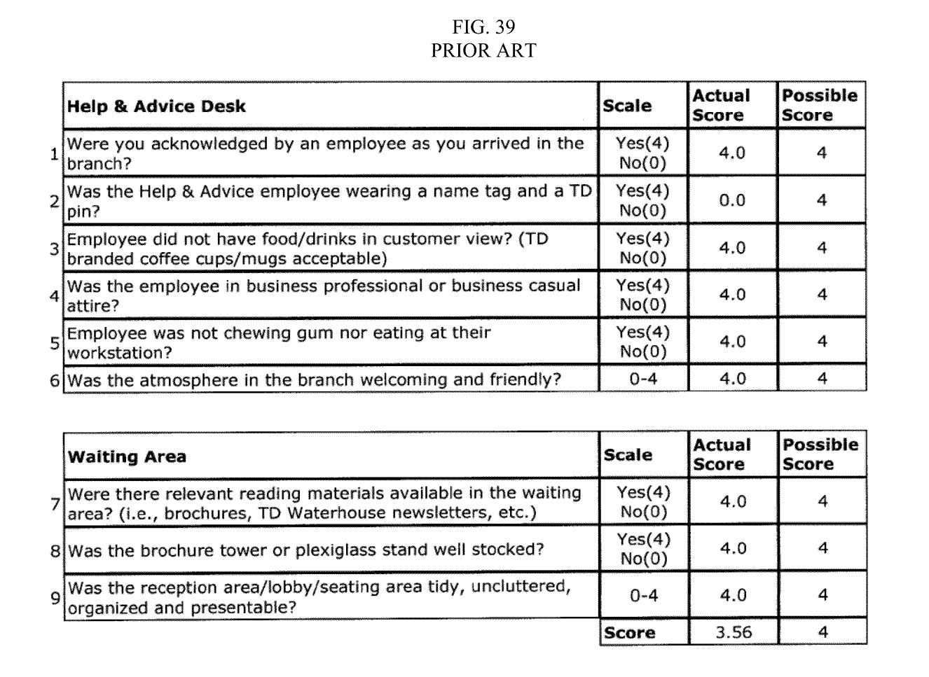

An example of questions that may be conventionally used as part of a conventional mystery shopping exercise to be carried out at a retail bank branch is shown in FIG. 39. In this example, similar types of questions may be categorized under topical headings (e.g., 4-6 headings). The defined question(s) (e.g., as selected by a Quality department personnel establishing the Review Program), which may be organized under topical headings, may be inputted into the Head-end System and may serve as a basis for a Rubric for a Review Program which uses a Virtual Mystery Shopping Review Type. An example display provided by an example Rubric is illustrated in FIG. 28, which shows example topical headings in the form of one or more Concept Bubbles (28.1)), and FIG. 29, which shows questions (29.1) under one of the topical headings. In establishing the Review Program Type, for the type of Site(s) that will be the subjects of review, one or more Stations that may be used to carry out the Review may also be defined (e.g., a teller's counter), and the approximate time for completing an average Review using this Rubric may also be defined.

As shown in FIG. 28, when a reviewer (e.g., a front line employee during slow times) accesses the Review Program (e.g., at a workstation such as a computer terminal having a display screen and input device(s) such as a keyboard and/or a mouse), the reviewer may be provided with a Rubric which may start with a display of one or more Concept Bubbles (28.1). Selection of a Concept Bubble may result in the display for illustrative purposes of one or more corresponding review questions (29.1), for example as shown in FIG. 29.

In FIG. 30, the reviewer may be provided with an option to select one or more Context Views to load into the Rubric for review, from a list of available Context Views (30.1). Selection of an entry in the list may instruct the Head-end System to load the relevant Performance data (e.g., video and/or audio data) for the selected Context View to the reviewer's workstation display.

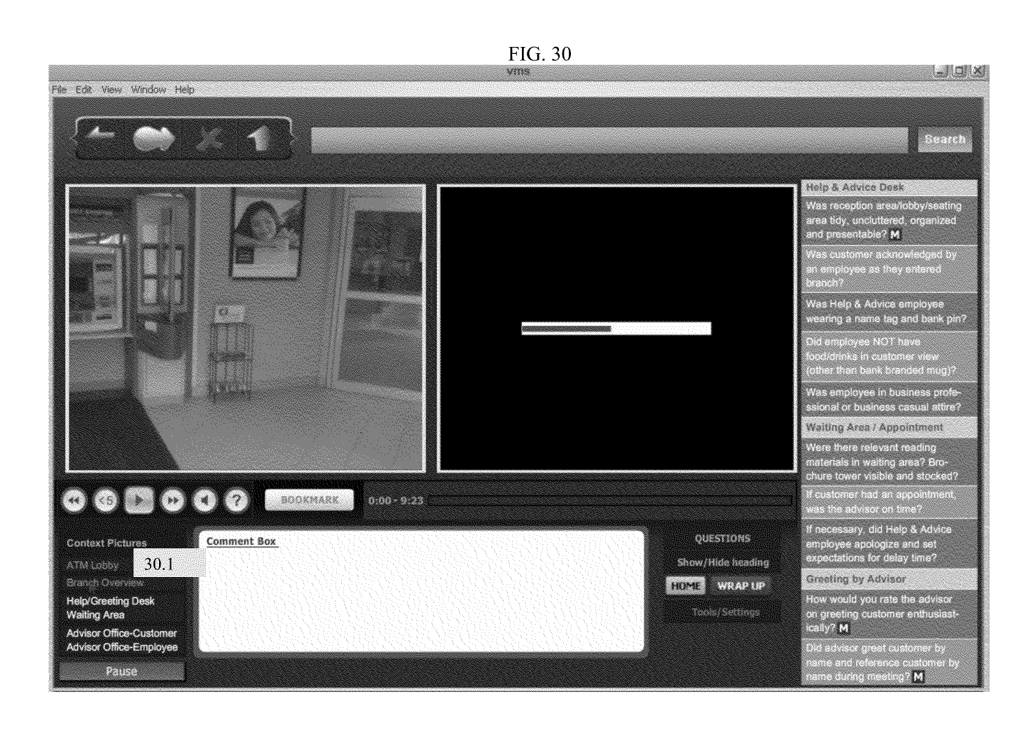

In FIG. 31, the reviewer may be provided with an option to select a question (31.1) to answer using the selected Context View(s). Selection of a question from the available list may populate a Comment Box (31.2) (e.g., a text box provided, for example, in the middle bottom of the Review Interface) with the question.

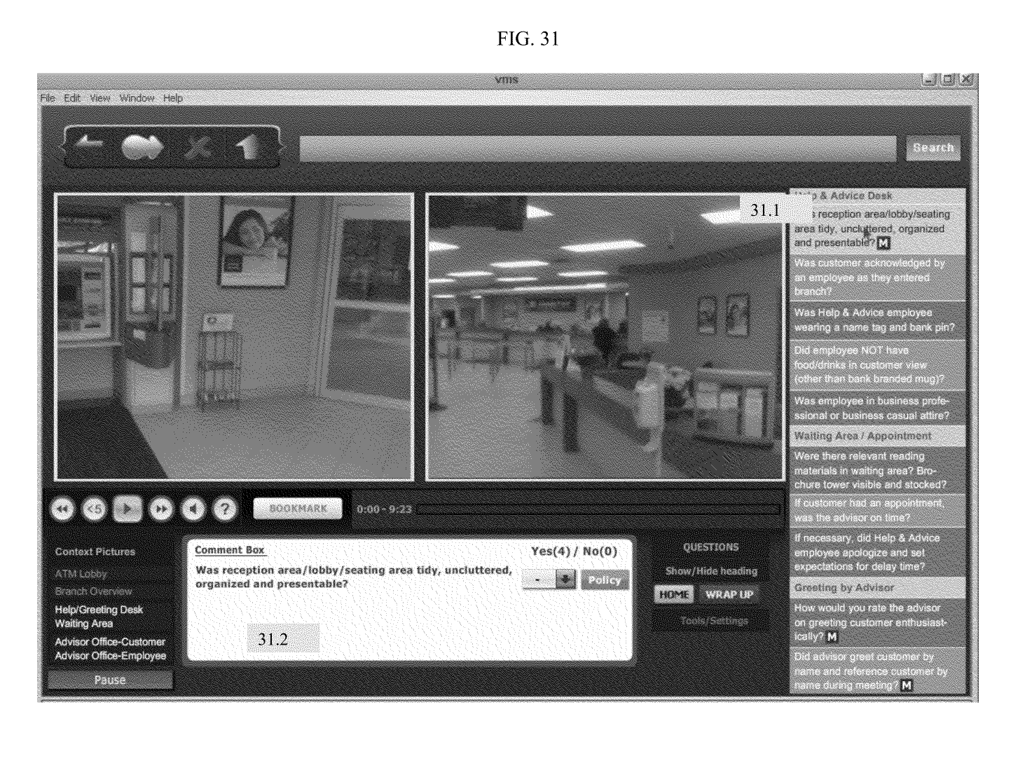

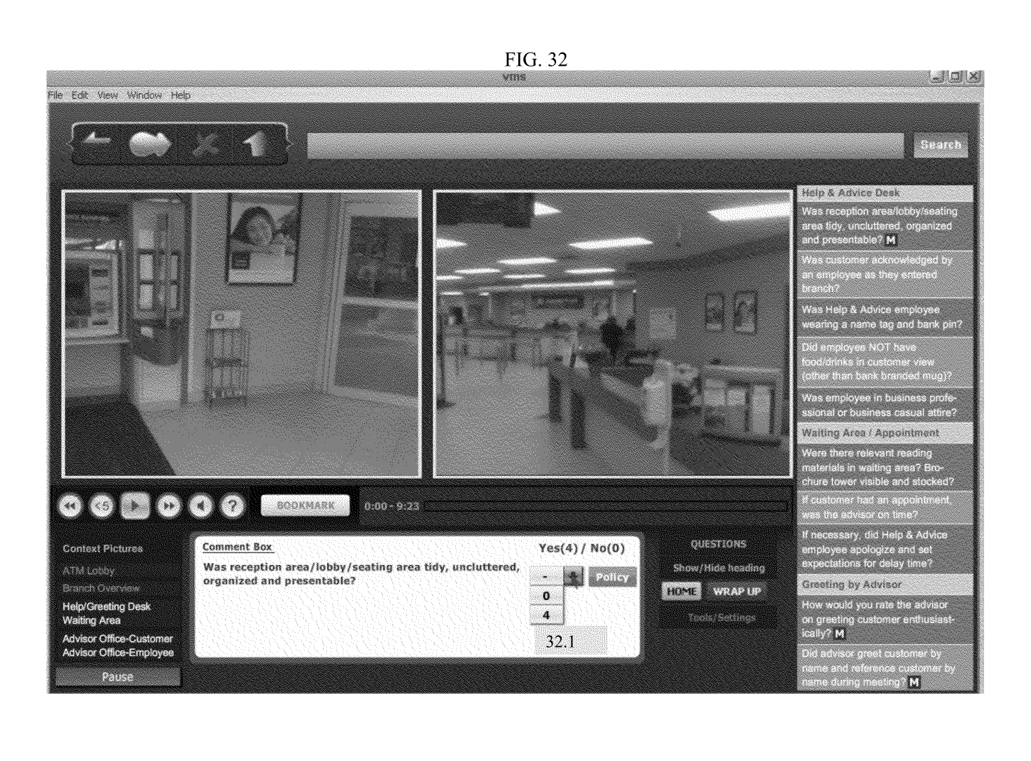

In FIG. 32, the reviewer may be provided with an option to answer the selected question. The answer may be provided, for example as a selection from a drop down answer box which may display a range of available answers (32.1). In other examples, other suitable methods may be provided to the reviewer to answer the question including, for example, text entry, audio input, sliding bar, check boxes, etc.

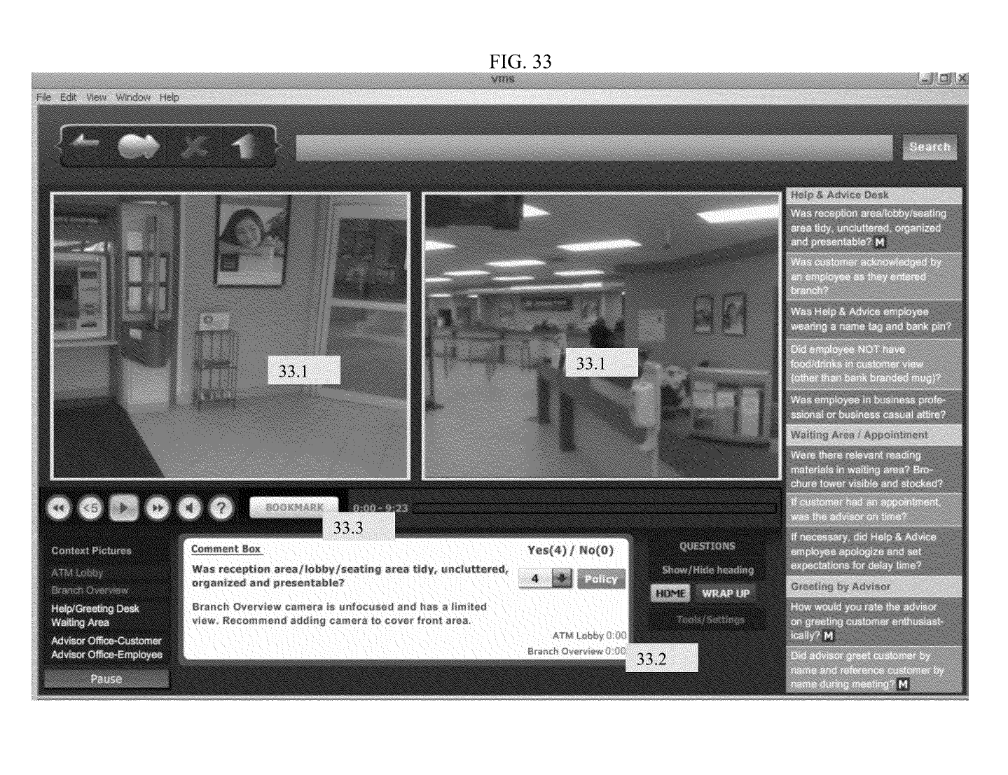

In FIG. 33, in addition to answering a question and optionally providing any comment, the reviewer may select one or more of the Context Views (33.1) (e.g., by clicking an image representing the Context View) to indicate that the reviewer deems the view to be relevant to the question. In some examples, selection of one or more Context Views may be indicated by a note or Bookmark (33.2), which may be included in the Comment Box. The reviewer may select a “Bookmark” button (33.3) to provide further comments at any time point or time period of the selected Context View. Use of the Bookmark button may enable the reviewer not only to indicate a Context View, but also to associate a rating (e.g., a “Like”/“Could Improve” type of approval rating) to the aspect of the Performance subject to comment, for example by adding an icon in the Comment Box.

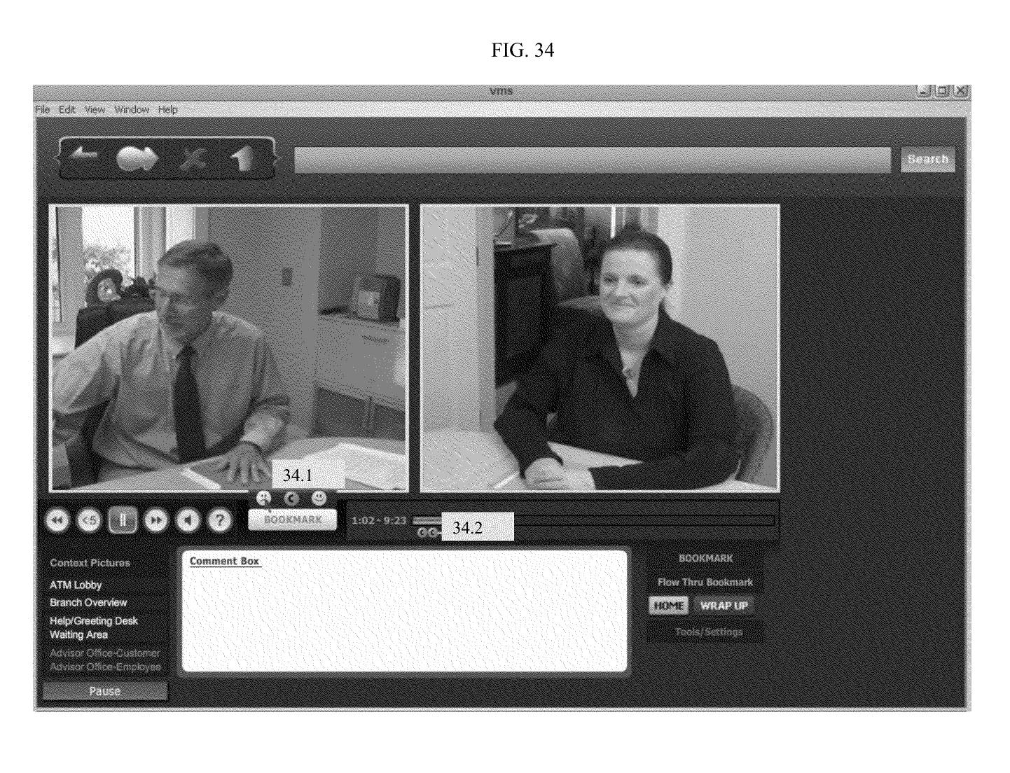

In FIG. 34, in response to a selection of the “Bookmark” button, the reviewer may be provided with selectable icons (34.1) (e.g., “Like”, “Neutral” and “Could Improve” icons) to indicate their evaluation of the Context View. Selection of an icon may result in the respective icon being displayed at the respective time point or time period indicated on a timeline (34.2).

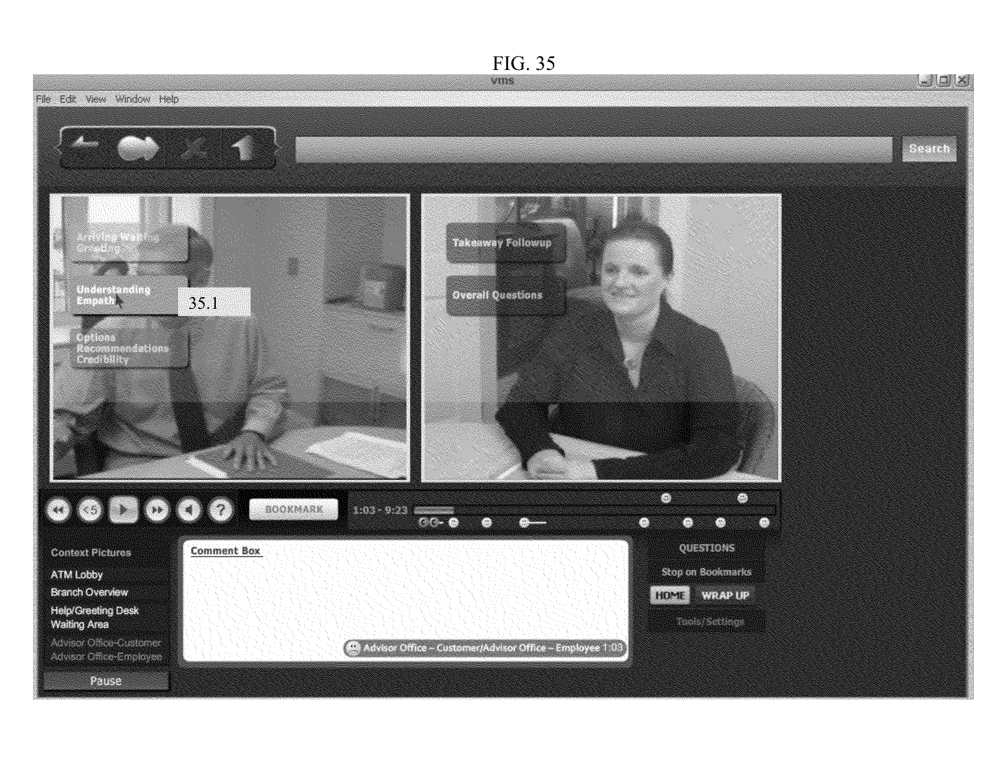

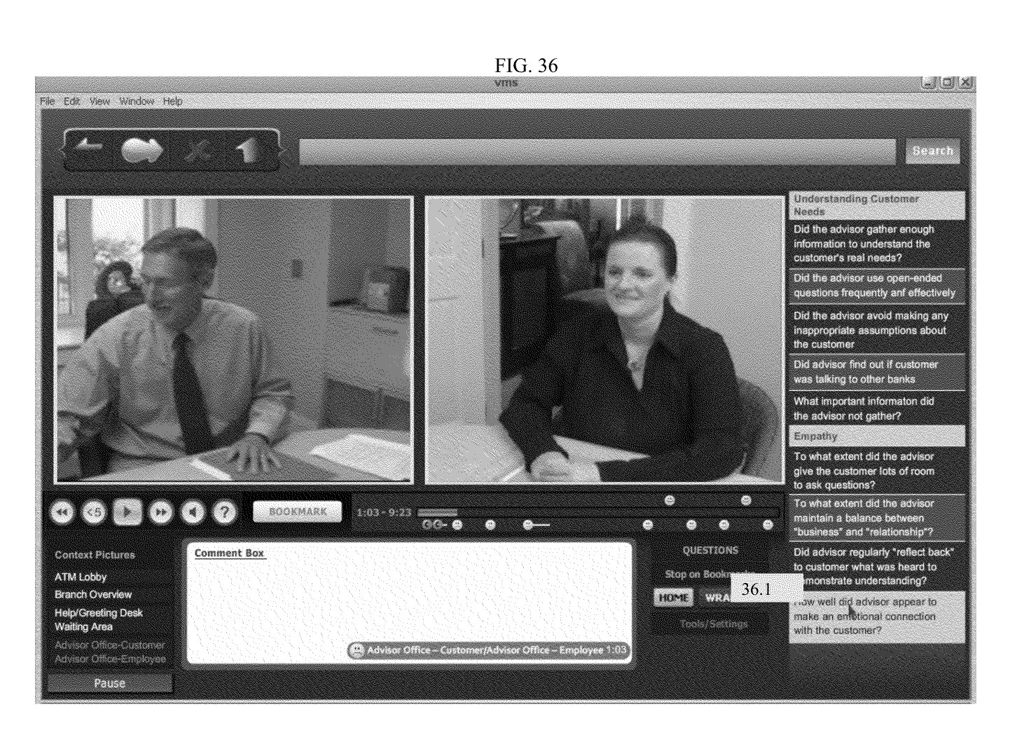

In FIG. 35, once the reviewer has viewed the entire Performance and created any Bookmarks, the Interface may automatically provide the reviewer with an opportunity to provide comments for any Bookmarks created by the reviewer that have as yet no comments associated with them. For example, the Interface may automatically display the first time point on the Timeline in the Context View that has no comment. One or more selectable Concept Bubbles (35.1) showing question headings used to arrange questions in the Rubric being used for the Review may be displayed. The reviewer may select a heading relating to what they want to comment on. In response to the selection, one or more questions associated with the selected heading may be displayed (see FIG. 36).

In FIG. 36, the reviewer may be provided with one or more questions associated with a selected heading. The reviewer may select the question (36.1) which they find to be relevant to the episode associated with the current Bookmark.

In FIG. 37, in response to selection of a question, the Comment Box may be automatically populated with the question. The reviewer may be provided with an option to select an answer to the question, for example using a button (37.1), a drop-down box, a check box or any other suitable input method. The reviewer may also be provided with an option to enter a comment (e.g., through text input or audio input or both).

The process illustrated in FIGS. 28-37 may be repeated until the reviewer has completed creation of Bookmarks and has provided suitable answers and/or comments for each created Bookmark. In some examples, the process may not be completed until a set of conditions is satisfied, for example all questions defined in the Rubric have been answered, or at least one question from each defined heading in the Rubric has been answered, or at least all the questions designated as being “Mandatory” in the Rubric have been answered. For example, if the reviewer attempts to end the process (e.g., by closing the Interface) before completion of all defined questions, the reviewer may be provided with a notification that there are still unanswered questions. In some examples, the reviewer may be provided with an option to save an incomplete Review to be completed in the future.

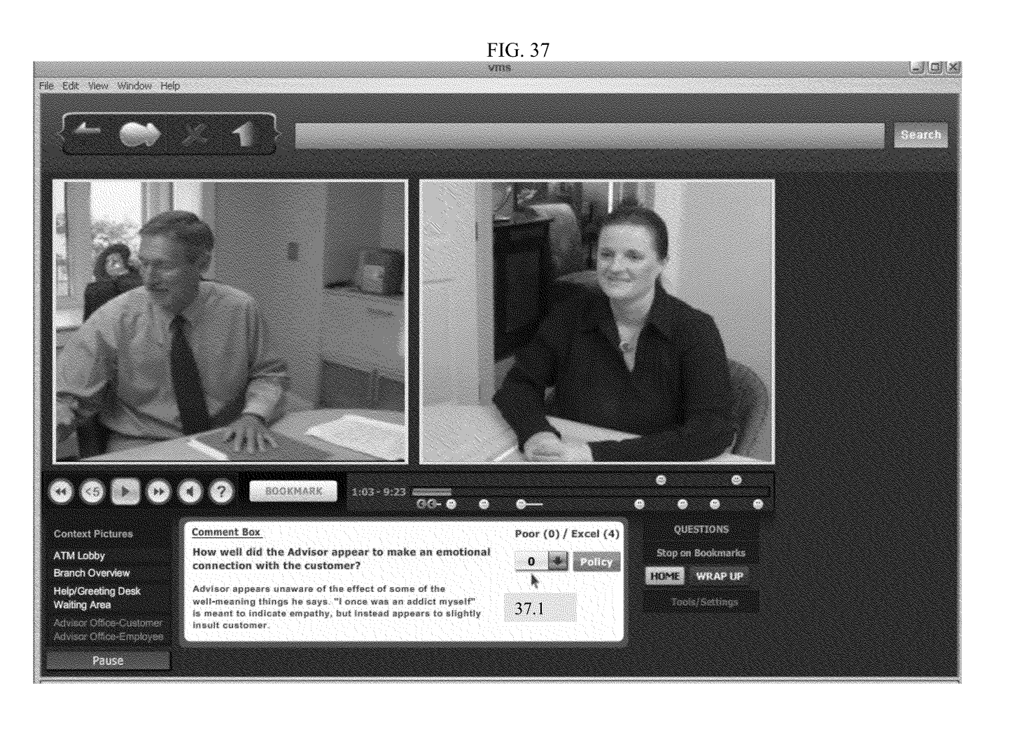

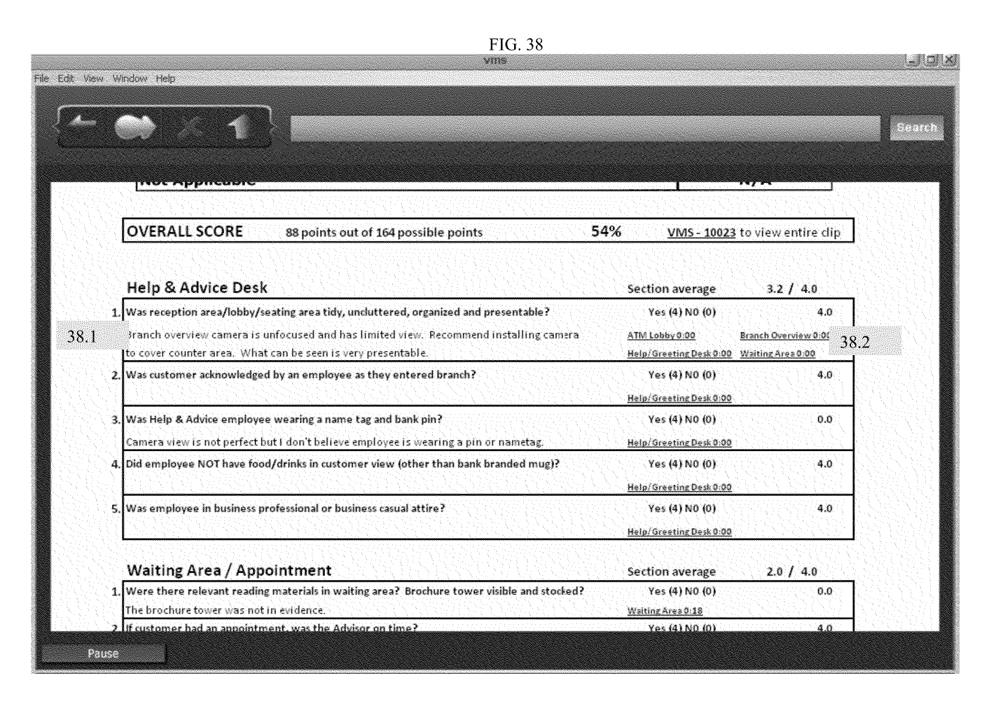

FIG. 38 shows an example Interface that may be displayed at the end of the Review process. In this example, a report may be automatically prepared (e.g., by the Head-end System), based on the answers and/or comments (38.1) provided by the reviewer. Any answers, comments and/or rating (e.g., similar to conventional mystery shop reports, such as the chart of FIG. 39) may be included in the automatically generated report. The report may also include one or more selectable links (38.2) to any episode(s) identified by the reviewer as being relevant to their answer to the related question. Selection of the link may automatically load and play the relevant Performance data for the episode(s). The report may be automatically transmitted to one or more designated parties at the office or Site that was reviewed, and thereby made available to the staff of that office or Site as a support to their efforts to change their behavior in order to improve the quality of their service, for example.

In some examples, the report may also be stored in a database on the Head-end System, for example to be accessed by authorized personnel (e.g., a store manager). In some examples, the Head-end System may automatically generate a notification to relevant personnel (e.g., a store manager or an employee being reviewed) that a report is available.

Referring back to FIG. 27 showing example steps involved in completion of a Virtual Mystery Shop Review, the example Rubric described above may be used to collect performance quality data on one or more defined Site Types. For example, the Review Interface and Rubric(s) to be used in reviewing particular Site Types or Performance Types may be defined (e.g., by a Quality department) (201). A particular Review Program may be defined by specifying, for example, which Users or Review Pool may participate in the Review Program, how many Reviews may be carried out per time period and/or for how long, which Sites should be involved, how often Reviews should be done, an end date for the Review Program, and/or which Rubric(s) should be used for Reviews (202).

Employees may learn (e.g., via online courses and/or online tests) the background to and/or the usage of the specified Rubric(s) (203). In some examples, an employee may be required to pass a qualification test (e.g., an online test) to be included in a Review Pool for using the particular Rubric. In some examples, the employee may request appropriate permission(s) (e.g., from a supervisor) to participate actively in a Review Pool (204). The employee may secure approval to perform reviews (205). The approval may specify that the employee may perform a specific number of Reviews per period.

The defined Rubric(s) may be stored in the Head-end System (e.g., in a rubric database). Identification of any employees qualified to use those Rubric(s) may also be stored in the Head-end System (e.g., in a review pool database). The Head-end System may establish the scope of the Review Program (e.g., using an assessment scheduling module) including, for example, the Site(s) involved, the Performance Type(s) to be reviewed, the Station(s) from which data should be collected, the number and/or frequency of Performances to collect from each Site, the Rubric(s) to be used for review, the number of reviewers needed, etc.

The Head-end system may monitor the sufficiency of the size of the Review Pool to meet the needs of the established Review Program (206). This may be done using, for example, an assessment scheduling module in the Head-end System, and may be based on the specifications of the Review Program. For example, the Review Program may be defined with a specification that a minimum number of reviewers must be used, that a minimum number of Performances must be reviewed and/or the Reviews must take place over a defined period of time, as well as any other suitable requirements. If the Head-end System determines that there are insufficient resources (e.g., the Review Pool qualified to use the defined Rubric is too small), the Head-end System may generate a notification about the insufficiency. This notification may be provided to the relevant personnel (e.g., the Quality department that established the Review Program) (207). The relevant personnel may then take appropriate action, for example, to cut back its proposed Review Program or to induce more employees to join the Review Pool (209).

Assuming there are sufficient resources to carry out the Review Program, then based on the defined Review Program, the Head-end System may notify the relevant Collector(s) (e.g., the Collector(s) of Site(s) defined in the Review Program) of the requirements of the Program (e.g., Performance Types to be identified and/or Sensor data to be retained) and request such data to be provided (208). In response, the Collector(s) may identify any existing Performances (e.g., stored in a Collector database) that meet the defined criteria (210). The Collector(s) may then transmit the relevant data to the Head-end System (e.g., as efficiently as possible, such as overnight transmission of data) (211). In some examples, where suitable data is not available (e.g., the Collector does not have sufficient Performance data relating to a defined requirement of the Review Program), the insufficiency may be reported to the Head-end System and/or to relevant personnel, and/or the Collector may automatically activate suitable Sensors to collect the needed data.

Once the data is received at the Head-end System such data may be stored in a suitable database (212). The system may then notify a reviewer (e.g., a Review Pool member) that a Performance is available for review (213). The Review Pool member may log into their personal portal and may be provided with a Performance with the defined Rubric, for example using the Rubric described above (214).

Once the Performance has been reviewed the Review data may be transmitted to the Head-end System. The Head-end System may store the data in a suitable database, and may generate any relevant reports (215). Such reports may be accessible by relevant personnel, such as personnel from the Quality department and/or the individual Site that was the subject of the Review. The report may provide detailed information about each Review (e.g., specific comments, ratings and/or created Bookmarks) as well as summary data of Reviews performed and scores obtained. The completed report, an example of which is illustrated in FIG. 38, may be transmitted to the relevant personnel, for example to the manager of the outlet that was the subject of the Review (216). A summary report may also be provided to the quality department of the Company (217). In some examples, the report provided to the quality department may be an aggregated report providing assessment results for one or more Sites, and may include review performance for one or more participating employees.

As described above, the report may provide selectable links for each question, rating and/or comment. Selection of such links may automatically provide the user with Performance data (e.g., video and/or audio) of the episode that the reviewer had associated with the question, rating and/or comment. A recipient of the report may also be provided with an option to rate the assessment made by the reviewer (e.g., as “Very Helpful”, “Helpful”, “Appreciated” or “Disputed”). Such a rating (which may be referred to as a Review-of-Reviews) may be information that may be stored (e.g., in a Review-of-Reviews database at the Head-end System) with any other ratings received by the reviewer, and may be used to create an assessment track record for that reviewer. Such a track record may be useful for the reviewer to learn about how their assessments are viewed by others and/or for others to learn how useful that reviewer's reviews may be. In a Review-of-Review, the reviewer may be provided with an option to step through bookmarks and/or comments created in the previous review, without having to watch the entire Performance.

In some examples, if a specific comment, rating and/or Bookmark have been indicated as being disputed, the Head-end System may automatically generate a notification to the reviewer, the report recipient and/or their direct supervisors. Such a notification may be individually generated for each party notified, for example to help maintain anonymity of the reviewer. Such a notification may be useful to allow the reviewer and the recipient to learn by discussing the episode and the resulting rating with their respective supervisor and/or coming to their own conclusions about its appropriateness.

In the example described above, a CSC is provided with the ability to use its own employees (for example during under-utilized time in the workday, or through small additional piece-rate payments to employees who perform reviews after hours) to perform assessments of, for example, non-financial service quality delivered at various outlets. Such an application may benefit the CSC and its employees based on one or more of the following:
Employees performing the Reviews may be more knowledgeable about how a customer service Performance is supposed to be than, for example, customers or third party mystery shoppers;
Anonymous Reviews may result in little or no motivation for over or under-criticizing a Performance so that reviewers may feel able to be more honest and complete in their Feedback, all to the benefit of the Company, Site or employee;
By spending under-utilized time reviewing service Performances more regularly, the employee reviewers may become more skillful themselves in their own Performance (for example, preparing feedback for someone else may force one to consolidate thoughts and learning of the subject matter applied to oneself);
Performers who receive reviews from their peers may find it more difficult to dismiss such reviews as being irrelevant, as they may with conventional third party mystery shoppers;
Because each assessment by a reviewer may be explained by one or more links directly to a specific episode(s) in the Performance, a performer who receives a review may be provided with more information to help understand the basis for an assessment, and may use such information more effectively to help drive behaviour change;
Reviewers may feel more valued by, and therefore more loyal to, the organization;
A regular workday may be already structured to include downtime during which Reviews may be performed by an employee with little or no incremental costs to the company; and
Regular review and assessment by all employees of actual service Performances may help to promote healthy dialogue about the organization's underlying values and principles, for example as they pertain to customer service (e.g., to promote and reinforce company culture).

Another possible benefit may be that as a result of using its own employees, the CSC may reduce data collection costs associated with quality assessments. For example, the estimated incremental cost of a conventional live mystery shopper may be about $30-$80 per mystery shop, while the equivalent cost using the example described above may be about $2-$5 per mystery shop. Thus, the CSC may be able to afford more assessment activity, with the result that more data points per month (e.g., 25 or more Reviews) may be possible (e.g., as opposed to once a month using a conventional mystery shopper). This may help to achieve results that may be statistically representative of real customer service performance. This may allow CSCs to focus more attention and compensation decisions on these results, which may lead to better performance by employees.

Variations may be possible to the example described above. For example, in order to fit more efficiently into the working day of employees that are on the job, miniaturized headsets may be used to carry out a Review rather than separate workstations. This may enable a worker to review a Performance, for example while standing behind a counter, without such activity being obvious to any customer that enters the outlet.

### Example 2

In this example, the disclosed systems and methods may be used to allow a customer him/herself to provide a Review of a Performance illustrating an interaction between a customer (e.g., the same customer performing the Review or another customer) and an employee. The customer may be provided with the ability to not only provide Feedback about the general interaction, but also Feedback on specific episodes or employee behaviours within the Performance and their impact on the customer experience.

Performance measurements relating to service Performances by employees or by individuals engaged in a human interaction (e.g., with a customer) may aim to achieve one or more of the following: i) measuring the customer's (or recipient's) subjective assessment of the quality of their experience in a relatively reliable and valid fashion; ii) indicating, for example as precisely as possible, what observable behaviours and/or choices made by the performer who served the customer may be related to the customer's assessment; and iii) reporting this information in a way that may help to motivate the employee(s) who are being measured, for example, by providing objective information connecting their behaviour directly to the customer's assessment.

CSCs may conventionally attempt to accomplish i) above through customer surveys, for example, which may be relatively inexpensive (e.g., they may be done by telephone, using online response forms, or through cultivation of online customer communities). However, results from these surveys may not accomplish ii) or iii) very well, and may be of limited value in driving or supporting front line behaviour change. Further, while front line employees may respect the validity and importance of customer survey data, such data may provide relatively little indication of how behaviour should be changed in order to affect the customer's assessments. This experience may be equally true in the case of reviews by non-customers (e.g., supervisor, peer, external coach, etc.) where employees or individuals may be given generalized feedback about their overall performance but rarely about any specific behavioural details which may help to point them in the direction of change.

A challenge with the issues described above may be that CSCs and/or individuals may not derive much impact on observable front line performance from customer research. This example of the disclosed systems and methods may help a CSC (or even individuals operating independently) to derive greater benefit from expenditures on customer research (or on other reviews, where relevant) by allowing the customer to observe a recording of a service Performance, either one in which they themselves were involved or one in which they were not involved, and by providing tools for indicating specific employee behaviours and for providing information about how those behaviors lead to a particular customer assessment.

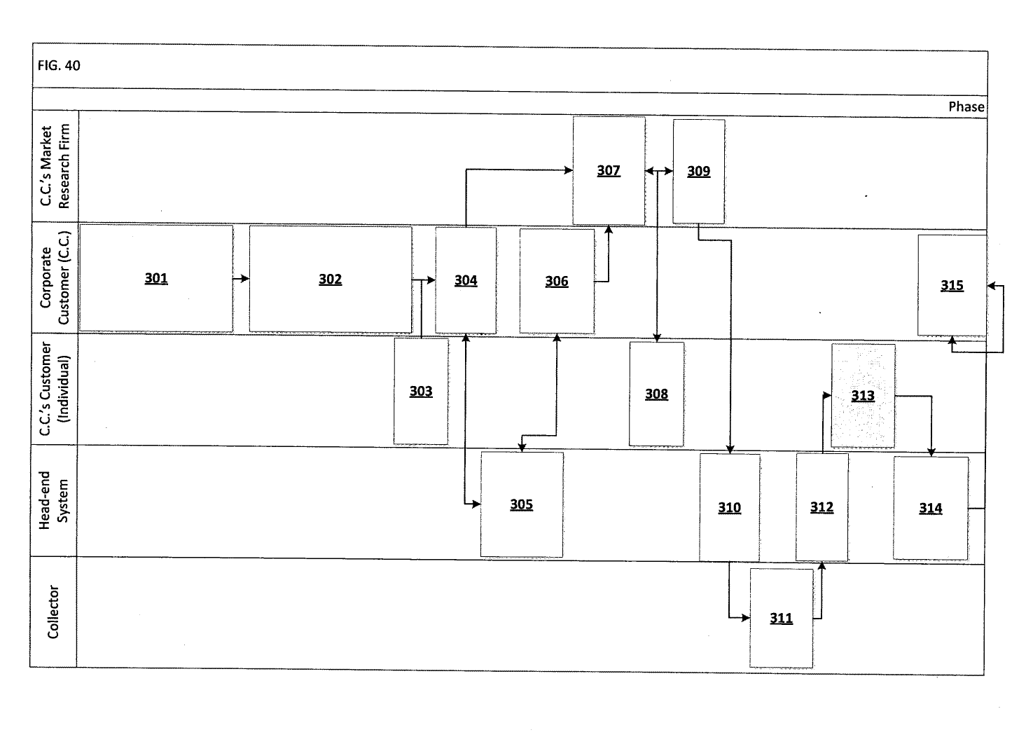

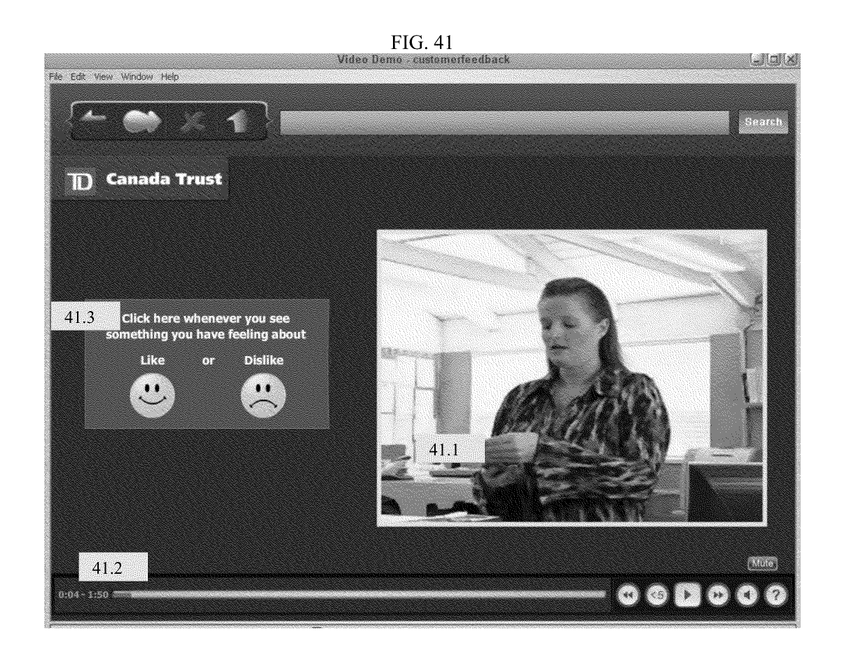

FIG. 40 is an example process flow chart which illustrates an example of use of the disclosed systems and methods. In this example, the Review Type may be a Virtual Insight into Customer Experience session and may use a particular Review Interface Type, for example as illustrated in FIGS. 41 to 43. The Interface shown in FIGS. 41-43 may illustrate not only aspects of the Review Interface but also of the specific Rubric which may be used to prompt a reviewer (e.g., a customer) to describe a subjective experience of a service Performance, which may allow the performer to understand how his/her behaviour contributed to the customer's experience.

In the example process illustrated by FIG. 40, the relevant Review Type and Review Interface Type may or may not have already been established (e.g., when the system was first installed). The example process may begin when a Rubric using a specific Rubric Type is defined (e.g., by a corporate Quality department personnel) (301). The definition may specify, for example, the Performance Type(s) that may be reviewed, the Concept Bubble(s) to be used and/or which Station(s) and/or Site(s) to collect data from. In this example, the Rubric Type may include multiple (e.g., three) layers of Concept Bubbles (for example as illustrated by FIGS. 41-43), each of which may be triggered by a selection made at a higher layer. The Rubric may define text which may be inserted into the Concept Bubbles to prompt the reviewer to elaborate on an initial assessment (e.g., a rating of “Like”/“Could Improve”).

In 302, the scope of a Review Program may be defined (e.g., by the Quality department personnel) to use a specific Rubric. The definition may specify, for example, the Site(s) and/or Station(s) to be reviewed, the number of customers from whom to solicit a Review, any criteria for selection of a customer for Review, an end date for the Program and/or the Rubric(s) to be used for review. For example, a conventional customer callback or survey program may be already in place, and the frequency of solicitation for customer feedback in this existing program may suggest an appropriate frequency and/or scope of this Review Program.

A customer visit to a Site defined in the Review Program may take place (303). Such a visit may be logged. A log of the customer visit (e.g., including information about customer name, time/date, Station, duration, etc.) may be gathered and transmitted to the Head-end System by the quality department, for example (304). For example, a Company's existing customer relationship management (CRM) or point of service (POS) system may capture data from the customer visit (e.g., logging date and time of the visit and/or any employees the customer interacted with), and such data may be sorted and transmitted to the Head-end System.

The Head-end System may match the log entry of the customer visit to an index of Performances (e.g., based on stored meta-data provided by one or more Collectors) (305). Assuming a match is found, a confirmation may be transmitted by the Head-end System to the Company to confirm that a Performance of the visit is available for Review. If a match is not found, the Company may also be notified of this (306). The Head-end System may also request a different customer visit log entry until a match is found.

In some examples, for each customer visit that is matched with a stored Performance, the Company may secure the respective customer's permission, for example through an outside market research firm, to engage the customer in performing a Review (307). The customer may be asked for permission to send (e.g., electronically) to the customer one or more representations of Performances in which the customer was served by a Company representative. Assuming the customer agrees (308), the Company or the outside market research firm may notify the Head-end System of the visit that is to be reviewed (309).

Upon receipt by the Head-end System of a notification of a willing customer to review a given customer visit, the Head-end System may request the appropriate Collector (e.g., the Collector associated with the store visited by the customer) to forward relevant Performance data (e.g., video and/or audio data) (310). The Collector may transmit the requested Performance data to the Head-end System (311). Upon receipt of the Performance data, the Head-end System may provide the customer with access to the Performance data (e.g., via a link emailed to the customer) (312). Such access by the customer may include one or more security features (e.g., the use of a password or PIN, or suitable encryption) to help ensure privacy and/or security of the data.

When the customer attempts to access the Performance data (e.g., by clicking on the link), the Head-end System may present to the customer the relevant data (e.g., video/audio recording) of the Performance involving the customer (313). In some examples, the Performance may be presented to the customer with or without the customer's own image included in the Review Interface. The Performance may be presented via a viewing Rubric such as the example illustrated and described with respect to FIGS. 41-43. This Rubric may be simplified compared to other Rubrics described in the present disclosure, for example to avoid the need to train the customer in its use. The Rubric may include a video feed of the Employee Side. The Rubric may or may not include a video portrayal of the customer, for example. The Rubric may also include one or more audio feeds, for example from each side of the interaction.

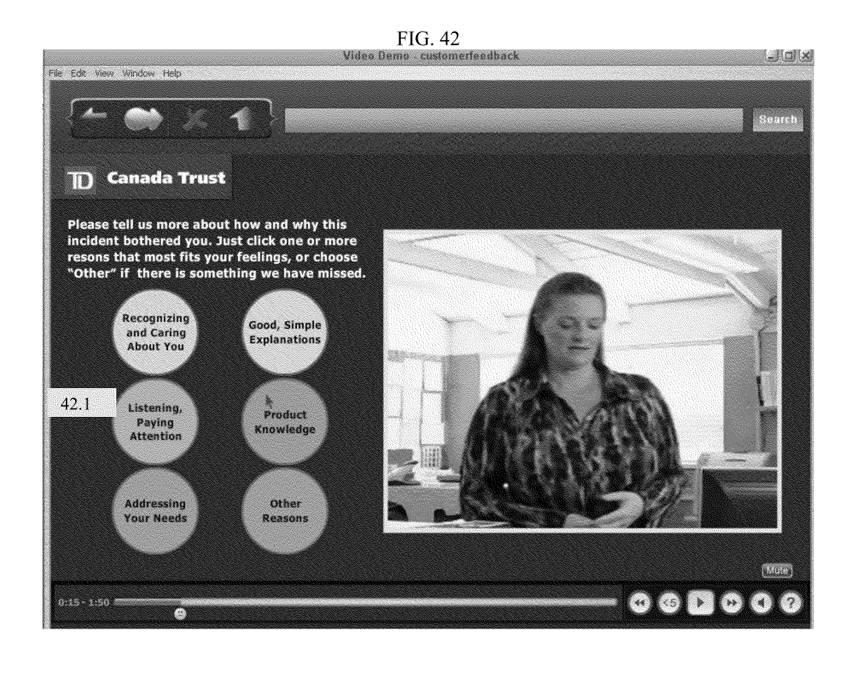

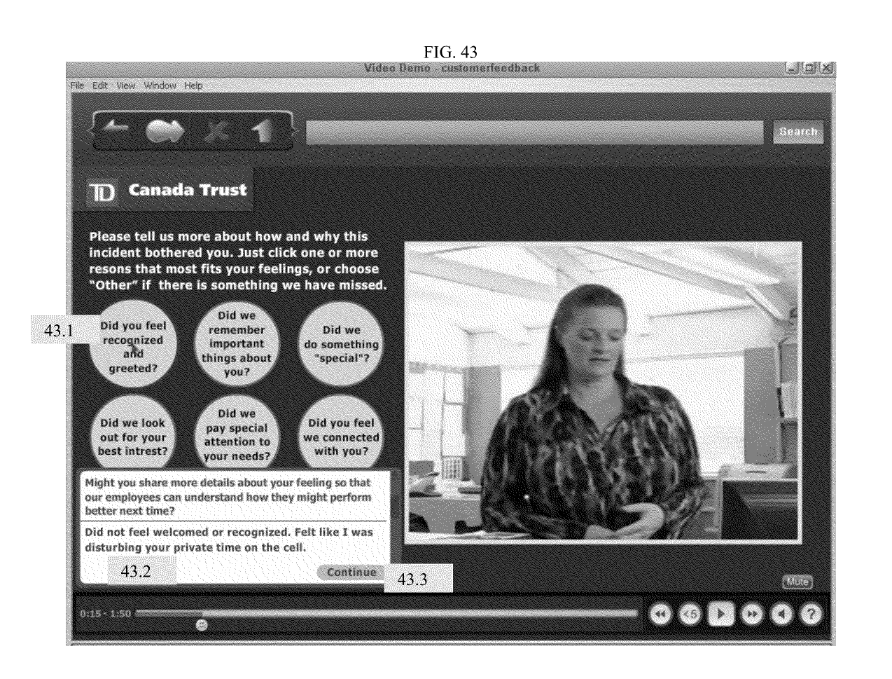

The Rubric may prompt the customer to provide specific Feedback relating to the Employee Side of the Performance and the customer's subjective reaction to it. The Rubric may allow the customer to associate such Feedback directly with specific behaviours exhibited by Employee at specific times in the video and/or audio representation of the Performance being viewed. Feedback from the customer may be solicited in a layered fashion, with each subsequent layer soliciting more detailed information from the customer. For example, FIG. 41 demonstrates a type of relatively simple initial solicitation (e.g., like or dislike) the customer may be presented with while watching a Performance. For example, when the customer sees something they like or dislike, at any point during the Performance, the relevant icon may be selected. Once the customer narrows down the nature of their initial choice (e.g., like or dislike), FIG. 42 illustrates an example secondary-order solicitation that may be presented to the customer following the initial selection. FIG. 43 illustrates an example tertiary order solicitation that may provide the customer with an opportunity to provide detailed Feedback (e.g., by text or by headset microphone, according to the customer's preference). FIGS. 41-43 are described in further detail below.

In FIG. 41, the example Review Interface may present the customer with a Performance showing an interaction the customer was involved in. In this example, the customer may be presented with only the Employee Side of the interaction (41.1). In this example, both sides of the audio track may be provided so that the customer may hear themselves interacting with the employee that served them. In some examples, a timeline (41.2) may be provided indicating the elapsed time of the Performance. The customer may be provided with a primary order solicitation for Feedback, such as a selectable “Like” or “Dislike” Feedback button (41.3). Selection of the Feedback button may automatically pause playback of the Performance, insert a Bookmark at the appropriate time point in the timeline, and may display a secondary order solicitation for feedback, for example as shown in FIG. 42.

In FIG. 42, in response to a selection of a primary order feedback, (e.g., “Like” or “Dislike”) the customer may be provided with secondary order feedback options, for example in the form of Concept Bubbles (42.1) (e.g., as defined when the Review Program is first established), which may provide the customer with an opportunity to more detail on the primary order feedback for the Bookmarked episode.

In some examples, the Rubric may further provide tertiary order feedback options (e.g., based on the Rubric definition when the Review Program is established by the Company) in response to a selection of a secondary feedback option. FIG. 43 shows an example Interface that may be displayed to a customer for providing tertiary order feedback. The tertiary order feedback options may include more detailed Concept Bubbles (43.1) which may attempt to solicit more detailed information about the customer's reaction to the employee's behaviour in the Bookmarked episode. The customer may also be provided with an option to provide freeform feedback, for example the customer may be provided with a comment box (43.2) for entering detailed text comments. In some examples, the customer may be provided with an option to provide audio comments (e.g., via a headset or microphone input device).

Although not shown, further levels of detailed feedback may be solicited beyond tertiary order. For example, in more detailed levels of feedback, the customer may be provided with an option to select specific portions of a video image to indicate visually aspects of the interaction the customer liked or disliked. In some examples, the customer may be required to complete all defined levels of feedback in order to complete commenting on a Bookmark. In some examples, the customer may be provided with an option to skip any level of feedback (e.g., the customer may choose to provide only primary order feedback).

When the customer is done providing feedback for a Bookmarked episode, the customer may instruct the Performance to resume, for example by selecting a “continue” button (43.3). The Performance may then resume, again presenting the customer with the primary order feedback options, such as the “Like”/“Dislike” buttons as illustrated in FIG. 41.

Referring again to FIG. 40, once the Review is completed (e.g., the entire Performance has been played and at least one piece of Feedback has been entered by the customer), the customer's responses may be transmitted to the Head-end System. Such data may be compiled by the Head-end System, for example to be included in any relevant reports (314). The data may be stored (e.g., in a customer feedback database) by the Head-end System. In addition to the customer Feedback data and any relevant reports, the recording (e.g., video and/or audio data) associated with the Performance itself may made available to the relevant manager and/or employee at the Site in question so that they may review both the Performance itself and the customer's specific reactions to it at the same time. A summary report (e.g., aggregating assessment results from one or more Sites) generated by the Head-end System may also be transmitted to other personnel, for example Quality department personnel, to allow for monitoring of trends and/or usage of the Rubric, for example (315).

Conventional methods of soliciting feedback from customers may rely on various forms of after-the-fact Feedback collection mechanisms, which may be customer-initiated (e.g., a customer logging on to a company website to complete a survey in the hope of deriving some benefit) or Company-initiated (e.g., use of focus groups, callback interviews, surveys, etc.). These methods may be deployed in a systematic ongoing way and may encompass a whole chain of outlets, so that Feedback may be used to influence regular employees in day-to-day work situations, for example. However, such conventional methods may rely on the customer's subjective memory of a live service Performance that may have taken place, for example, days before the customer provides Feedback. Such memories, while real to the customer, may not be accurately connected in the customer's memory to specific behaviours exhibited by the employee. This may limit the value of the customer's Feedback as an aide to help that employee adjust his/her behaviour in response to the Feedback.

Other conventional methods of soliciting customer Feedback may rely on a staged setting which may be setup to enable real-time collection of reaction data from a customer in one or more “test” encounters with an employee or a business system. Examples include cameras which capture eye movements or microphones which capture modifications in tone of voice. These methods may capture real-time physical responses by customers to moment-by-moment experiences of an employee's behaviour and/or the environment. However, such conventional methods may require service to be performed in artificial spaces or contexts and, as a result, may not be suitable as a source of Feedback for individual employees working in real day-to-day environments.

The example application of the disclosed systems and methods discussed above may benefit a Company or User based on one or more of the following:
The example application may provide a direct link between an employee's observable behaviour during a Performance and the customer's reaction to that behaviour. This may allow the employee to derive direct motivational benefit in terms of their efforts at behavior change by receiving specific feedback directly from the customer. In another case, the employee may derive direct motivational benefit in terms of their efforts at behavior change by receiving feedback about their behavior not only from the specific customer they served, but also from other customers watching the original Performance, thereby giving the employee the benefit of other customer-like perspectives.
The example application may provide a mass market, ongoing, relatively cost-effective means of accomplishing everyday in a real environment what may be done conventionally only in a “training” or artificial environment.
By allowing customers to provide their feedback over, for example, an electronic medium as opposed to via an interviewer for example, the cost of data collection may be reduced.
By allowing the customer to revisit a service experience again, the customer may be provided with an opportunity to reflect upon the experience at more length, which may often allow the customer to become more appreciative of a good experience or more understanding of an employee mistake.
By using the disclosed example, the Company may communicate to its customers a transparency and an honest desire to understand its behavioural challenges, which may help to build customer loyalty.
Customers may become engaged in an ongoing relationship with the Company in which the customers are helping the Company to serve them better. This may also help to increase customer loyalty.

Variations to the disclosed example may be possible. For example, in the example described above, a customer visit may be logged and identified (for example by a specific date/time/location), for example by a Company's existing POS or CMR system, and such identifying information may be transmitted to the Head-end System. In other examples, the Head-end System may be integrated with the Company's existing POS or CRM system, and any customer visit may be automatically logged, identified and matched to a stored Performance by the Head-end System (e.g., including identification of the customer involved). This may allow the Head-end System to automatically generate its own representative list of customer visits, rather than having to rely on a list produced by the Company itself. Such integration may also enable the Head-end System to be made aware of a customer-initiated quality assessment in which the customer identified themselves by invoice number, etc. and/or left a forwarding email address.

In another example, the User may be an individual who is seeking to improve his/her Performances in various ways and who may solicit the assistance of the recipient of those Performances. In this case, the individual themselves may create or select the Rubric to be used (for example by selecting from an existing library provided by the Head-end System) by the recipient. The individual may use the system to provide the recipient with the Rubric (e.g., by emailing a link to the recipient directly), and the recipient may then carry out the Review in a manner similar to that described above.

In another example, at the end of the Review, the Rubric may include a request that may seek to enroll the reviewer to agree to perform another similar Review in the future (e.g., the following month, quarter or year). This may help to engage a customer in a relationship where they may agree to help the Company to get better at providing better customer service. This may also help to increase a customer's degree of loyalty to the Company.

### Example 3

In this example, the disclosed systems and methods may be used to enable multiple employees working side by side in a common facility to pay more attention to a particular aspect of or perspective on their collective customer service, in order to support their collective efforts to change their behavior or habits. For example, employees may be focused to pay more attention to the physical appearance of a facility (e.g., from the perspective of what a customer might see, although other perspectives may also be possible) in order to support their collective efforts to change their behavior or habits that may impact how the facility looks.

Often, management may seek to inculcate into their employees certain habits or behaviours related to an individual or group aspect of customer service, such as keeping the physical appearance of the facility in line with desirable standards. In these situations, certain employees may notice or pay attention to such aspects of customer service (e.g., the physical appearance of the facility) more readily than others. Those employees who do not pay attention to such aspects may take up a disproportionate share of management's attention, and may cause bad feelings with employees that have made an effort to keep the facility looking good, for example.

In this example application of the disclosed systems and methods, all members of a group of employees may be provided with a way to focus their attention on how their personal behavior impacts or contributes to a group aspect of customer service, such as appearance of a facility. Other group aspects of customer service may include, for example, volume of noise, availability of staff, fluid movement of team members from serving front counter customer to serving drive-thru customers in a fast food restaurant environment, etc.

In this example, the system setup may be similar to that described above. In addition, one or more Sensors (e.g., cameras, microphones or other Sensors as appropriate) may be added to those installed to capture individual Performances in order to specifically capture service Performances related to group aspects of customer service, for example representing the perspective that employees are supposed to pay more attention to. For example, the customer's perspective of the appearance of a facility may be captured by one or more cameras placed so as to provide a close facsimile to what a customer would see upon entry to a site and as they move throughout the site. For example, a camera may capture what a customer sees upon initial entry into a facility; another camera may focus on a greeting area; another camera may focus on the front counter from the customer's perspective; another camera may cover the office of a sales rep, etc. One or more of these Sensors may serve both to capture such group aspects as well as specific employee interactions. For example, if a pair of cameras is being used to capture two sides of a service Performance for the purpose of providing Feedback on that specific Performance (for example as described above), the Employee Side camera may also be used to capture information to portray the customer's perspective of the facility.

In some examples, the system may select a sample (e.g., a randomized representative sample) of camera shots designated as representing the perspective of interest, for example at different times throughout a day. These shots may be assembled and may be displayed, for example as a time series on a display (e.g., a video wall display). The time series may be accessed (e.g., via the internet) by any member of the group that works in the facility in question, or may be generally provided to all employees, for example by projection onto a flat screen in a common area in the facility.

In this example, the disclosed systems and methods may be used to help systematically to draw the attention of a group working together in a facility to a particular aspects, for example a visual perspective on that facility, so as to encourage the group to notice something that they are doing or not doing and, as a result, to help each other as a group to change their individual behavior in order to achieve the desired group objective. This example application may help to leverage underlying group dynamics or social processes to apply motivating pressure on individuals to change their daily behavior or habits.

In this example, the method may include: (i) the designation of specific sensors (e.g., cameras) as representing a perspective of interest (e.g., a series of cameras may be positioned to capture what a customer might see); (ii) the collection from those sensors of data (e.g., short video clips or still images) at relatively frequent and/or random time periods throughout the day in such a manner as to ensure that the resulting images are representative of the desired perspective of the facility in question; (iii) the compilation of these images (e.g., as a “video wall”); and (iv) the presentation of these images to employees who work in the facility (e.g., on a publicly-displayed flat screen or via a web portal, which may be accessible only to employees) in such a way that all employees may be aware that other employees have seen the images being displayed.

In some examples, a provocative title may be associated with the images (e.g., “This is your branch. Are you proud of it?”) in order to elicit a desired reflection from the employees. In some examples, employees or group members may be provided with the ability to comment (e.g., anonymously or not) on the images in such a way that all group members may view the comments. In some examples, periodic live discussion amongst the group of what they are seeing may be encouraged, for example to help promote dialogue and the emergence of a common concern for improvement of group behaviors (e.g., for maintaining how the facility looks from a perspective of interest).

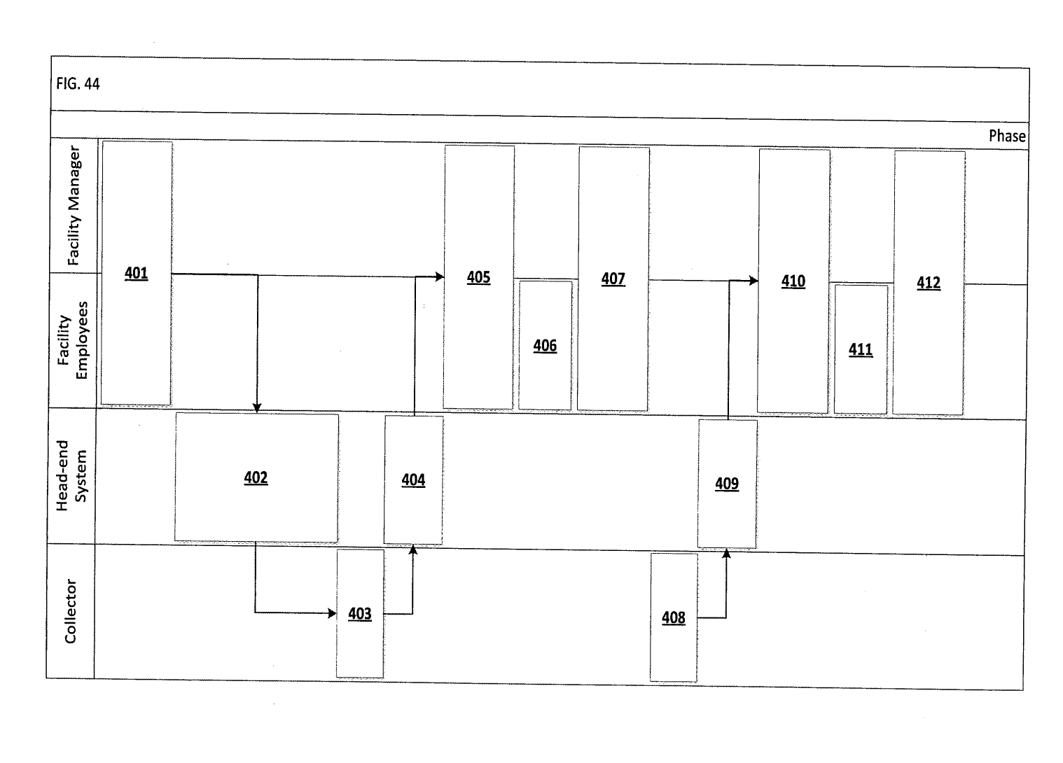

An example process flow diagram of an example operation for this example is shown in FIG. 44. In this example, the process may begin with definition of a perspective or objective of interest, for example by the manager of a facility agreeing with his/her employees on a perspective or objective (401). This may include selection of one or more Context Views to represent that perspective. For example, 8 camera views may be selected to provide an overview of what a customer would see when entering a particular facility.

This definition may be transmitted to the Head-end System which may set up a relevant type of Review Program (402). The Review Program may be specified according to, for example, the Site(s) to be reviewed (e.g., the Site where the group is active), the Context View(s) to be used to achieve the desired perspective, how often data is to be collected and/or provided for review, etc. The Head-end System may then transmit information to the relevant Collector(s) requesting certain data to be transmitted to the Head-end System periodically (e.g., each day or more regularly, as appropriate). The Collector(s) may then collect and transmit the appropriate data to the Head-end System (403).

As the data is received at the Head-end System from the Collector (e.g., on a daily basis), the Head-end System may populate (or update) video images and/or clips that form the time-series to be displayed as a video wall (404). The displayed images and/or clips may be cycled (e.g., randomly) so that no one set of views is left visible for more than a specified number of seconds, for example. This may allow individuals who walk by the display to be able to see multiple time-series within, for example, a 2-3 minute period.

The manager and employees may access the video wall, for example either online (e.g., via a personal portal) or via viewing a commonly shown display (e.g., on a flat screen panel in an employee break room), on a regular basis (e.g., at least daily) (405). In some examples, employees may be provided an option to tag and/or comment on various images (406). In some examples, the source of such tags and/or comments may be identified, which may help to avoid prank or malicious use of tags and/or comments. Periodically, for example as and when issues begin to become evident to all, based on review of such images, the group may gather to discuss the source of any problems and how behaviour has to change in order to address it (407).

At 408-412, steps 403-407 may be repeated as many times and as often as necessary (e.g., as specified by the manager and/or employees.

This process (e.g., as described with respect to steps 401-407, 408-412) may continue until the behaviour in question had been changed. A new perspective or objective of interest may then be identified and the process repeated.

Conventionally, as a manager of a facility, it may be difficult to motivate employees to change their group's habits, for example in order to keep the place clean, to clean up their desks, to turn off all lights when they leave, to pay ongoing attention simultaneously to customer needs in both a front counter area and a drive-thru area and to take action as a group in real time to address changing needs, etc. While certain employees may follow the rules diligently, others may either ignore the rules or fail to notice how they are behaving. Conventionally, managers may resort to warnings, disciplinary actions, prodding, badgering employees, and other similar kinds of efforts to get certain employees to pay attention and change their behaviours. This may be the case even when the behaviour changes are simple and well understood. Such conventional efforts may be time consuming, tiring, frustrating and demotivating, and may be divisive where certain employees may feel either taken advantage of or picked on. In such conventional methods, responsibility for enforcing the rules may remain with the manager and employees may remain on the sidelines watching what is going to happen.

In the example described above, the manager of a facility may be provided with the ability to highlight explicitly a set of observable features or behaviours that are taking place in the facility. In this example, the system may help to ensure that the target perspective(s) and/or objective(s) are visible on a regular basis to employees who work in that facility. This may help to foster a sense of communal responsibility for the group behaviour (e.g., for the way the facility comes across), and may help to enlist the employee community in applying pressure on those who are not addressing their behavioural issues. Getting individuals to pay consistent and sustained attention to their behaviour may be a pre-condition to their being able to change it. This example application may also help to reduce the load carried by the manager in delivering the desired behaviour change.

### Example 4

In this example, the disclosed systems and methods may be used in the context of making a new hiring decision. For example, the disclosed systems and methods may be used to provide employees/interviewers with an objective perspective on each candidate's behavioural and perceptual competency to perform the job based on the candidate's reactions to real customer interactions.

A conventional strategy employed by companies to increase employee motivation and engagement, to reduce absenteeism and turnover, and/or to maximize the likelihood of a successful “fit” between employee and corporate environment may be to employ structured interview and screening techniques of candidates during hiring. However, interviewers may develop preferences among new hire candidates for reasons that have little to do with the candidate's objective qualities. Having potential colleagues of a new hire participate in the hiring decision may help to increase current employees' sense of commitment to making the new hire successful, so involving colleagues in the interview process may be desirable. Structured interview techniques and aptitude tests have been developed to attempt to mitigate the impact of the interviewers' subjective opinions.

However, it may be useful to provide current employee/interviewers with a more realistic picture of how a candidate may actually perform in specific situations they may be expected to encounter in the job for which they are applying, particularly since the current employees may have personal experience with the work that the new hire may be asked to do. In this example, employee/interviewers may be provided with an objective perspective on each candidate's behavioural and perceptual competency to perform the job based on the candidate's reactions to real customer interactions.

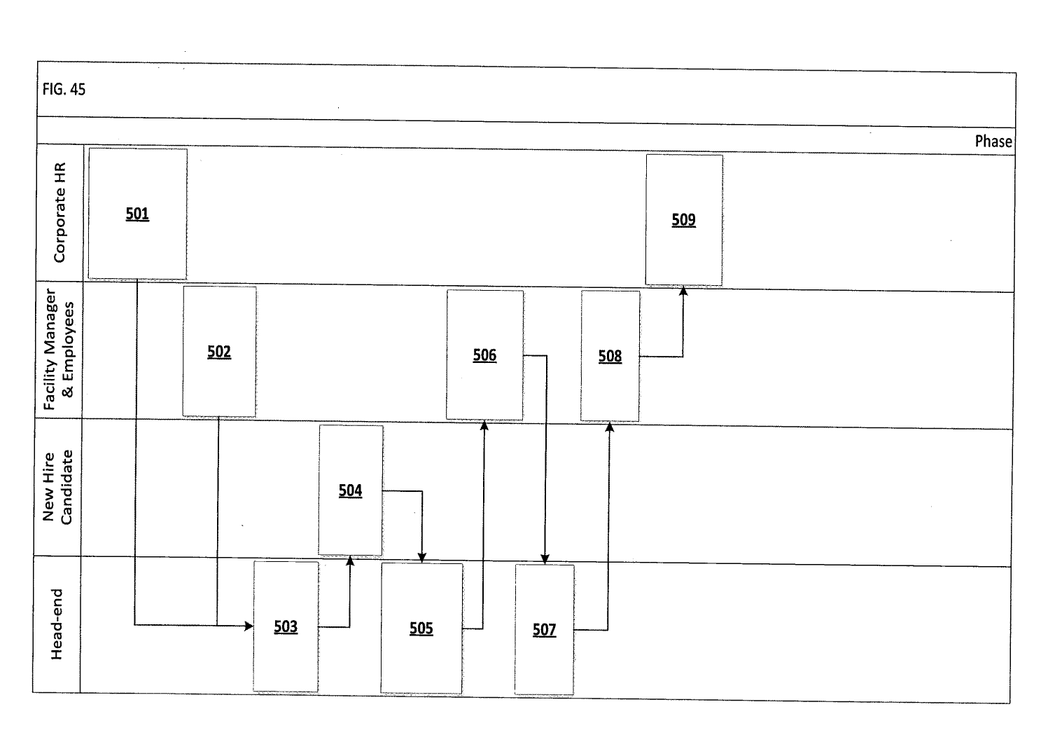

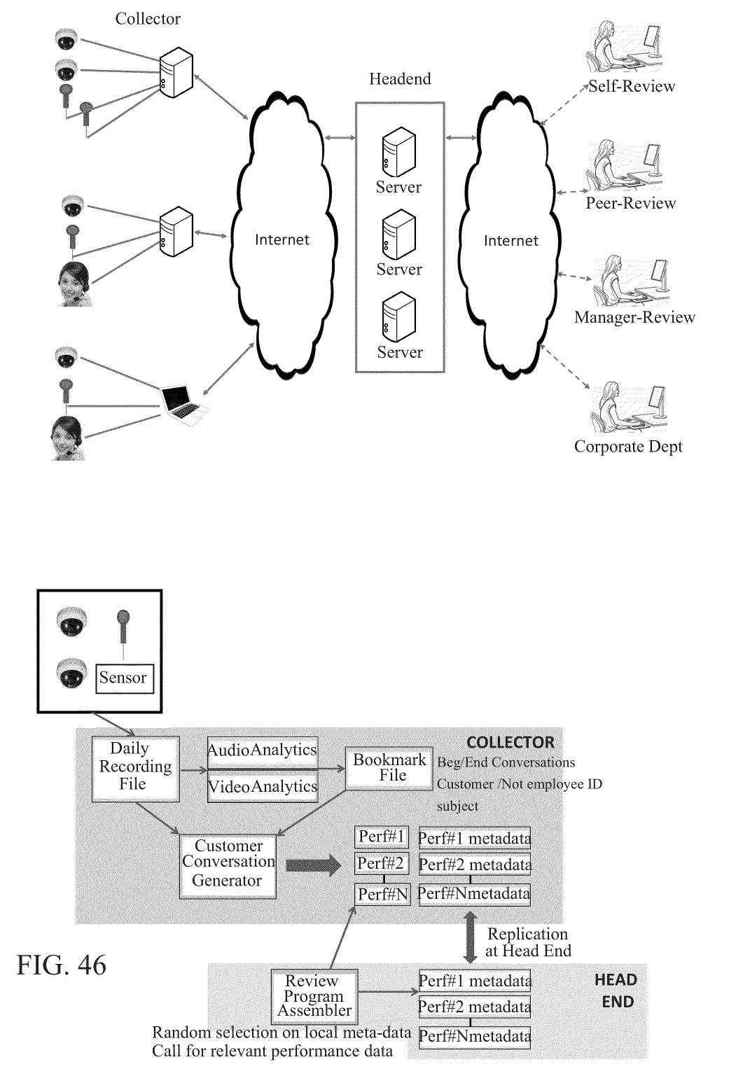

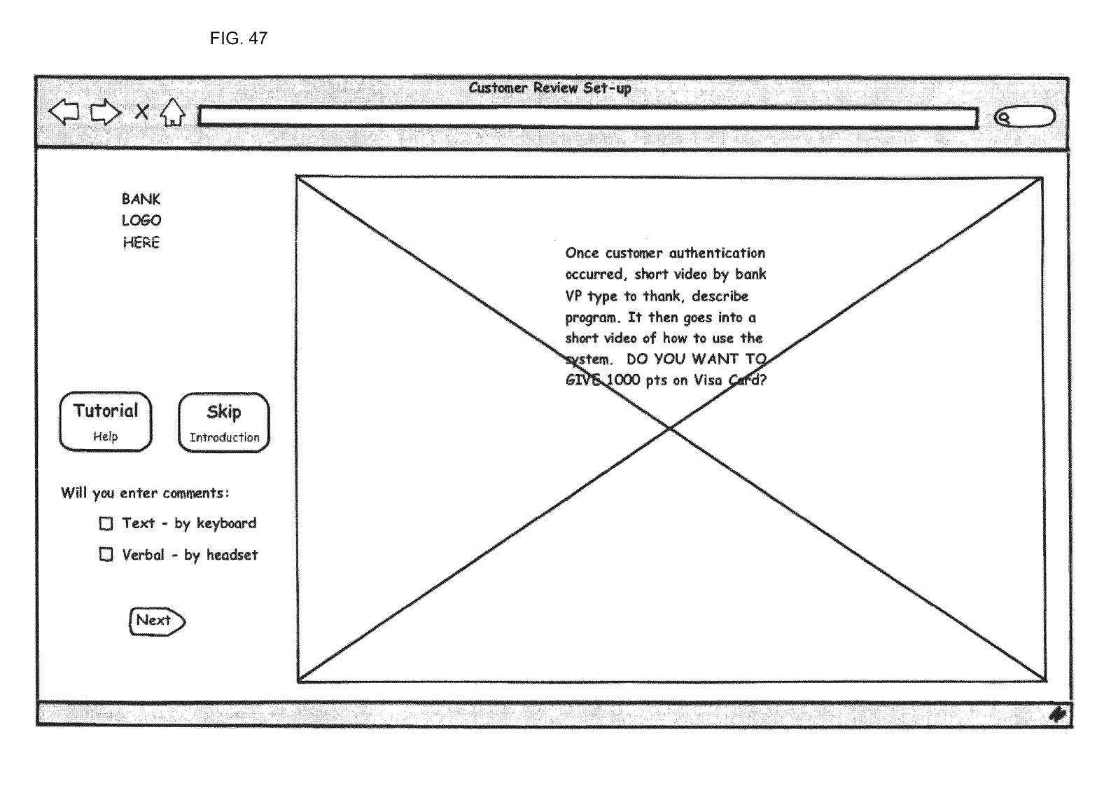

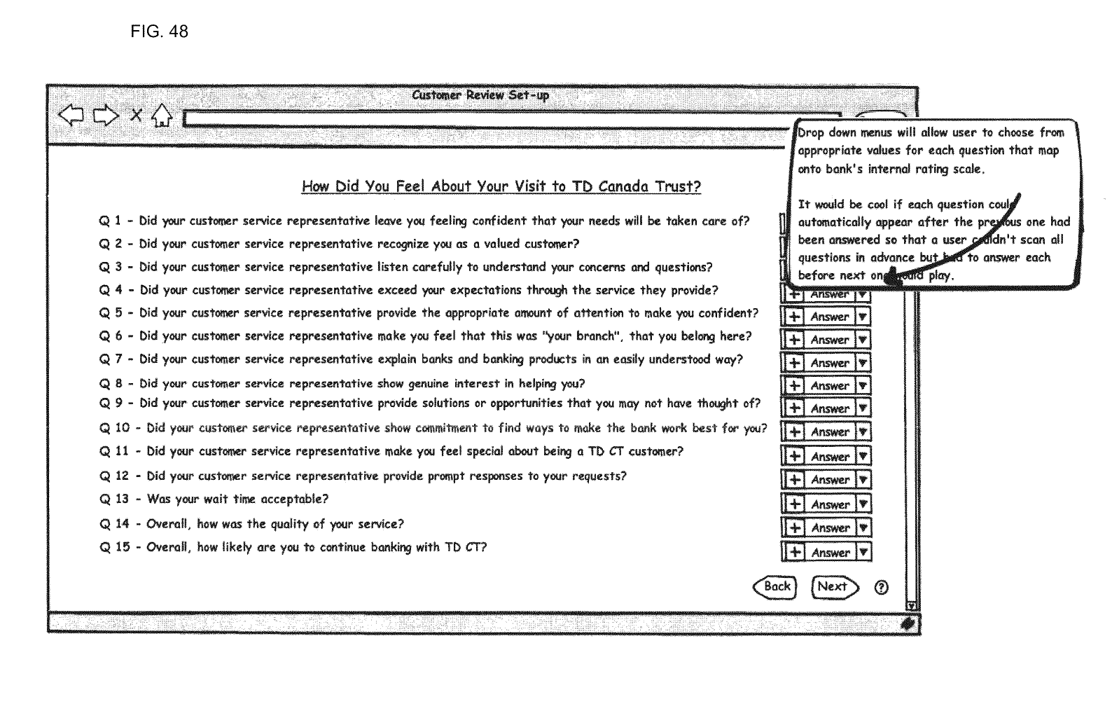

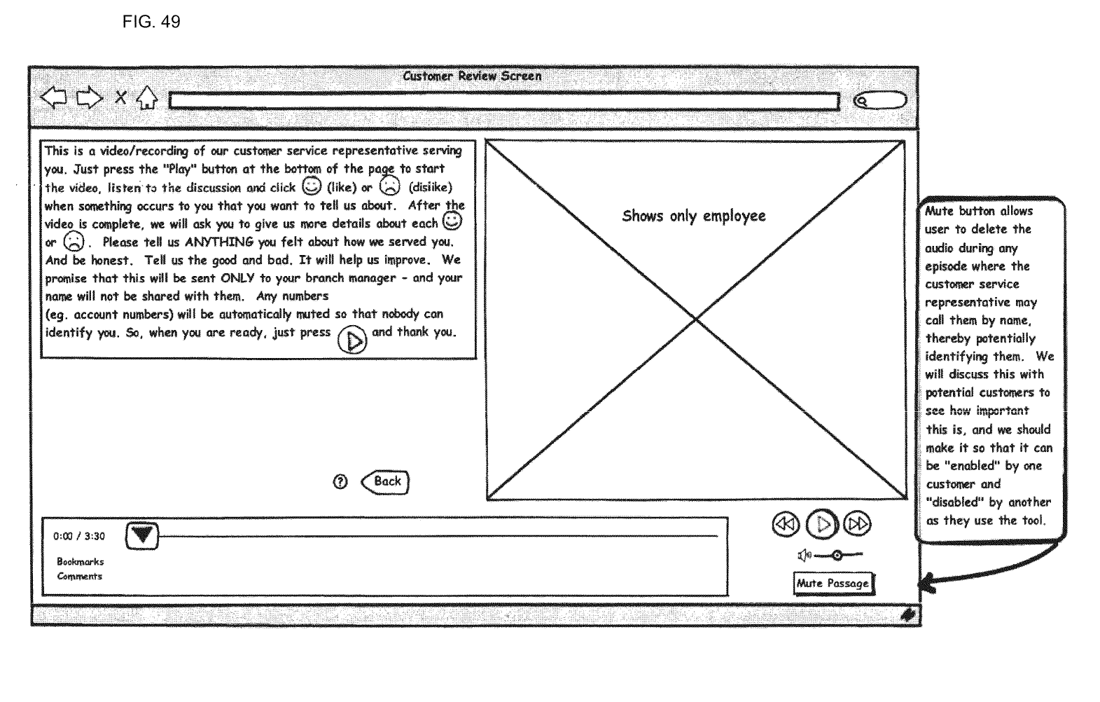

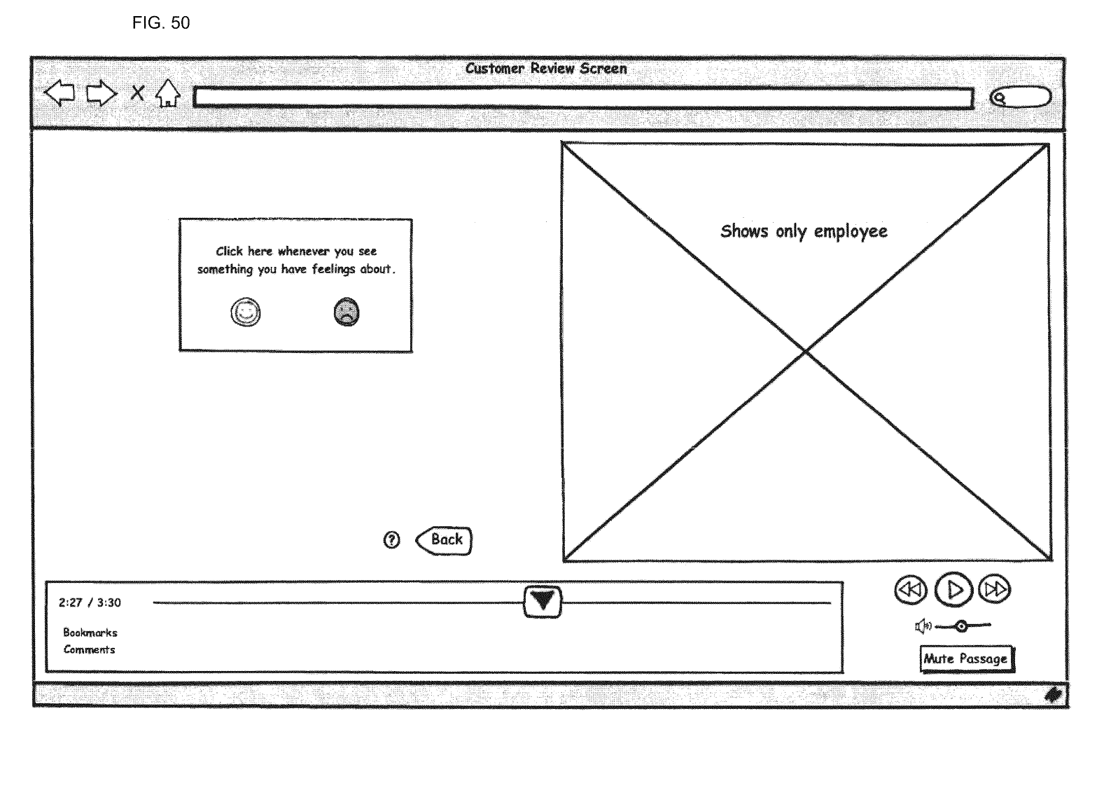

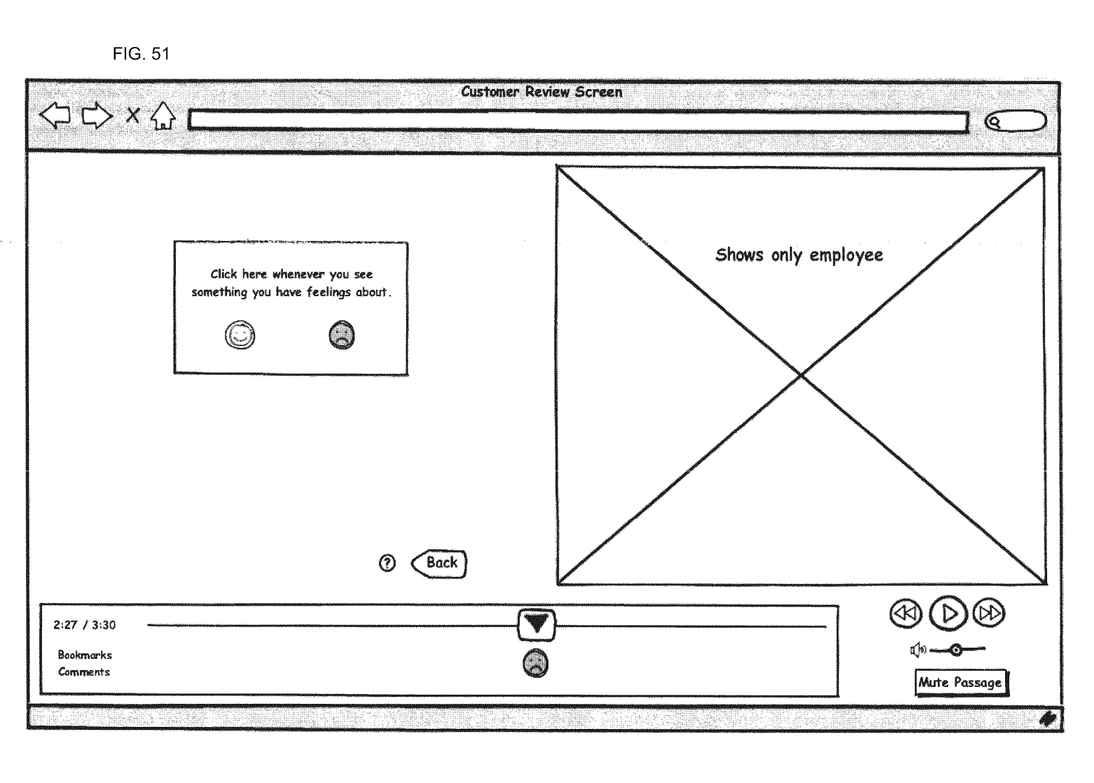

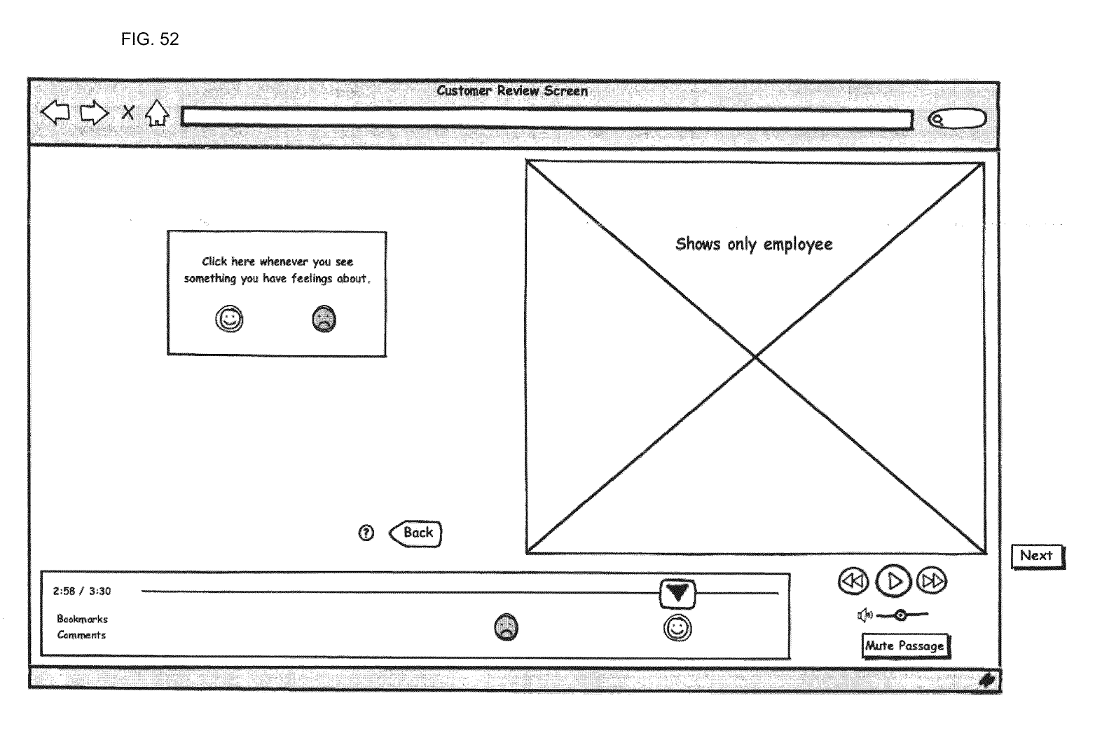

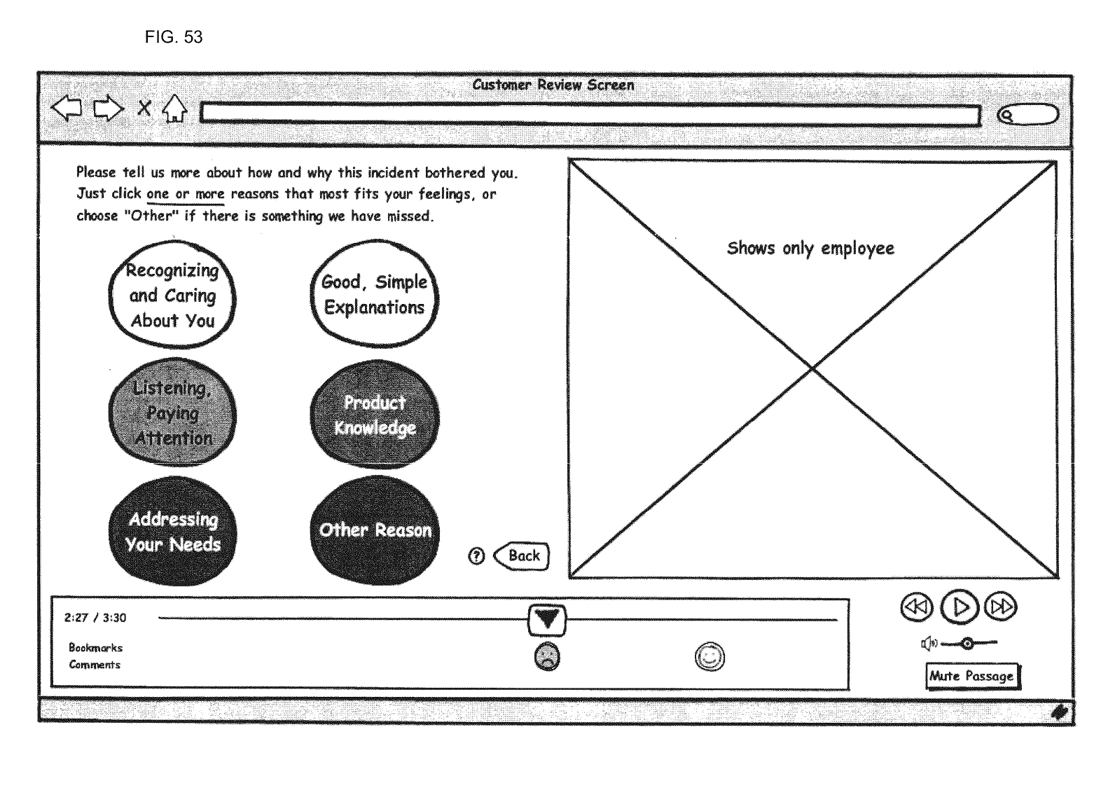

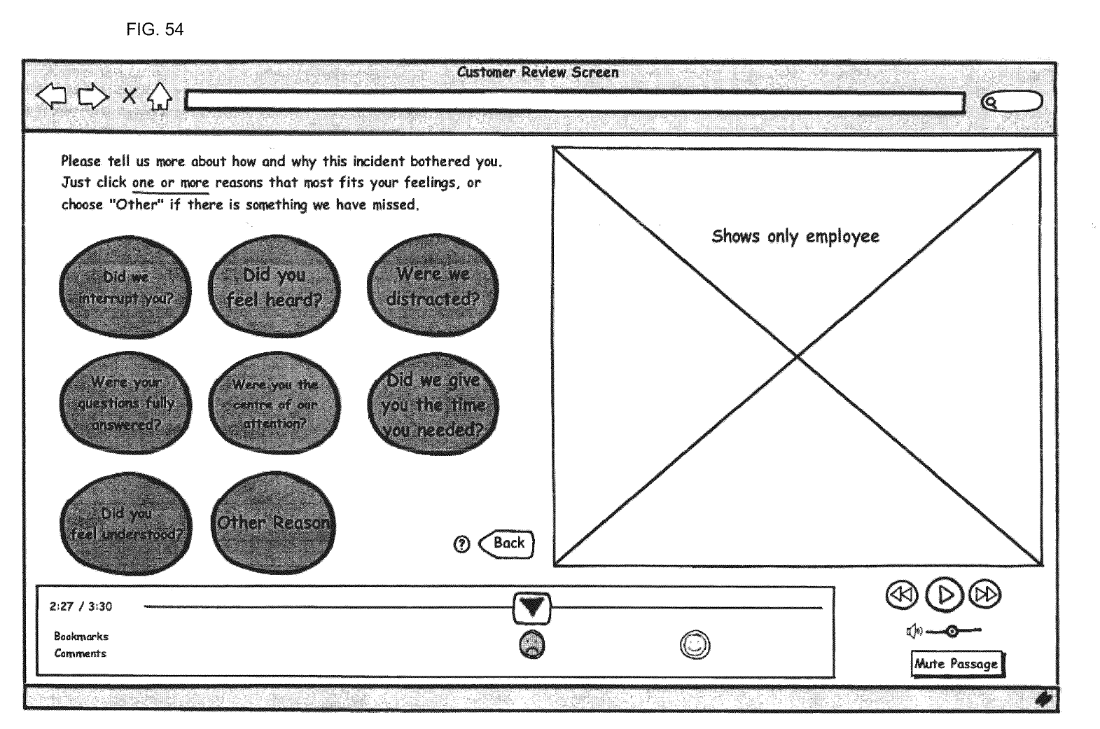

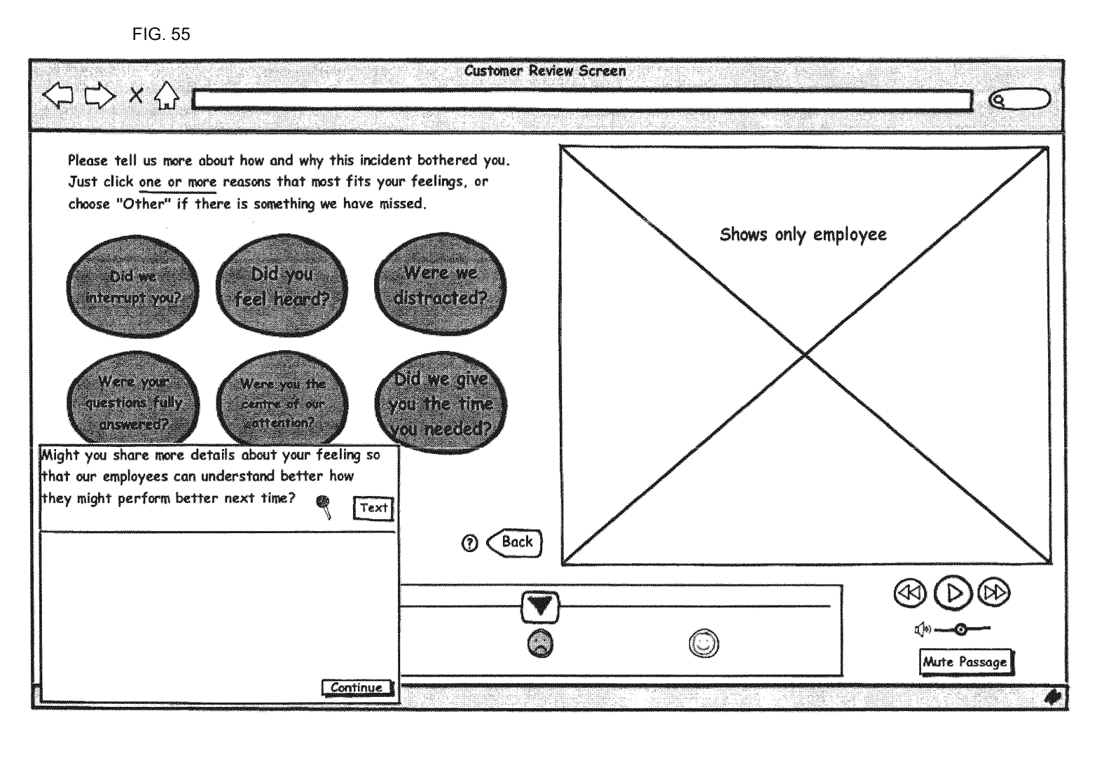

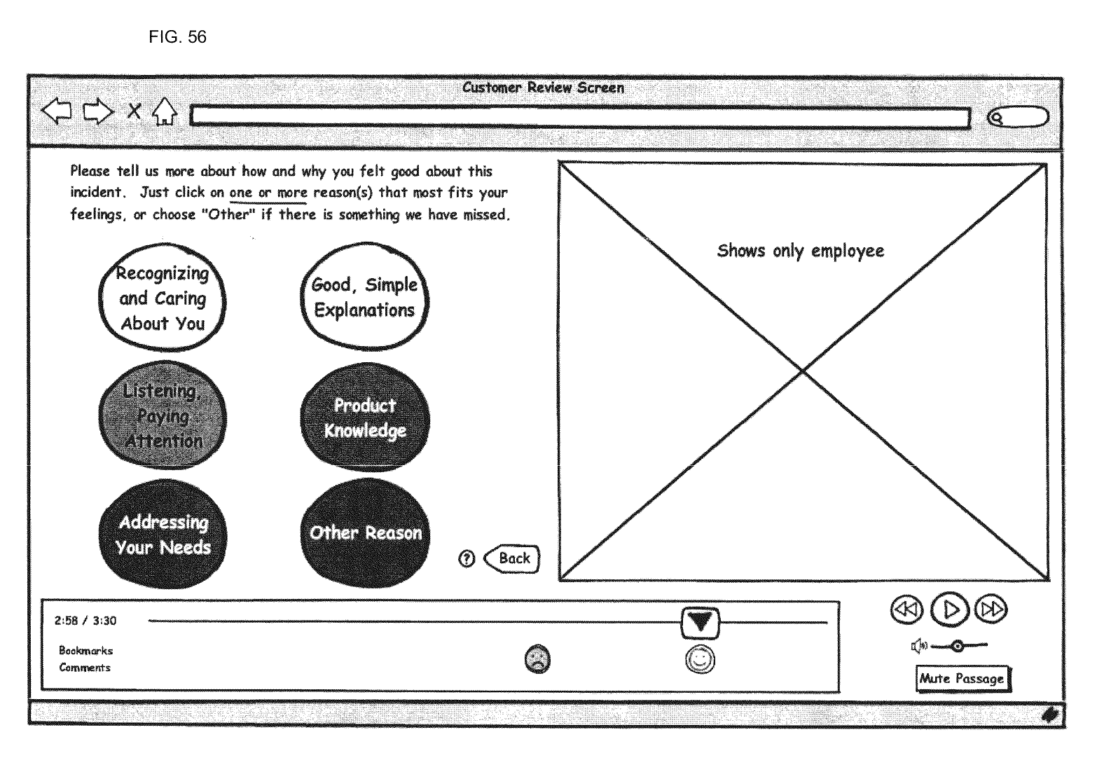

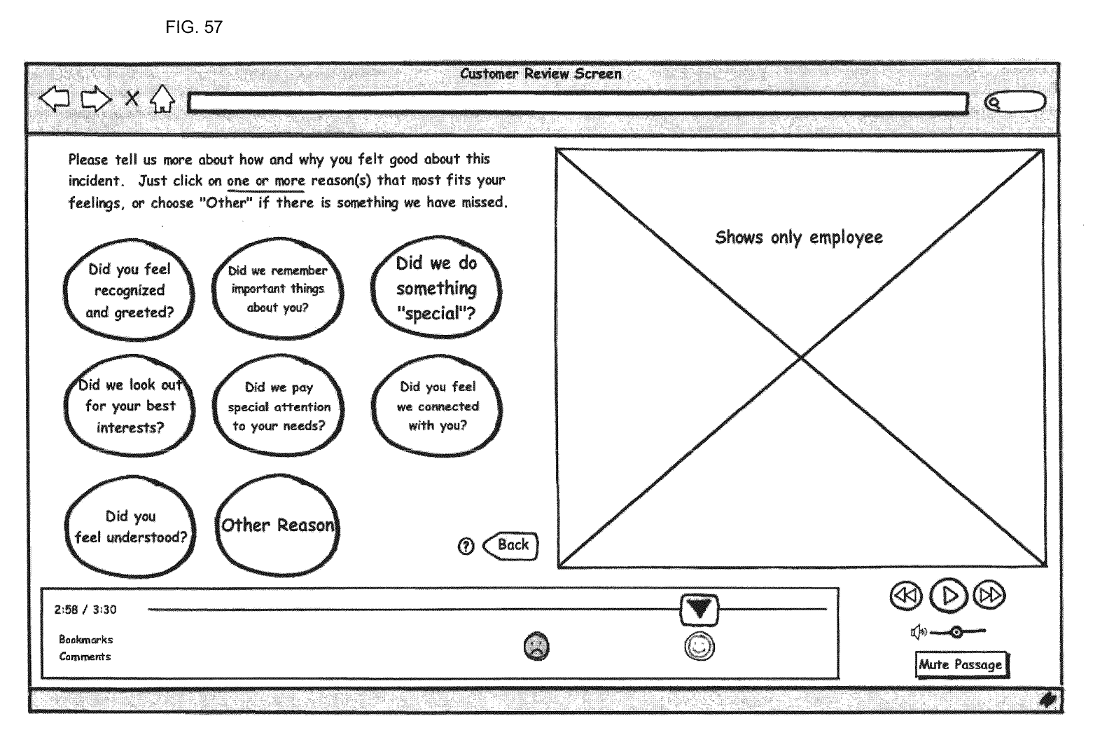

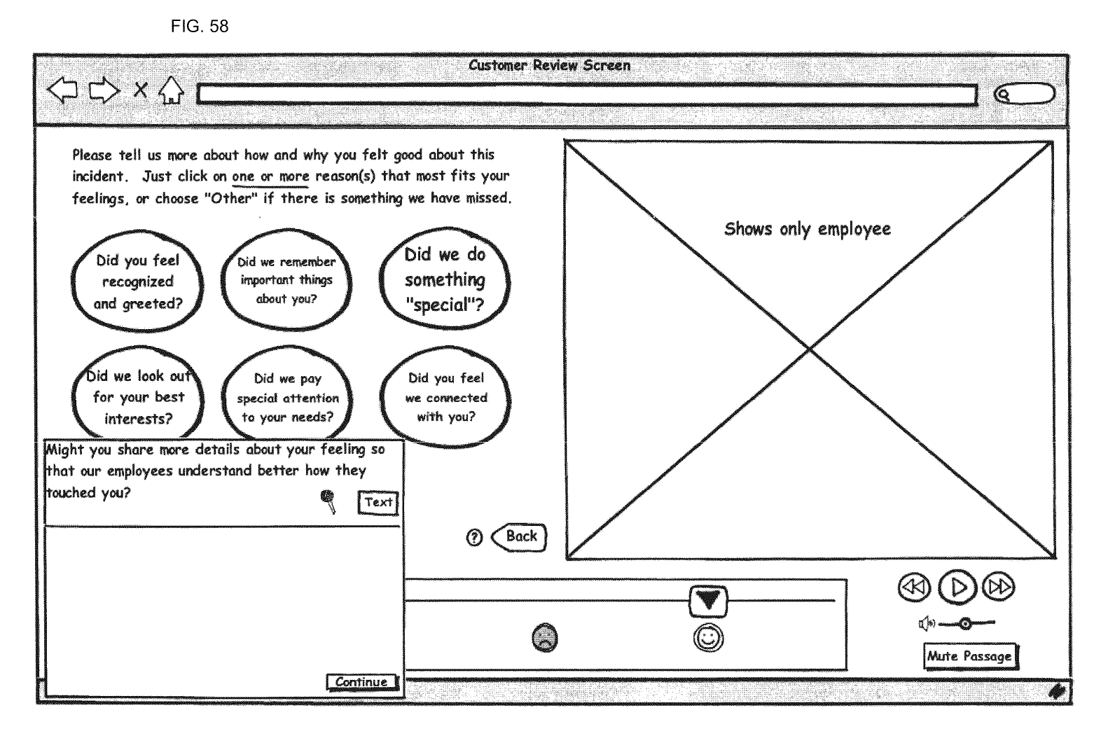

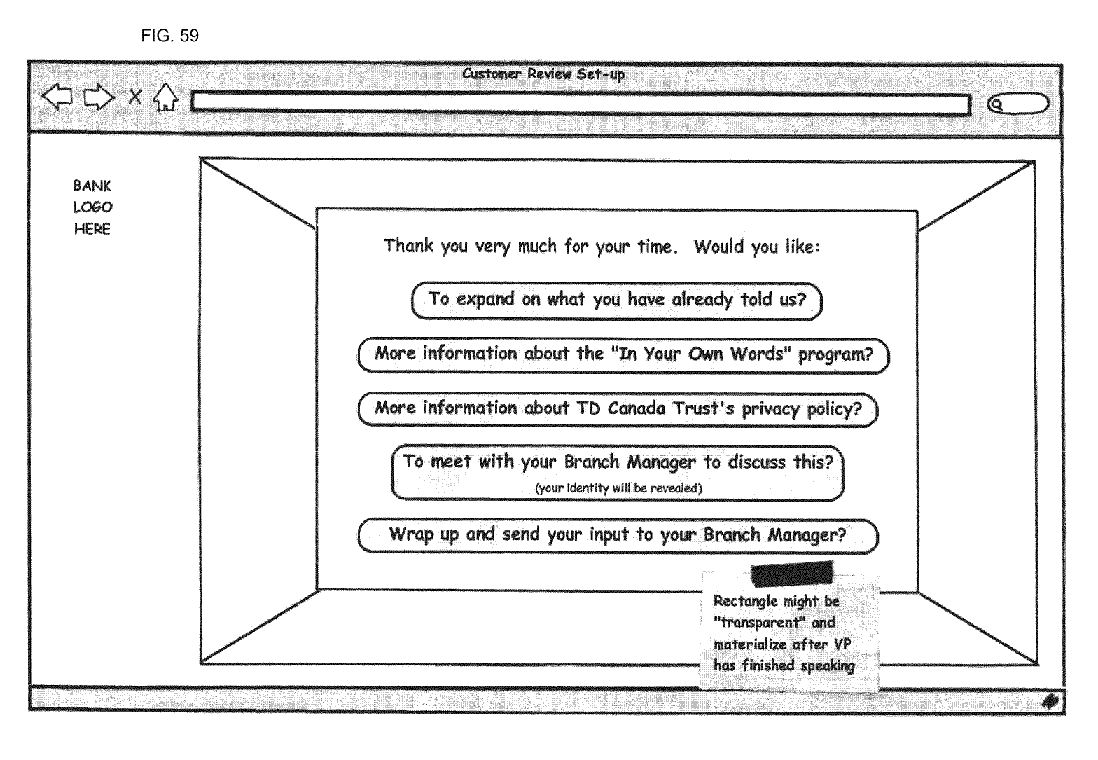

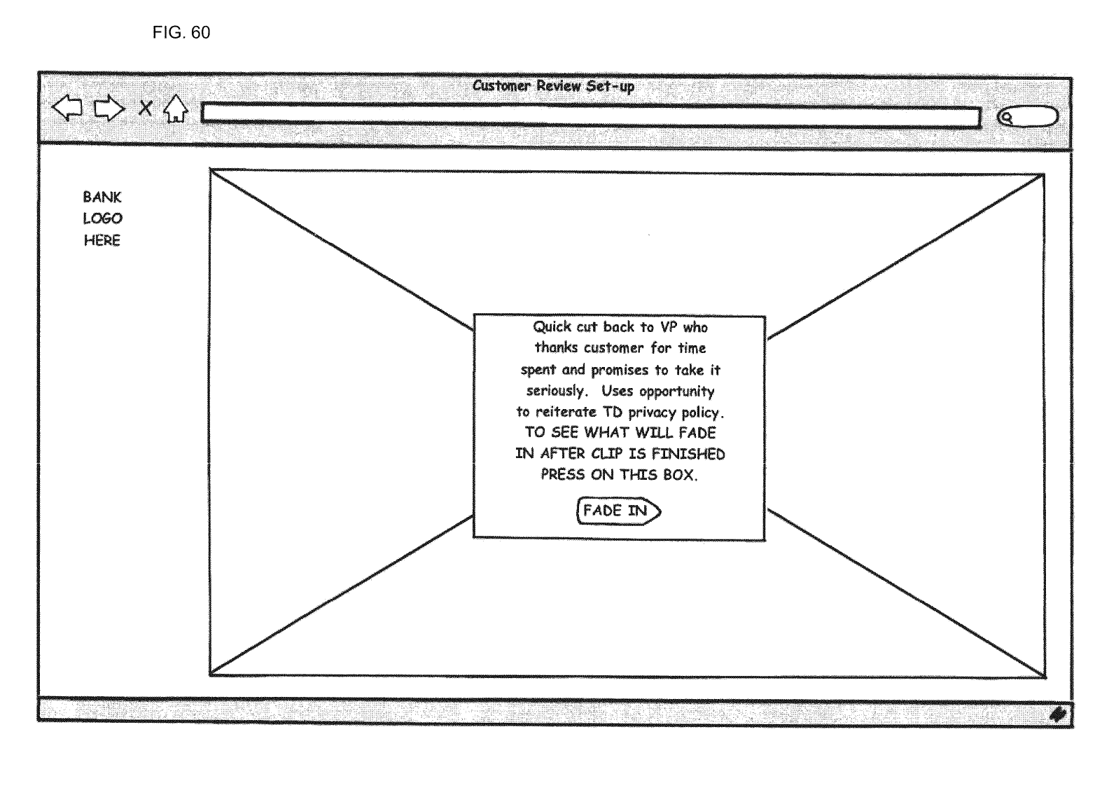

FIG. 45 illustrates an example process flow diagram of how the disclosed systems and methods may be used in the context of making a hiring decision.

To begin with, in 501, a Rubric may be defined (e.g., by central HR personnel) based on the skills and attributes that employee/interviewers may be looking for in a new hire. Such a Rubric may be defined, for example for a specific position, based on Company-wide job descriptions and/or competency models for that position. This Rubric may be based on an Assessment Review Type (e.g., as described above) and may facilitate a Review-of-Review in which employees/interviewers may assess and comment on the Feedback provided by a candidate in step 504 below. The Rubric definition may be transmitted to the Head-end system (e.g., loaded into a Rubric library). A portfolio of recorded Performances (e.g., that provided typical examples of customer interactions relevant to each type of position) may also be transmitted to the Head-end System. Such a portfolio may be selected by central HR personnel, for example, to help illustrate stronger and weaker demonstrations of specific competences relative to a specific job or position.

Such a Rubric may be used Company-wide across multiple outlets or may be customized for each outlet. For example, as appropriate, in 502, hiring teams at a specific facility may be permitted to add Performances to the library that they feel may be typical of experiences in their facility.

In 503, the Head-end System, based on data provided at 501 and 502, may set up the Rubric(s) and related Performance(s) for each Job Category which may be the subject of a hiring process.

When a candidate applies for a position (and after any initial screening a Company may use), that candidate may be invited to perform one or more Reviews, for example using a web portal in a Company facility (e.g., to ensure the individual's work was truly their own). In 504, the candidate may log in and review one or more Performances (e.g., 3-4 Performances), which may be selected at random from the relevant library. This initial Review may be performed using a simplified Observation-type Rubric, for example one that may enable the candidate to Bookmark and comment on anything that they noticed or reacted to in the Performance (e.g., indicating good, bad or simply interesting) without providing any Concept Bubbles to direct their attention. This may avoid the need for much training of the candidate on use of the Rubric. The candidate may be asked to provide comments on everything and anything that they noticed in the Performance(s) available for them to review. The Review (which may be made up of one or more Reviews by the candidate of individual Performances of interest) may be carried out in a manner similar to that described above, and may be simplified (e.g., by omission of Concept Bubbles) as appropriate.

Once the candidate has completed their Review, the Review data may be stored on the Head-end System (505). The Head-end System may send each member of the employee/interview team a notification indicating that the candidate's Review is available for review (e.g. a Review-of-a-Review Type) by each member of the hiring team.

Each member of the employee/interview team may log on to the system and view the candidate's Review(s) of the, for example, 3-4 Performance(s) (506). The Head-end System may provide an appropriate Rubric for carrying out a Review of the candidate's Review(s). For example, this Review-of-Reviews may be carried out using an Assessment-type Rubric designed in 501, which may allow the employee/interviewers to relate the candidate's comments about each Performance to one or more job competency-based Concept Bubbles provided in the Corporate HR-supplied Assessment Rubric. The employee/interviewers may also provide their own assessment of how what the candidate noticed demonstrated the candidate's strength or weakness on each of the relevant job competency dimensions.

After each Review-of-Review is completed by each member of the employee/interview team, their Feedback may be transmitted to the Head-end System, which may store and index this data according to the specialized Rubric (507). When all members of the employee/interview team have completed their own Review-of-Review activity, the Head-end System may notify the whole team of the completion, and may provide to the team a summary of their collective Feedback (e.g., in each case linking each piece of Feedback to a specific episode/comment made by the candidate). The employee/interview team may schedule a meeting to make a final group hiring decision (508). Alternatively, the system may enable each member to separately enter their hire/no hire decisions into the system, which decision may be transmitted to a hiring manager for a final decision.

The hiring decision may be shared with Corporate HR personnel, for example to ensure the hiring process and Rubric(s) are working (509). The Head-end System may enable Corporate HR personnel to audit the processes being followed in each remote outlet in order to ensure that the competency-based Rubric was being properly used, for example.

In this example, new hire candidates may be provided with realistic representations of interactions that they may encounter in the performance of the job they seek. The candidates may be offered an opportunity to reveal what they noticed (or did not notice) about the interaction, which may range from the obvious to the subtle or very personal. Since there may be no perceived “right answer” or human prompt, the candidate may not be able to deduce the “correct answer” based off the interviewer's questions. By being forced to provide un-prompted reactions to the Performance(s) viewed, candidates may reveal what they notice, how they react, how sensitive they are, what is important to them, what beliefs they bring with them about how customers ought to be treated or how much responsibility an individual employee has with respect to customer service, etc. All of this information may provide useful determinants of success in a front line service environment. Such information may be relatively hard to obtain through conventional interview techniques.

By allowing several current employees to carry out this Review-of-Review on the candidate, the Company may benefit from multiple experienced perspectives that may be based on the objective evidence of what the candidate noticed, reacted to, etc. Future colleagues of the new hire may also get to see details of how each candidate may react to and behave in everyday situations, and to decide if such a candidate would be a desirable colleague. This may help to make these colleagues more invested in helping the new employee to be successful. In designing the Rubric that employees use for such a Review-of-Review for a new hire, the Company may help to ensure that specific job-related competencies and/or issues of importance are being considered when looking at new hire candidates, without having to invest heavily in HR staff to administer local interview processes. This example application may also help to enable participation in the interview decision-making process by employees who may be unable to attend a particular interview date or schedule.

Conventional hiring practices may make use of role-playing or insertion of a candidate into a simulated experience so that the candidate may display how they would handle a situation. Such methods may be expensive and/or hard to justify in the hiring of lower-level candidates, and such simulations may not provide true interactivity as a way of forcing the candidate to reveal how they would respond to an evolving situation. For example, simulations which bring a candidate up to specific moment and then ask “what would you do?” may have the limitation that i) a simulation may be a reduction of reality which may eliminate some of the richness of a complex situation, and ii) a candidate's “on the spot” verbal reaction may stay at a high-level and may not cause the candidate to reveal the nuances and subtleties of their perception and thinking.

In the example described above, the disclosed systems and methods may be used to allow candidates to reveal their softer, more nuanced and perceptual skills and attitudes in reaction to a fully realistic situation. In some examples, a Performance shown to candidates may be interactive simulations that may change in reaction to the attributes noticed by a candidate, for example, as they use a Rubric to point to what they notice. This may allow for a more comprehensive examination and display of a candidate's attributes as the Performance of the interaction being watched may change in response to what the candidate notices.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A method for obtaining and sharing a review of a service performance, the method comprising:
storing, in a computer system, a definition of a review group of reviewers for providing a review of the service performance, wherein the definition can be updated from time to time and comprises:
one or more criteria for admittance of a candidate into the review group;
one or more rules governing one or more tools useable by a reviewer, including at least one of a review type and a review user interface type;
one or more rules for assigning a performance to be reviewed by a reviewer;
determining, based on an evaluation of any criteria and rules in the definition, one or more performances to be reviewed by one or more reviewers;
providing, through the computer system, a playback of the performance to one or more reviewers;
obtaining from the one or more reviewers, a review of the performance during the playback of the performance;
storing the performance data and the review, the stored review being associated with the stored performance data; and
providing the stored review as feedback to a performer involved in the service performance.

2. The method of claim 1 wherein the reviewer does not know the performer and/or does not know the performer's work performance.

3. The method of claim 1 wherein the one or more rules governing the review type comprises a rule governing a type of performer for a reviewer to review.

4. The method of claim 1 further comprising determining whether the candidate meets the criteria defined in the definition of the review group and, if the individual meets the criteria, assigning the candidate to the review group.

5. The method of claim 1 wherein determining one or more performances to be reviewed further comprises evaluation any requests from the one or more reviewers to review the one or more performances.

6. The method of claim 1 wherein the one or more criteria for admittance comprises at least one of: a request by at least one or the performer and a supervisor of the performer to admit the candidate to the review pool; completion of at least one qualification requirement by the candidate; and at least one experience in common between the performer and the candidate.

7. The method of claim 1 wherein the review types comprise at least one of: an observation of a performer's behavior; an assessment of a performer's competence and/or skills; a comparison of the performance with a reference standard; a review carried out using a computer user interface provided by the computer system; and a review of a pre-defined position in an organization and/or type of service interaction.

8. The method of claim 1 wherein the one or more rules for assigning a performance comprise at least one of: random assignment; assignment based on matched positions, skills, learning objectives, and/or specific request; uni-directional assignments; and bi-directional assignments.

9. A method for generating a profile of interpersonal behavior of a subject involved in a service interaction, the method comprising:
storing, by a computing system, data for playback of a plurality of service interactions involving the subject and storing information characterizing each interaction in association with each respective interaction;
obtaining, using a computer user interface provided by the computing system, one or more characteristics of the interpersonal behavior of the subject, the one or more characteristics being observed through the playback of the plurality of interactions; and
generating the profile of the subject, the profile including information about the one or more characteristics and data for playback of the plurality of interactions.

10. The method of claim 9 further comprising recording the plurality of service performances and information characterizing each service performance using one or more sensors.

11. The method of claim 9 further comprising providing, via the computing system, the profile of the subject as output to one or more users prior to the one or more users interacting with the subject.

12. The method of claim 9 further comprising providing, via the computing system, a summary of the profile of the subject as output to one or more users during an interaction between the one or more users and the subject.

13. An apparatus for the collection of data associated with a service performance involving at least one performer and at least one customer at one or more physical locations for carrying out a service performance, the apparatus comprising:
a support positionable between the at least one customer and the at least one performer; and
at least one housing mountable on the support, the at least one housing at least one of:
at least one camera for capturing an image of at least one of the at least one customer and the at least one performer during the service performance;
at least one microphone for capturing audio from at least one of the at least one customer and the at least one performer during the service performance; and
at least one processor configured for controlling operation of the at least one camera and the at least one microphone.

14. The apparatus of claim 13 wherein the at least one processor is coupled to a memory for storing data captured by the at least one camera and the at least one microphone, the at least one processor being further configured for communicating the stored data to an external computing device.

15. The apparatus of claim 13 wherein the least one housing further houses at least one of: a motion detector, a distance detector and a radiofrequency identification (RFID) reader.

16. The apparatus of claim 13 wherein the support is adjustable in length.

17. The apparatus of claim 13 wherein data captured by the at least one camera and the at least one microphone are encrypted.

18. The apparatus of claim 13 wherein the at least one processor is further configured for identifying at least one of the at least one performer and the at least one customer.

19. The apparatus of claim 13 further comprising a mechanism for indicating suspension of data capture.

20. The apparatus of claim 19 wherein the at least one processor is further configured for, in response to activation of the mechanism, designating that a subsequent portion of data captured by the at least one camera and the at least one microphone should be ignored or discarded.

21. A dedicated device for the collection data associated a service performance involving at least two performers, the device comprising:
a portable housing placeable stably on a support surface;
at least one panoramic camera within the housing for capturing a panoramic view of the service performance;
at least one microphone within the housing for recording voices of one or more performers in the vicinity of the device;
a memory for storing data from the at least one panoramic camera and the at least one microphone; and
at least one communication component for communicating the stored data to a computing device.

22. The device of claim 21 further comprising a processor in communication with the at least one panoramic camera and the at least one microphone, the processor being configured for controlling function of the at least one panoramic camera and the at least one microphone, and for implementing at least one security feature to inhibit unauthorized access to the stored data.

23. The device of claim 21 wherein the processor is further configured for identifying a primary user of the device by at least one of: receipt of a user identifying input; execution of a voice-recognition algorithm; and execution of a facial-recognition algorithm.

24. The device of claim 22 wherein the at least one security feature comprises at least one of:
a protocol for authenticating a connection to the computing device;
a protocol for inhibiting communication of stored data to an unauthorized system; and
a protocol for encrypting the stored data prior to or during communication to the computing device.

25. The device of claim 21 wherein the device is sized to fit into a pocket.

26. The device of claim 21 wherein the at least one panoramic camera is configured to capture a panoramic view in the range of about 180° to 360° along a first axis and in the range of about 0° to about 90° along a second axis.

27. The device of claim 21 configured for collecting sensor data associated with interactions taking place around a table or desk.

28. The device of claim 21 wherein the device is not a smartphone or a consumer recording device.

29. The device of claim 21 further comprising at least one additional sensor including at least one of: a radiofrequency identifier (RFID) sensor; a location sensor; and a wireless hotspot sensor.
